(19) United States
(12) Patent Application Publication
(10) Pub. No.: US 2018/0163135 A1
(43) Pub. Date: Jun. 14, 2018

(54) LIQUID CRYSTAL POLYMERIZED FILMS USING ALIGNMENT FILM AND POLYMERIZABLE LIQUID CRYSTAL COMPOSTION

(71) Applicants: JNC CORPORATION, Tokyo (JP); JNC PETROCHEMICAL CORPORATION, Tokyo (JP)

(72) Inventors: Daisuke OOTSUKI, Ichihara-shi (JP); Nagahisa MIYAGAWA, Ichihara-shi (JP); Norio TAMURA, Ichihara-shi (JP)

(73) Assignees: JNC CORPORATION, Tokyo (JP); JNC PETROCHEMICAL CORPORATION, Tokyo (JP)

(21) Appl. No.: 15/833,783

(22) Filed: Dec. 6, 2017

(30) Foreign Application Priority Data
Dec. 7, 2016 (JP) 2016-237810
Nov. 20, 2017 (JP) 2017-222666

(51) Int. Cl. C09K 19/38; C08G 73/10; C08F 267/06; C09D 135/02

(52) U.S. Cl. CPC C09K 19/3833; C08G 73/1067; C08G 2250/00; C09D 135/02; C08F 267/06

(57) ABSTRACT

Liquid crystal polymerization films, prepared by applying a polymerizable liquid crystal composition containing a polymerizable liquid crystal compound represented by formula (2) on an alignment film prepared by calcinating a composition containing a polymer represented by a repeating unit of formula (1), and subsequently polymerizing the polymerizable liquid crystal composition.

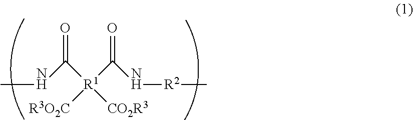

In formula (1), R¹ is independently a tetravalent group, R² is independently a divalent functional group and R³ is independently a hydrogen atom or a monovalent functional group.

PG¹-Sp¹-R⁴-Sp²-PG² (2)

In formula (2), R⁴ represents a divalent group formed by combining five or more and nine or less of alicycles and/or aromatic rings, SP¹ and SP² represent a spacer group, and PG¹ and PG² represents an alkyl group, an alkoxyl group, a cyano group, fluorine or a polymerizable functional group, in which either group is the polymerizable functional group.

### TECHNICAL FIELD

The invention relates to a liquid crystal polymerization film using a polymerizable liquid crystal composition as a raw material. More specifically, the invention relates to a liquid crystal polymerization film having optical anisotropy, and an alignment film of the liquid crystal polymerization film.

### BACKGROUND ART

Liquid crystal polymerization films prepared by polymerizing a polymerizable liquid crystal composition can be used as a film or a device formed of a phase difference film, an optical compensation film, a reflection film, a selective reflection film, an antireflection film, a viewing angle compensation film, a liquid crystal alignment film, a polarizing device, a circularly polarizing device, an elliptically polarizing device or other optically anisotropic bodies.

As the optical compensation film for the purpose of improvement of a quality of an image display, a stretched polymer film having birefringence has been used in a liquid crystal display apparatus. A study has been conducted on replacement of the polymer film into liquid crystal polymerization films for further improving the display quality of the liquid crystal display apparatus, and achievement of thin film of a liquid crystal display device in the liquid crystal display apparatus. In the above case, for example, when the liquid crystal polymerization films are used as a +A-plate, alignment of liquid crystals in higher order is required for performing ideal optical compensation.

The liquid crystal polymerization film is prepared by polymerizing the polymerizable liquid crystal composition on a base material with an alignment film. The alignment film in which alignment of molecules in the alignment film is arranged in a fixed direction induces alignment of liquid crystal compounds on the alignment film. The alignment film particularly induces alignment of the liquid crystal compounds into an azimuth direction or/and a polar angle direction relative to a plane of the base material.

Specific examples of a method of arranging alignment of molecules in the alignment film in a fixed direction include a rubbing method and a photoalignment method. The rubbing method is a method of providing the alignment film with liquid crystal alignability by rubbing a surface of the alignment film with cloth. The photoalignment method is a method of providing the alignment film with the alignability by using light. Accordingly, the photoalignment film has a photosensitive group within a material. As the photosensitive group, an azobenzene structure, a cyclobutane structure, a cinnamic acid structure, a chalcone structure or a coumarin structure has been known. Specific examples of publicly-known raw materials of the liquid crystal polymerization film include the following prior literature.

### CITATION LIST

### Patent Literature

Patent literature No. 1: JP 2014-205819 A.

Patent literature No. 2: JP 2015-040950 A.

Patent literature No. 3: JP 2015-212807 A.

### SUMMARY OF INVENTION

### Technical Problem

An object of the invention is to provide a phase difference film having high contrast.

### Solution to Problem

The present inventors have found that, in liquid crystal polymerization films prepared by combining a specific alignment film and a specific polymerizable liquid crystal composition, a liquid crystal skeleton being a constituent thereof is aligned in an order higher than ever before, and have completed the invention.

The content of the invention is items 1 to 12 described below.

Item 1. Liquid crystal polymerization films, prepared by applying a polymerizable liquid crystal composition containing a compound represented by formula (2) on an alignment film prepared by calcinating a composition containing a polymer represented by a repeating unit of formula (1), and subsequently polymerizing the polymerizable liquid crystal composition:

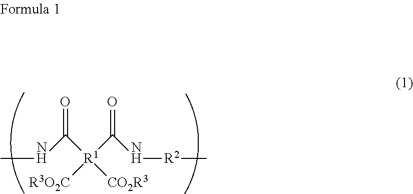

wherein, in formula (1), R¹ is independently a tetravalent group, R² is independently a divalent functional group and R³ is independently a hydrogen atom or a monovalent group:

Formula 2

PG¹-Sp¹-R⁴-Sp²-PG² (2)

wherein, in formula (2), R⁴ represents a divalent group formed by combining five or more and nine or less of alicycles and/or aromatic rings; SP¹ and SP² represent a spacer group; and PG¹ and PG² are an alkyl group, an alkoxyl group, a cyano group, fluorine or a polymerizable functional group, in which either group is the polymerizable functional group.

Item 2. The liquid crystal polymerization films according to item 1, wherein a content of a hydroxyl group, an amino group or a carboxyl group contained in the alignment film is 0.1 or more and less than 2 based on the repeating unit of formula (1).

Item 3. The liquid crystal polymerization films according to item 1, prepared by polymerizing the polymerizable liquid crystal composition, and then calcinating the resulting material at 140° C. or higher.

Item 4. The liquid crystal polymerization films according to any one of items 1 to 3, wherein the alignment film is a photoalignment film.

Item 5. The liquid crystal polymerization films according to item 4, wherein a photosensitive group of the photoalignment film has an azobenzene structure, a cyclobutane structure, a cinnamic acid structure, a chalcone structure or a coumarin derivative structure.

Item 6. The liquid crystal polymerization films according to any one of items 1 to 5, having characteristics of a positive A-plate.

Item 7. The liquid crystal polymerization films according to items 1 to 6, wherein R¹ in formula (1) is represented by any one of formulas (1-A) to (1-D):

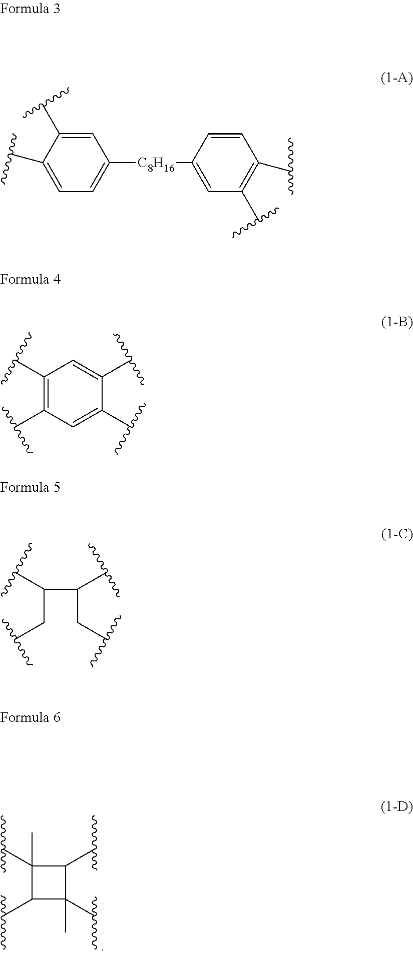

Item 8. The liquid crystal polymerization films according to item 7, wherein R² in formula (1) is a group represented by any one of formulas (1-F) to (1-N):

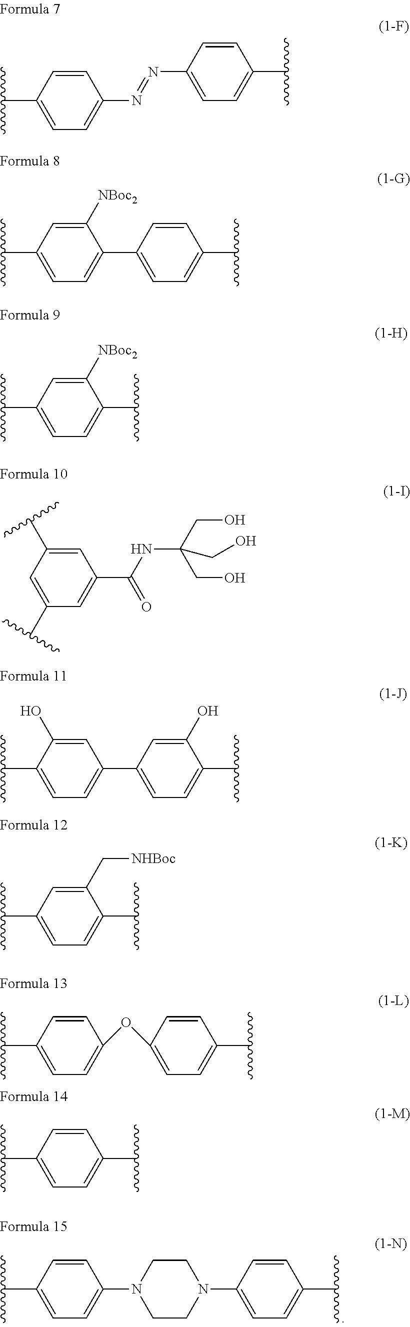

Item 9. The liquid crystal polymerization films according to item 8, containing a compound represented by formula (2-A):

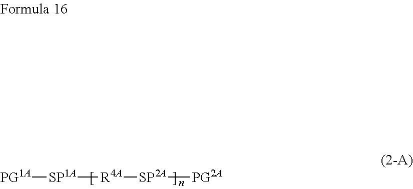

wherein, in formula (2-A),

R^{4A} is independently a group represented by formula (2-A-a) to formula (2-A-o):

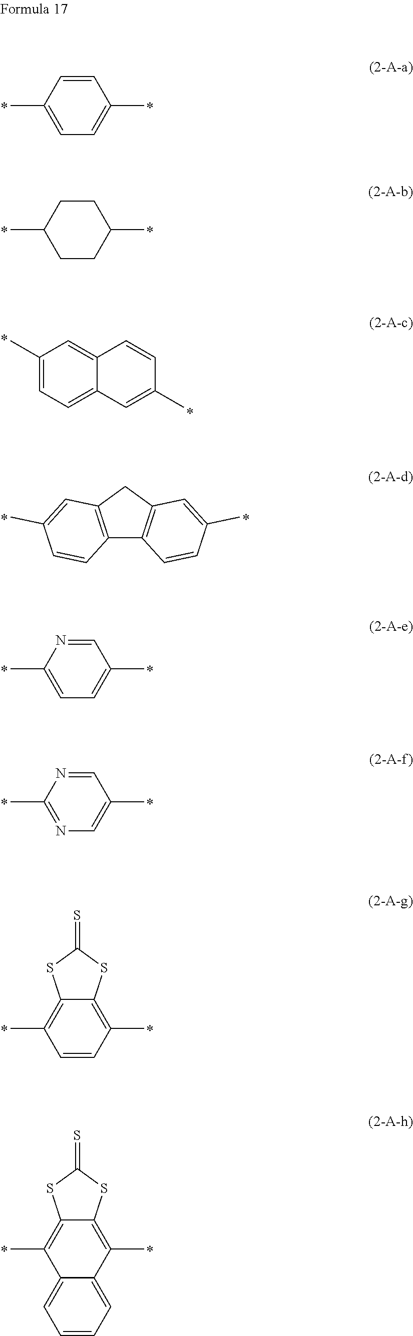

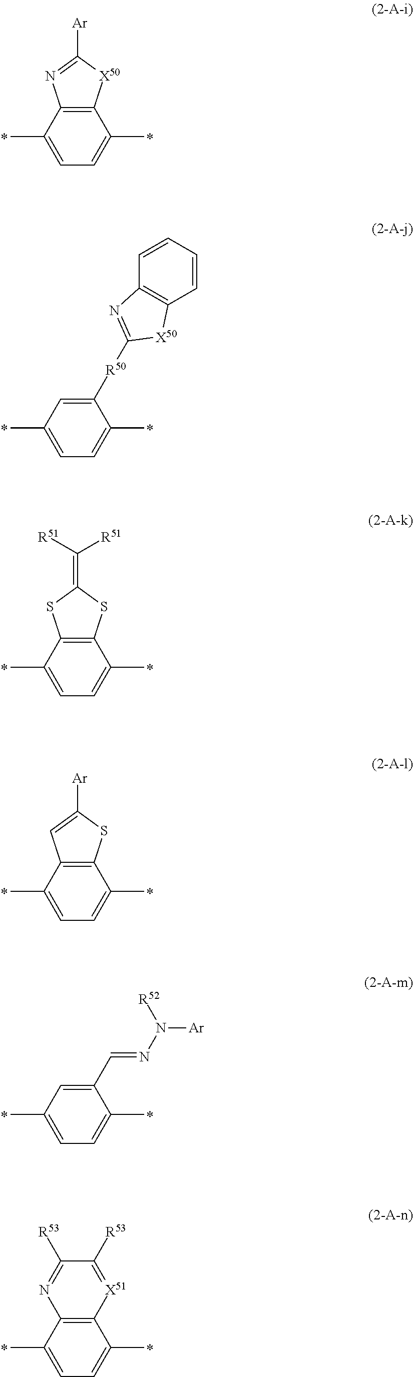

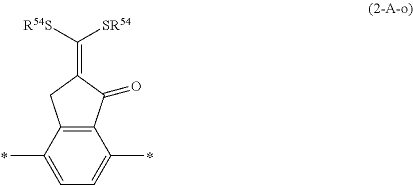

wherein, in formula (2-A-a) to formula (2-A-o),

an asterisk * represents a bonding position to SP^{1A} or SP^{2A};

Ar is an aromatic group having 14 or less carbons or a group in which aromatics are conjugated;

X⁵⁰ is —NH—, —O— or —S—,

X⁵¹ is ═CH— or ═N—;

R⁵⁰ is a single bond or —CH═CH—;

R⁵¹ is —CO₂R⁵¹1 or —CN;

R¹¹ represents an alkyl group having 10 or less carbons, and one methylene in the alkyl group or one hydrogen in the methyl group may be replaced by a (meta)acryloxy group;

R⁵² represents a hydrogen atom or an alkyl group having 10 or less carbons, and one methylene in the alkyl group or one hydrogen in the methyl group may be replaced by a (meta)acryloxy group;

R⁵³ is independently a hydrogen atom, an alkyl group having 5 or less carbons or an aromatic group having 10 or less carbons;

R⁵⁴ represents an alkyl group having 5 or less carbons, and two pieces of R⁵⁴ may be bonded into a ring structure; and

in formula (2-A-a) to formula (2-A-o),

one hydrogen may be substituted for an alkyl group having 1 to 5 carbons (in which arbitrary —CH₂— in the alkyl group may be substituted for —O—, —CO— or —COO— and arbitrary —CH₂—CH₂— may be replaced by —CH═CH—, and hydrogen in the alkyl group may be substituted for a halogen group) or a halogen group;

SP^{1A} and SP^{2A} are independently a single bond or alkylene having 2 to 4 carbons, and —CH₂— in the alkylene may be substituted for —O—, —CO— or —COO—; and

PG^{1A} is a functional group represented by formula (2-B):

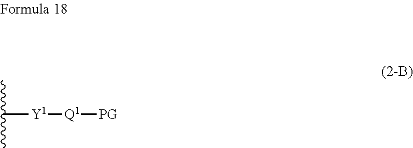

wherein, in formula (2-B),

Y¹ is a single bond, —O—, —COO—, —OCO— or —OCOO—;

Q¹ is a single bond or alkylene having 1 to 20 carbons, and in the alkylene, at least one piece of —CH₂— may be replaced by —O—, —COO— or —OCO—, and PG is a (meta)acrylic group; and

PG² is an alkyl group, an alkoxyl group, a cyano group, fluorine or a functional group represented by formula (2-B); and

n is an integer from 5 to 9.

Item 10. The liquid crystal polymerization films according to item 9, wherein a content of a compound represented by formula (2-A) in a polymerizable liquid crystal composition is 70% by weight or more based on other polymerizable compounds.

Item 11. The liquid crystal polymerization films according to item 9, wherein the polymerizable liquid crystal composition contains a compound represented by formula (2-A) only.

Item 12. A phase difference film, using the liquid crystal polymerization films according to any one of items 1 to 11.

### Advantageous Effects of Invention

According to the invention, contrast in liquid crystal polymerization films to be utilized for a phase difference film is improved.

### DESCRIPTION OF EMBODIMENTS

In the invention, “contrast” means a value obtained by dividing (luminance in a parallel Nicol state) by (luminance in a crossed Nicol state) upon matching an alignment direction of a liquid crystal polymerization film with a base material and one axis of polarizing plates to arrange the liquid crystal polymerization film with the base material between two polarizing plates.

In the invention, “crossed Nicol state” means a state in which polarization axes of polarizing plates arranged facing each other are orthogonally crossed.

In the invention, “parallel Nicol state” means a state in which polarization axes of polarizing plates arranged facing each other are agreed.

In the invention, “An” represents birefringence of a phase difference film.

In the invention, “compound (X)” means a compound represented by formula (X). Here, X in “compound (X)” means a character string, a numerical character, a symbol or the like.

In the invention, “liquid crystal compound” is a generic term for a compound having a liquid crystal phase as a pure material (A) and a compound serving as a component of the liquid crystal composition (B).

In the invention, “polymerizable group” means a functional group that is polymerized by light, heat, a catalyst and other means to give a capability of changing a compound into a polymer having larger molecular weight. An acrylic group, a methacrylic group or the like is the polymerizable group.

In the invention, “hydrogen-donating group” means a hydroxyl group, an amino group, a carboxyl group or other functional groups in which hydrogen is adjacent to an atom having higher electronegativity than the electronegativity of carbon.

In the invention, “photosensitive group” means a functional group specific to a compound of causing a chemical reaction by excitation of an electron in molecules. A photolytic reaction, a photoisomerization reaction or the like is the chemical reaction.

In the invention, “polymerizable compound” means a compound having a polymerizable group.

In the invention, “monofunctional compound” means a compound having one polymerizable group.

In the invention, “polyfunctional compound” means a compound having a plurality of polymerizable groups.

In the invention, “X functional compound” means a compound having X pieces of polymerizable groups. Here, X in “X functional compound” is an integer.

In the invention, “polymerizable liquid crystal compound” means a liquid crystal compound and a compound having a polymerizable group.

In the invention, “non-liquid crystalline polymerizable compound” means a polymerizable compound and a compound having no liquid crystal phase as a single body.

In the invention, “polymerizable liquid crystal composition” means a composition containing a polymerizable compound and a liquid crystal compound, and a composition containing “polymerizable liquid crystal compound.”

In the invention, “alignment film” means a film causing alignment of liquid crystals.

In the invention, “photoalignment film” means an alignment film to be formed by light.

In the invention, “base material with an alignment film” means a base material having an alignment film.

In the invention, “base material” is a generic term for a base material with an alignment film and an alignment film with no base material.

In the invention, “liquid crystal polymerization film” means a film obtained by polymerizing a polymerizable liquid crystal composition.

In the invention, “liquid crystal polymerization film with a base material” means a material that is obtained by polymerizing a polymerizable liquid crystal composition on a base material and contains the base material.

In the invention, “liquid crystal polymerization films” is a generic term for “liquid crystal polymerization film” and “liquid crystal polymerization film with a base material.”

In the invention, “phase difference film” means a light transforming device having optical anisotropy. The phase difference film includes the liquid crystal polymerization films.

In the invention, “alignment” represents a state in which major axes (easy axes of alignment) of liquid crystal molecules are arranged in a fixed direction in an optically available state.

In the invention, “tilt angle” means an angle between a direction of alignment of liquid crystal molecules and a plane of a base material.

In the invention, “homogeneous alignment” represents a state in which the tilt angle is from 0 degrees to 5 degrees and liquid crystal molecules are uniaxially aligned in an azimuth direction on a plane of a base material.

In the invention, “homeotropic alignment” represents a state in which the tilt angle is from 85 degrees to 90 degrees and liquid crystal molecules are uniaxially aligned.

In the invention, “tilt alignment” represents a state in which liquid crystal molecules are aligned in such a manner that the tilt angle is increased according to a distance from a plane of the base material.

In the invention, “twist alignment” means a state in which a direction of alignment of liquid crystal molecules in a major axis direction is parallel to a base material, and the liquid crystal molecules are twisted stepwise with a helical axis as a center accordingly as the liquid crystal molecules are separated from the base material.

When the functional group described below is described in the chemical formula, a wavy line part means a bonding position of the functional group. C described below herein represents an arbitrary atom or functional part.

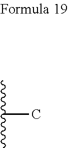

### Alignment Film

Alignment of polymerizable liquid crystals in the alignment film can be induced into an azimuth or/and polar angle direction relative to the plane of the base material by arranging alignment of the functional groups in contact with the liquid crystal compound in a fixed direction.

Polyamic acid represented by formula (1) and a derivative thereof serve as a raw material of the alignment film.

A rubbing method of rubbing an alignment film surface with cloth, a photoalignment method by irradiation with polarized light or the like is a method of arranging the alignment in a fixed direction.

In the invention, contrast in the liquid crystal polymerization film can be improved, and therefore the photoalignment method is preferred.

In the photoalignment method, incorporation of the photosensitive group into the alignment film is required. In order to align the molecules even with a small amount of light exposure, as the photosensitive group, an azobenzene structure, a cyclobutane structure, a cinnamic acid structure, a chalcone structure or a coumarin derivative structure is preferred.

In order to improve the contrast, an azobenzene structure or a cyclobutane derivative structure in which anchor energy to the liquid crystal compound is high to easily align the liquid crystal compounds is further preferred.

A plurality of kinds of photosensitive groups can be combined and used.

The photoalignment film of the invention can be obtained by introducing the photosensitive group into diamine being a raw material of the alignment film or a diamine derivative being the raw material of the alignment film, or tetracarboxylic dianhydride being the raw material of the alignment film or a tetracarboxylic dianhydride derivative being the raw material of the alignment film. Such diamine having the photosensitive group, such tetracarboxylic dianhydride having the photosensitive group and the derivative thereof may be simultaneously used.

A structure represented by formula (P-1) to formula (P-7) or the like is the photosensitive group.

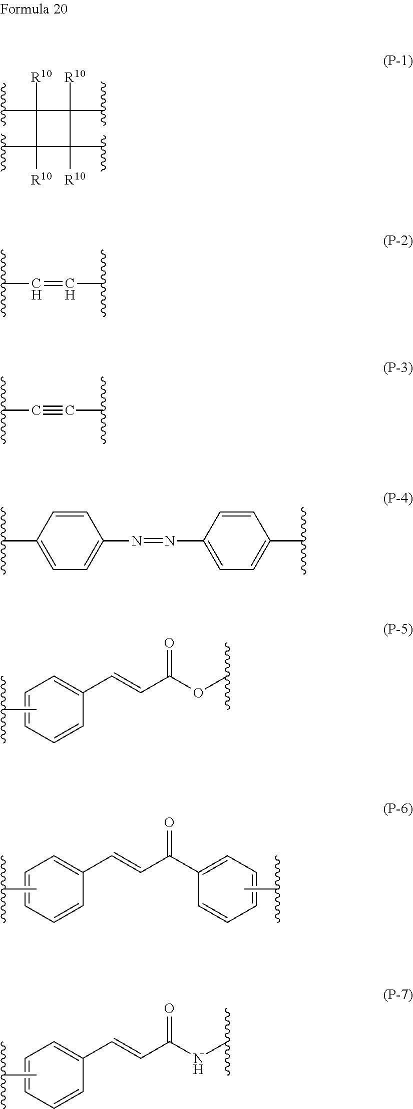

In formula (P-1), R¹⁰ is independently a hydrogen atom, an alkyl group having 1 to 5 carbons or a phenyl group.

The molecules can be aligned even with a small amount of light exposure, and therefore a compound represented by formula (PA-1) to formula (PA-6) is preferred as a compound having the photosensitive group having formula (P-1).

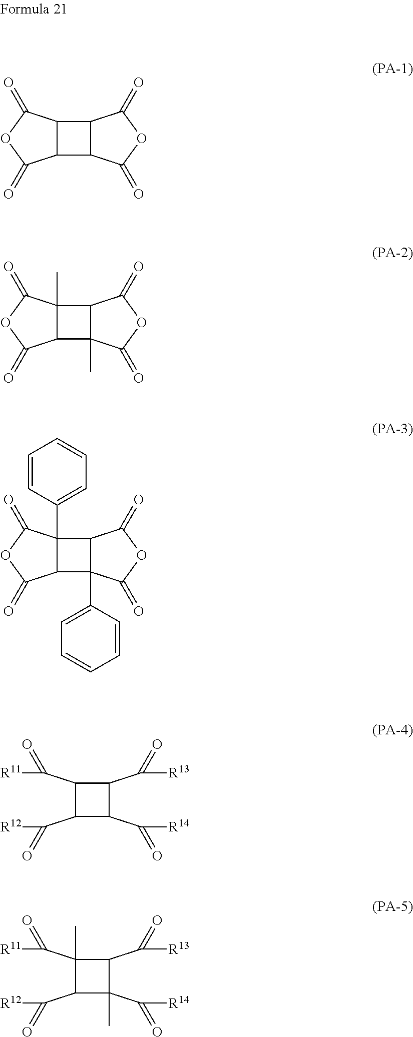

In formula (PA-4) and formula (PA-5), one of R¹ and R¹² is an alkyloxy group having 1 to 5 carbons, and the other of R¹ and R¹² is —OH or —Cl.

One of R¹³ and R¹⁴ is an alkoxy group having 1 to 5 carbons, and the other of R¹³ and R¹⁴ is —OH or —Cl.

The molecules can be aligned even with a small amount of light exposure, and therefore a compound represented by formula (II-1), formula (II-2), formula (III-1), formula (III-2), formula (IV-1) and formula (VI-2) is preferred as a compound having a photosensitive group having formula (P-2) to formula (P-5).

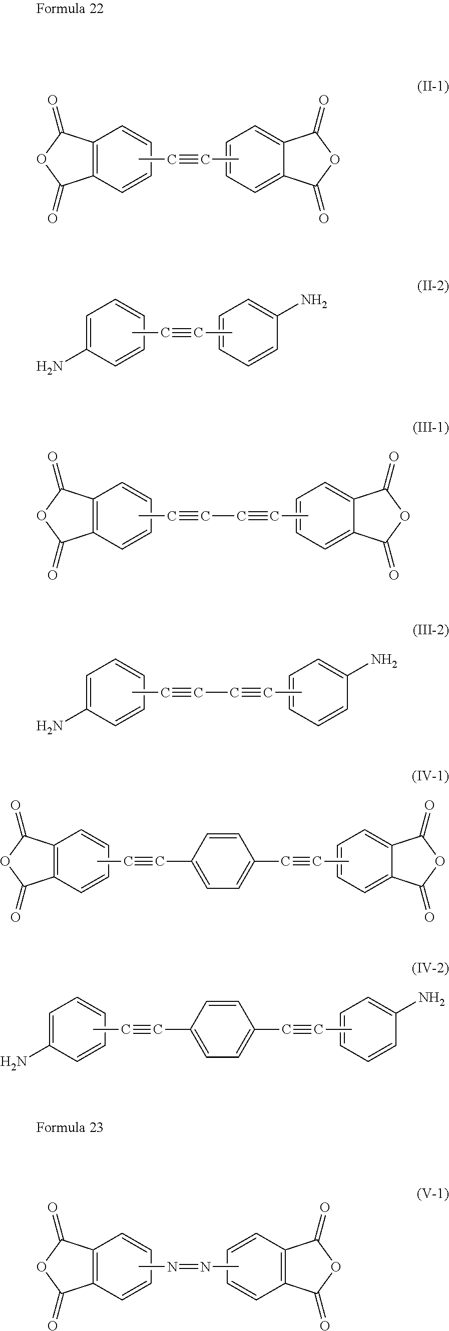

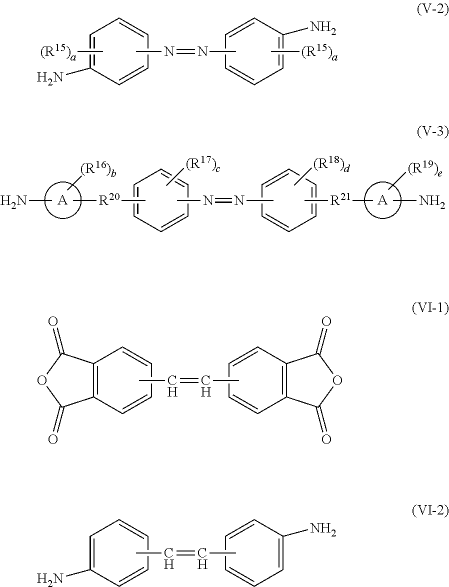

In formula (V-2),

R¹⁵ is independently —CH₃, —OCH₃, —CF₃ or —COOCH₃, and

a is independently an integer from 0 to 2.

In formula (V-3),

ring A and ring B are independently a monocyclic hydrocarbon, a fused polycyclic hydrocarbon and a heterocycle,

R²⁰ and R²¹ are straight-chain alkylene having 1 to 20 carbons, —COO—, —OCO—, —NHCO— or —N(CH₃)CO—, and one or two pieces of —CH₂— in the straight-chain alkylene may be replaced by —O—,

R¹⁶ to R¹⁹ are independently —F, —CH₃, —OCH₃, —CF₃ or —OH, and

b to e are independently an integer from 0 to 4.

From a viewpoint of improving the contrast in the liquid crystal polymerization films, a compound represented by formula (V-2), (V-3) and (VI-2) each described above is further preferred as a component of the raw material of the liquid crystal polymerization film.

In order to induce alignment of the liquid crystal compounds by using a photosensitive group, a compound having an amino group in a para-position of —N═N— bond in formula (V-2) is further preferred as the component of the raw material of the liquid crystal polymerization film.

From the viewpoint of improving the contrast in the liquid crystal polymerization films, when ring A in formula (VI-2) is a six-membered ring, a compound having an amino group in a para-position of R²⁰ is further preferred as the component of the raw material of the liquid crystal polymerization film.

From the viewpoint of improving the contrast in the liquid crystal polymerization films, when ring B in formula (VI-2) is a six-membered ring, a compound having an amino group in a para-position of R²¹ is further preferred as the component of the raw material of the liquid crystal polymerization film.

From the viewpoint of improving the contrast in the liquid crystal polymerization films, a compound in which a=0 in formula (V-2) is preferred as the component of the raw material of the liquid crystal polymerization film.

Compounds represented by the formulas below and so forth show specific examples of compounds represented by formulas (II-1) to (VI-2).

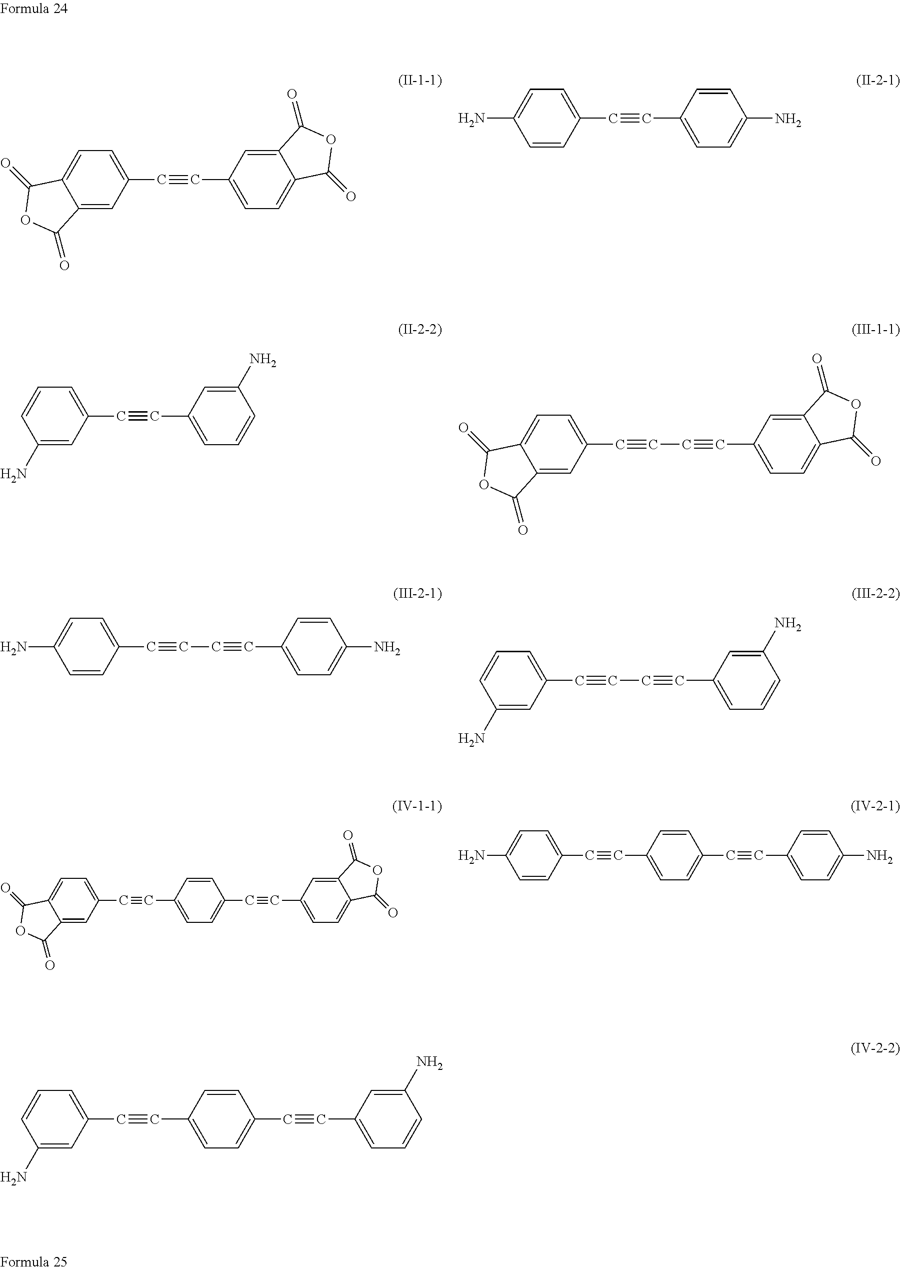

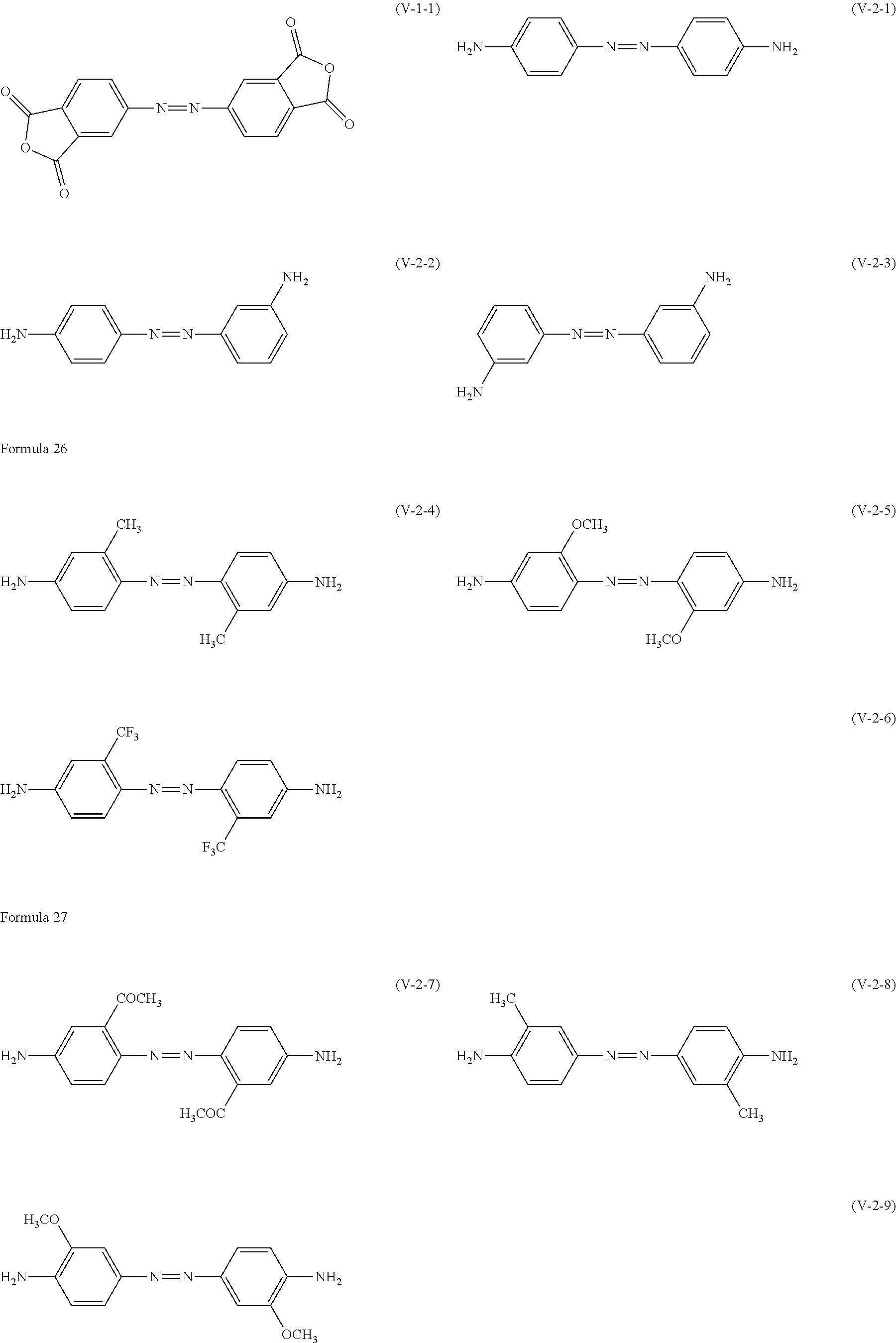

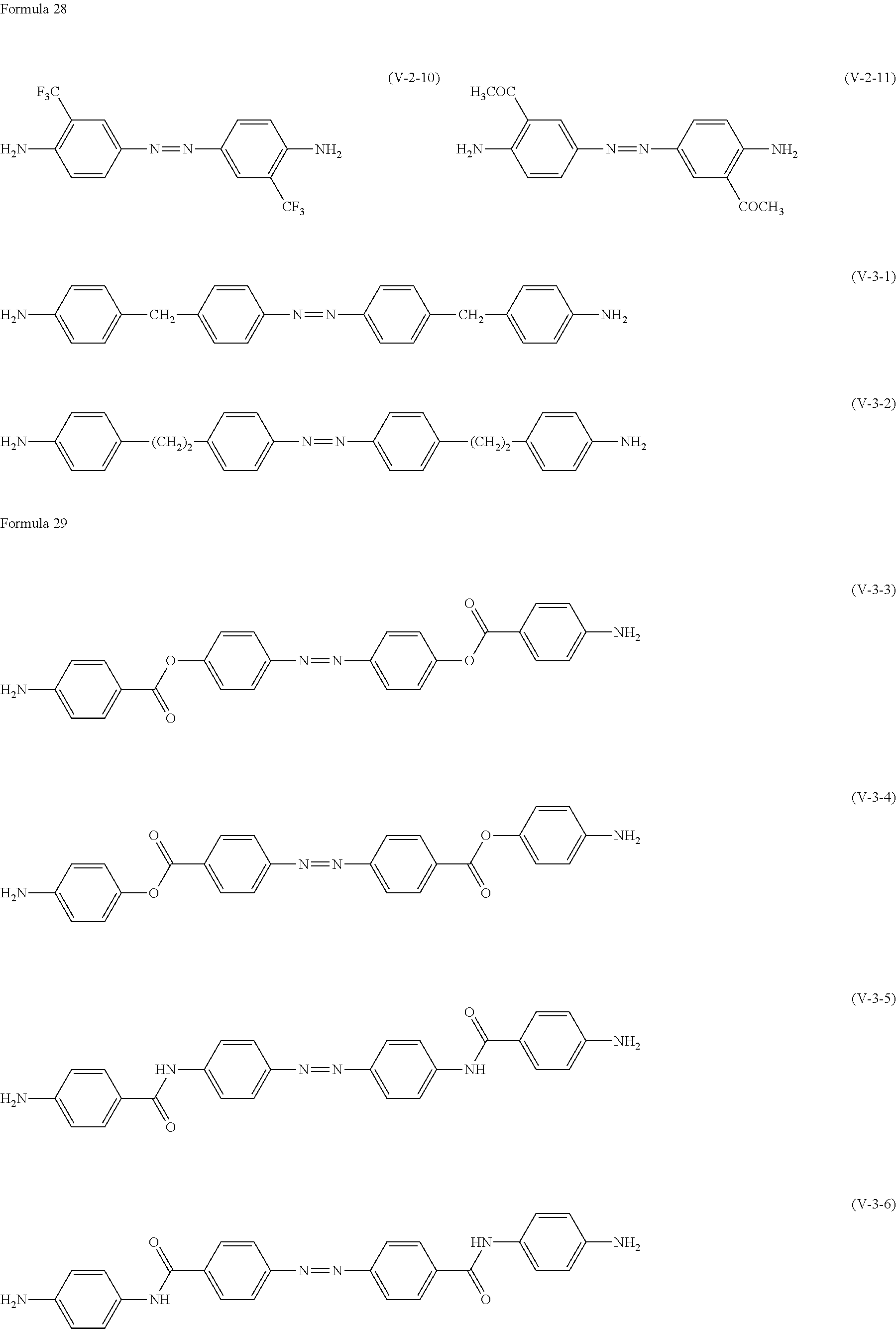

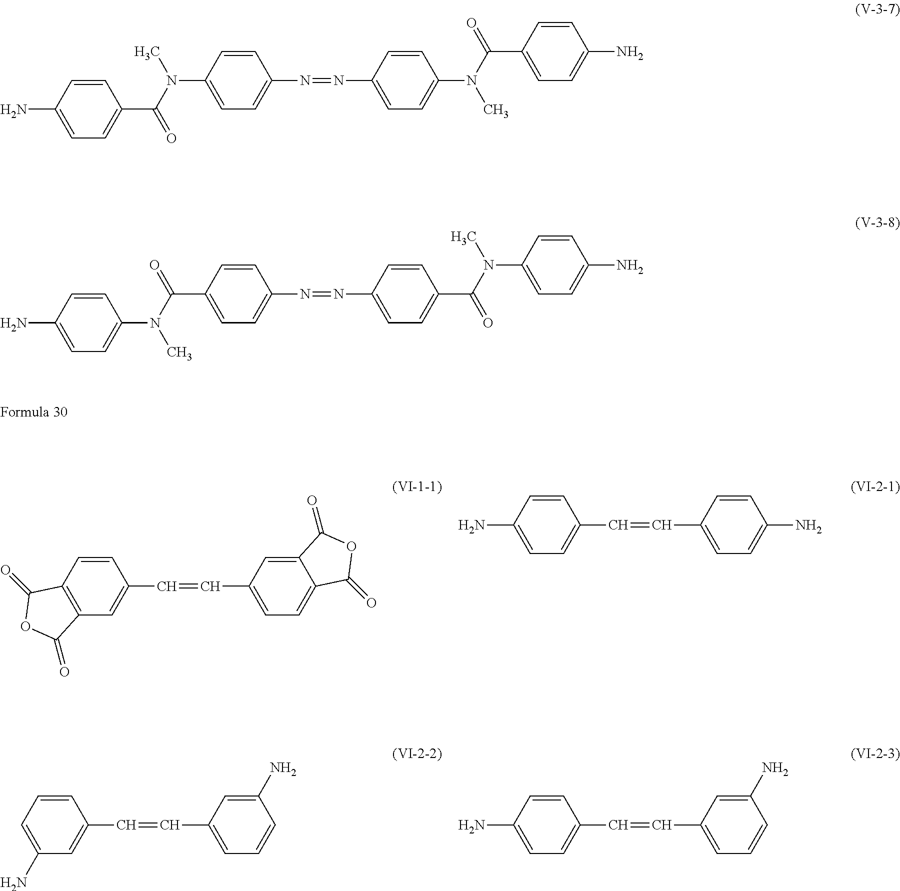 [SMILES: CN(C(=O)c1ccc(N)cc1)c1ccc(N=Nc2ccc(N(C)C(=O)c3ccc(N)cc3)cc2)cc1 ; CN(C(=O)c1ccc(N=Nc2ccc(C(=O)N(C)c3ccc(N)cc3)cc2)cc1)c1ccc(N)cc1 ; O=C1OC(=O)c2cc(C=Cc3ccc4c(c3)C(=O)OC4=O)ccc21 ; Nc1ccc(C=Cc2ccc(N)cc2)cc1 ; Nc1cccc(C=Cc2cccc(N)c2)c1 ; Nc1ccc(C=Cc2cccc(N)c2)cc1]

The molecules are aligned even with a small amount of light exposure, and a compound represented by formula (II-2-1), formula (III-1-1), formula (III-2-1), formula (IV-1-1), formula (IV-2-1), formula (V-2-1), formula (V-2-4), formula (V-2-6), formula (V-2-7), formula (V-3-1), formula (V-3-2), formula (V-3-3), formula (V-3-5), formula (V-3-7) or formula (VI-2-1) is further preferred as a component of a raw material of the photoalignment film.

A degree of coloring of the alignment film is low, and therefore a compound represented by formula (II-2-1), formula (III-1-1), formula (III-2-1), formula (IV-1-1), formula (V-2-1), formula (V-3-1), formula (V-3-2) or formula (VI-2-1) is further preferred as the component of the raw material of the photoalignment film.

Anisotropy of the liquid crystal polymerization film formed on the alignment film is increased, and therefore a compound represented by formula (V-2-1) is further preferred as the component of the raw material of the alignment film.

Compounds represented by formulas (PDI-1) to (PDI-5) and so forth show specific examples of a compound having a cinnamic acid structure being a photosensitive group.

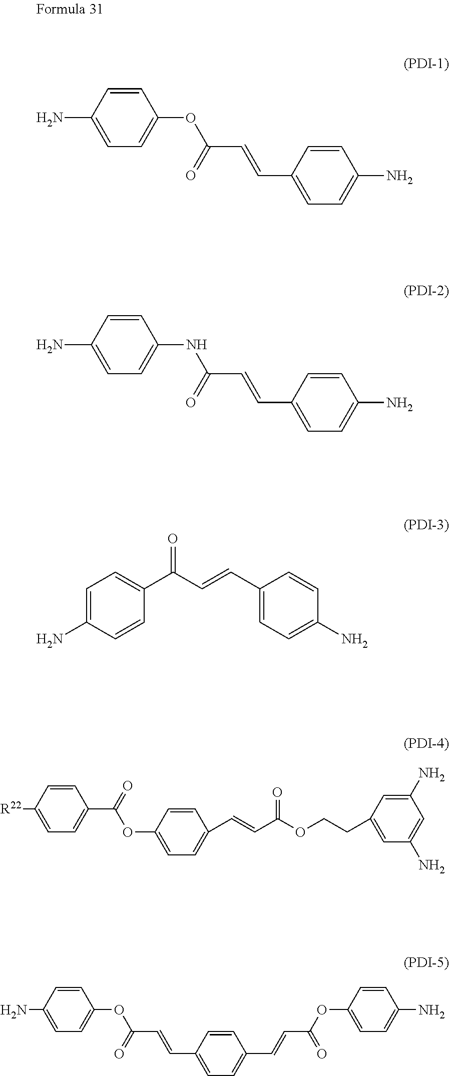

In formula (PDI-4), R²² is alkyl or alkoxy having 1 to 10 carbons, and at least one hydrogen in the alkyl or the alkoxy may be substituted for fluorine.

The molecules are aligned even with a small amount of light exposure, and therefore a compound represented by formulas (PDI-1) and (PDI-3) each is further preferred as the component of the raw material of the alignment film by the photoalignment method.

The contrast in the liquid crystal polymerization films is improved, and therefore a material in which liquid crystal alignability is amplified by calcination is preferred as the photoalignment film. Diamine having a flexible skeleton or tetracarboxylic dianhydride and a derivative thereof are preferred, and a compound represented by formula (FL-1) to formula (FL-4) each is further preferred.

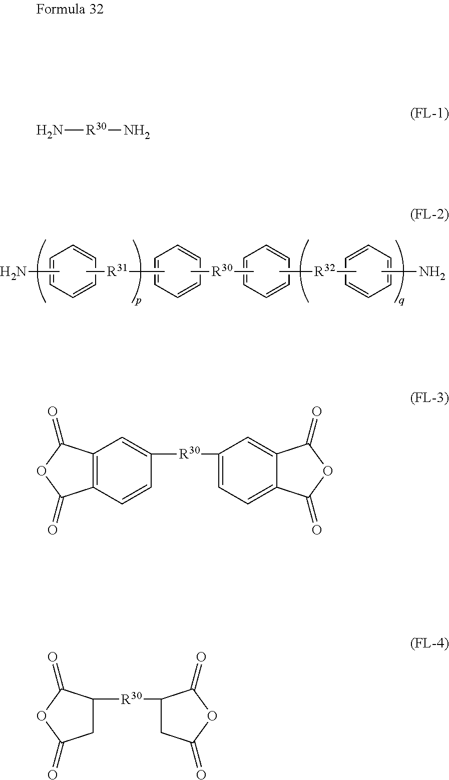

In formula (FL-1) to formula (FL-4),

R³⁰ is alkylene having 2 to 12 carbons, and —CH₂— of the alkylene may be replaced by —CH═CH—, —C≡C—, —O—, —NCH₃—, —CO₂— or —CONR³³—,

R³¹ and R³² are a single bond or alkylene having 2 to 12 carbons,

R³³ is —H or —CH₃, and

p and q are 0 or 1.

A benzene ring in formula (FL-2) to formula (FL-3) may be replaced by —CH₃, —CH₂CH₃, —OCH₃ or fluorine.

Compounds represented by formulas (FL-1-1) to (FL-4-6) and so forth show specific examples of compounds represented by formulas (FL-1) to (FL-4). From the viewpoint of improving the contrast, a compound represented by formula (FL-3-2) to formula (FL-3-5) each is most preferred in the formulas (FL-1-1) to (FL-4-6).

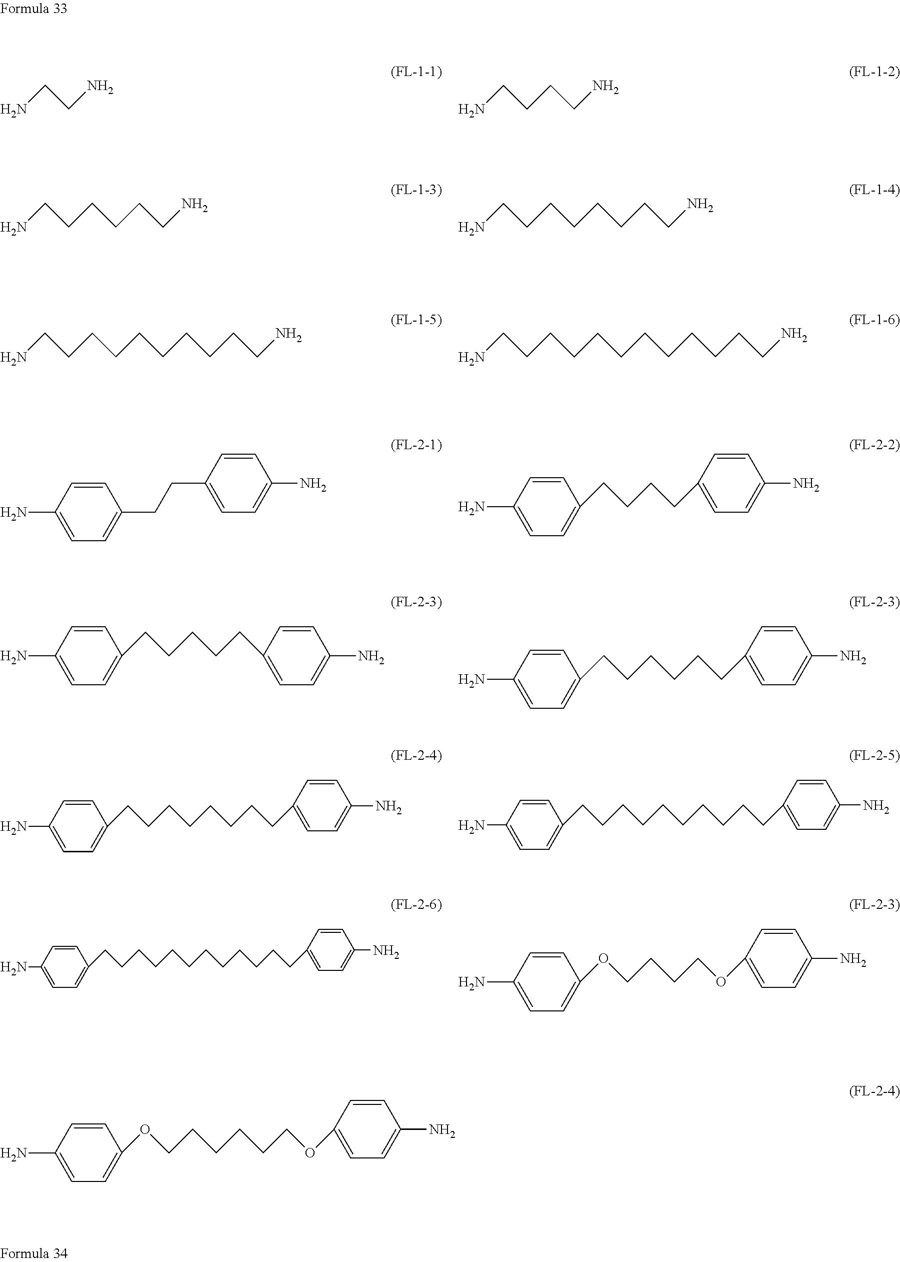

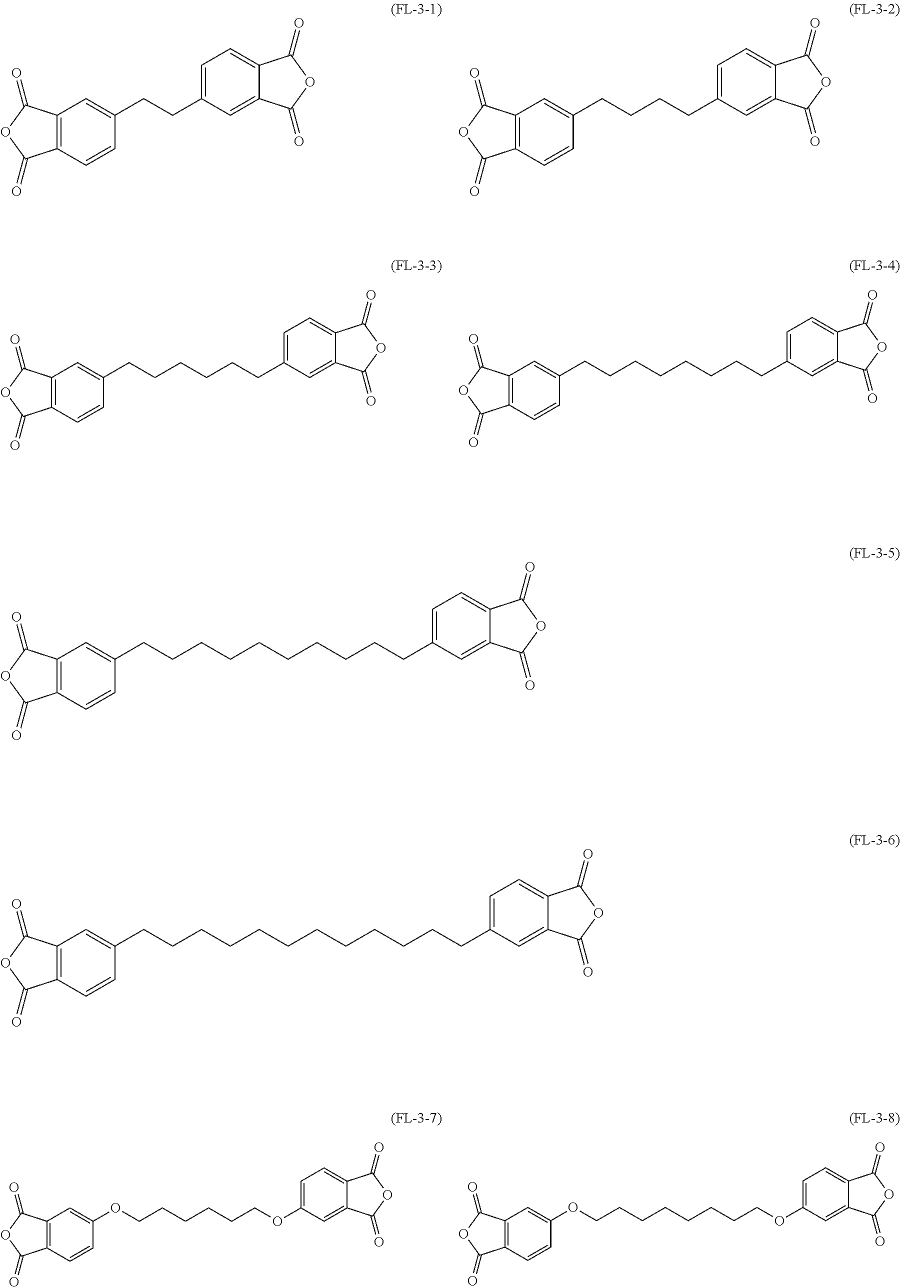

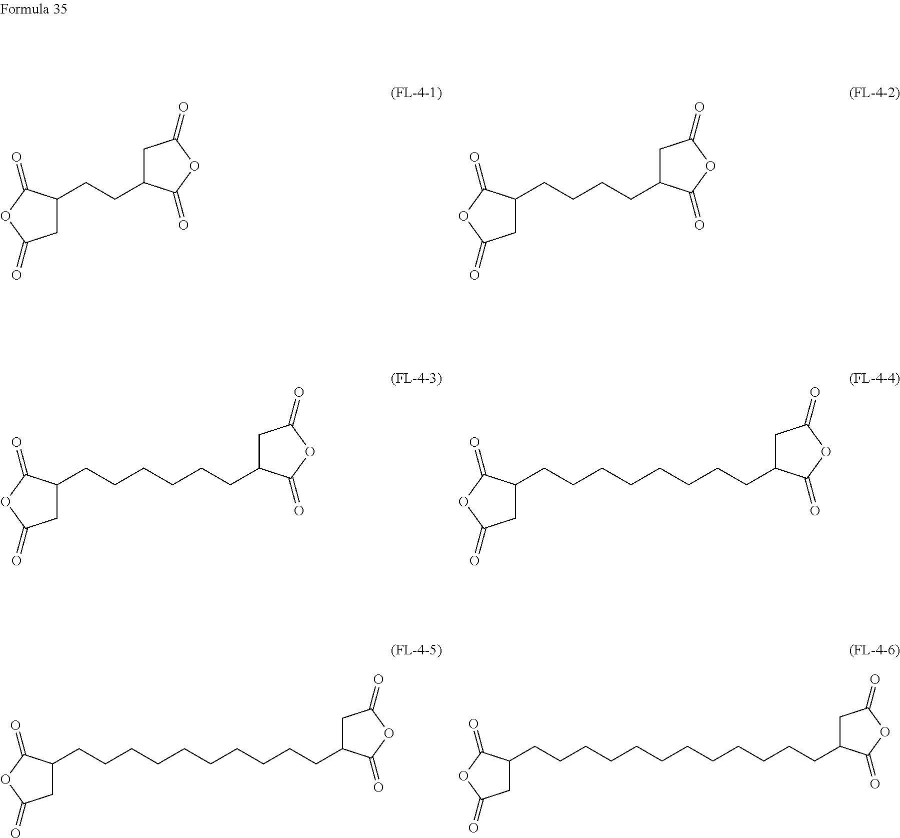 [SMILES: O=C1CC(CCC2CC(=O)OC2=O)C(=O)O1 ; O=C1CC(CCCCC2CC(=O)OC2=O)C(=O)O1 ; O=C1CC(CCCCCCC2CC(=O)OC2=O)C(=O)O1 ; O=C1CC(CCCCCCCCC2CC(=O)OC2=O)C(=O)O1 ; O=C1CC(CCCCCCCCCCC2CC(=O)OC2=O)C(=O)O1 ; O=C1CC(CCCCCCCCCCCCC2CC(=O)OC2=O)C(=O)O1]

The contrast in the liquid crystal polymerization film with the base material is improved, and simultaneously difficulty in flaking between the liquid crystal polymerization film and the base material is improved, and therefore an amount of the hydrogen-donating group based on the repeating unit in the raw material of the alignment film is preferably from 0.1 to 2, and further preferably from 0.1 to 1. If an attempt is made on reinforcing bonding between the alignment film and the liquid crystal polymerization film, the alignment in the liquid crystal polymerization film by the alignment film has been so far disordered, and the contrast of the liquid crystal polymerization film with the base material has been so far reduced. Therefore, an improvement in the alignment film has been considered to cause no satisfaction of both the contrast of the liquid crystal polymerization film and difficulty in flaking between the liquid crystal polymerization film and the base material.

The alignment film of the invention can be obtained by introducing such a hydrogen-donating group into diamine, or tetracarboxylic dianhydride and the derivative thereof, each being the raw material of the alignment film. Diamine having such a hydrogen-donating group, and tetracarboxylic dianhydride and the derivative thereof each having such a hydrogen-donating group may be simultaneously used. As diamine, tetracarboxylic dianhydride and the derivative thereof as described above, a publicly-known material can be used without particular restriction, but a compound represented by formula (PQ-1) is preferably used because ease of availability.

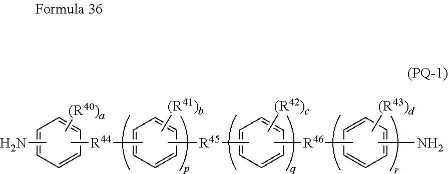

In formula (PQ-1),

R⁴⁰, R⁴¹, R⁴² and R⁴³ are independently a group having —OH, —CO—C(CH₃)₃, —COOH, —CONH₂ or —NH—CO—C(CH₃)₃,

a, b, c and d are independently 1 to 4,

R⁴⁴, R⁴⁵ and R⁴⁶ are a single bond or alkylene having 2 to 12 carbons, and —CH₂— in the alkylene may be replaced by —CH═CH—, —C≡C—, —O—, —N(CH₃)—, —COO— or —CONR⁴³—, in which R⁴³ is —H or —CH₃, and

p, q and r are independently 0 or 1.

As diamine represented by formula (PQ-1), formula (PQ-1-1) to formula (PQ-1-17) are preferred.

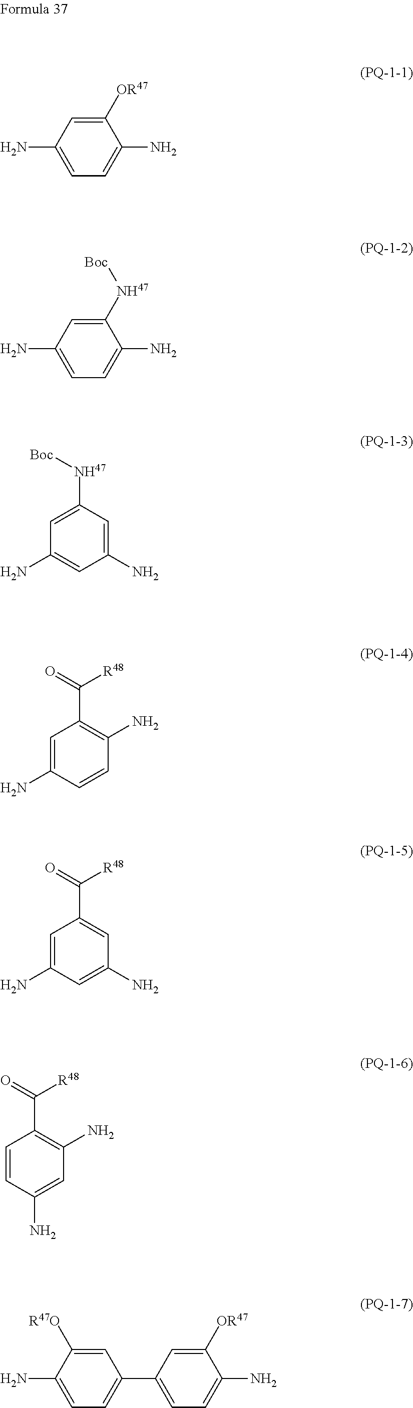

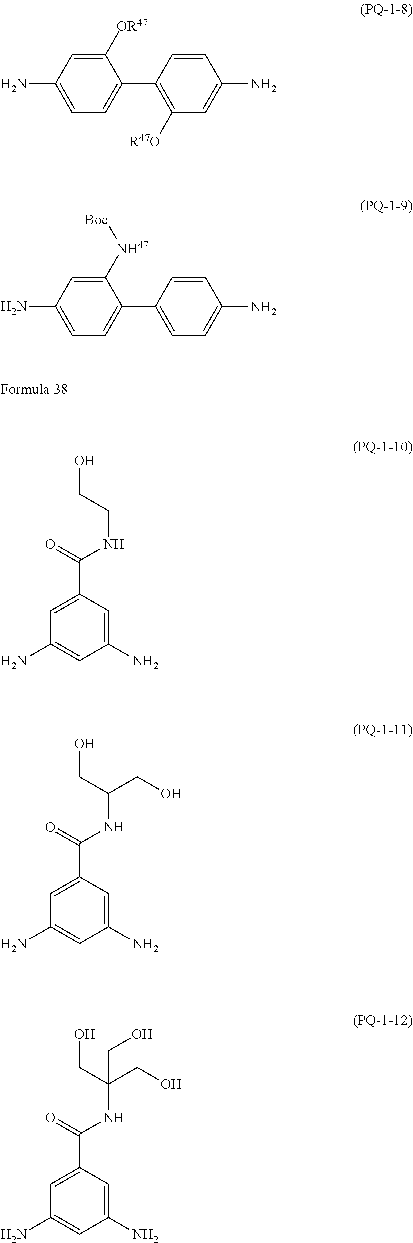

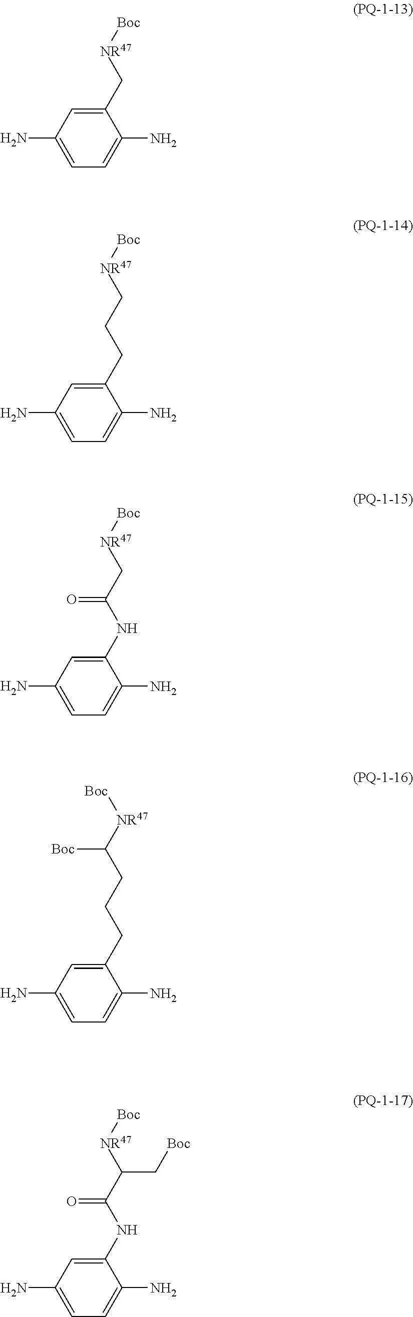

Among kinds of diamine having the hydrogen-donating group, a compound represented by formulas (PQ-2) and (PQ-3) each is also preferred.

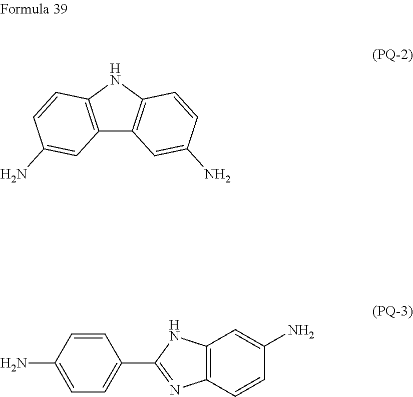 [SMILES: Nc1ccc2[nH]c3ccc(N)cc3c2c1 ; Nc1ccc(-c2nc3ccc(N)cc3[nH]2)cc1]

A content of the hydrogen-donating group in the alignment film prepared using polyamic acid represented by formula (1) can be adjusted by preparation of the raw material and adjustment of reaction conditions such as temperature.

In order to improve adhesion to the base material, a silane coupling agent is preferably incorporated into the alignment film prepared using polyamic acid.

### Polymerizable Liquid Crystal Compound

In order to obtain a liquid crystal polymer having high contrast, a polymerizable liquid crystal compound represented by general formulas (2-1) to (2-10) below is preferred used as the raw material.

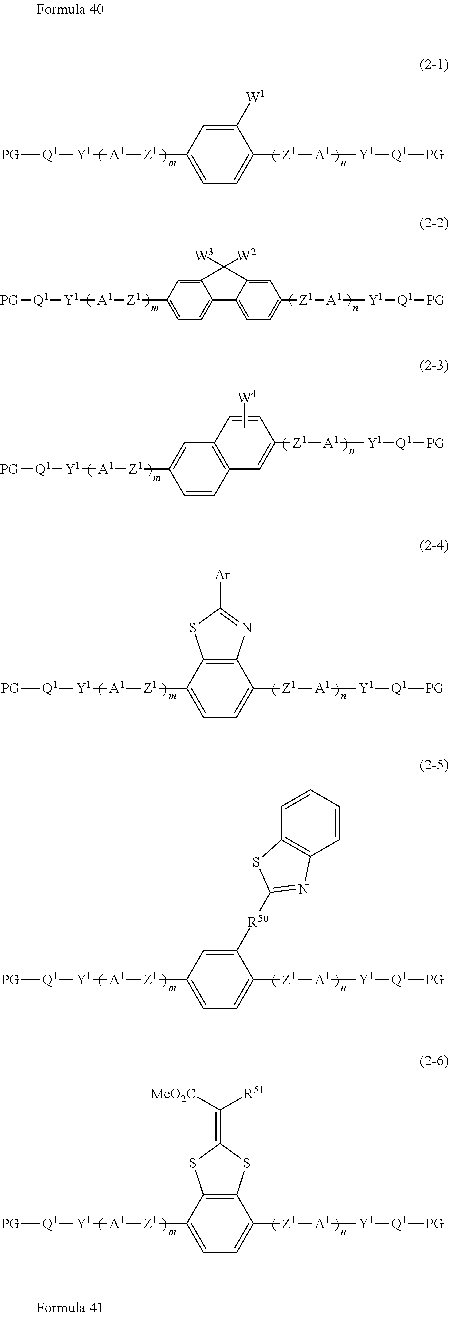

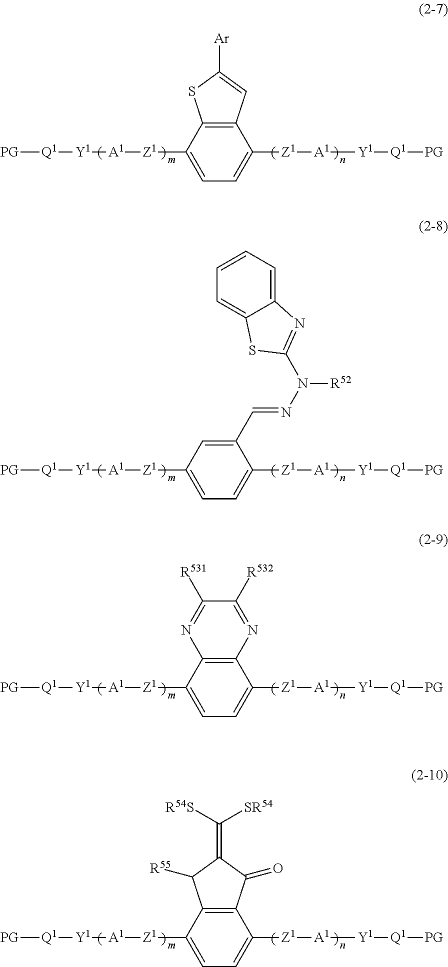

In formula (2-1),

W¹ is hydrogen, fluorine, chlorine or an organic group having 1 to 5 carbons. From a viewpoint of extension of a temperature range in which a liquid crystal phase is developed when the compound is processed into a composition, compatibility with other liquid crystal compounds and solubility in a solvent or the like (hereinafter, the viewpoint is referred to as “viewpoint of ease of handling”),

W¹ is further preferably alkyl having 1 to 5 carbons, alkoxycarbonyl having 1 to 4 carbons, aldehyde or alkylcarbonyl having 1 to 4 carbons.

In formula (2-2), W² is hydrogen, fluorine, chlorine or an organic group having 1 to 5 carbons. From the viewpoint of ease of handling, W² is further preferably alkyl having 1 to 5 carbons.

In formula (2-3), W⁴ is hydrogen, fluorine or an organic group having 1 to 5 carbons. From the viewpoint of ease of handling, W⁴ is preferably alkyl having 1 to 5 carbons, alkoxycarbonyl having 1 to 4 carbons, aldehyde or alkylcarbonyl having 1 to 4 carbons.

In formula (2-4), Ar is an aromatic group having 14 or less carbons or a group in which aromatics are conjugated. From the viewpoint of ease of handling, Ar is further preferably phenyl, pyridyl, naphthyl or a thiophene group.

In formula (2-5), R⁵⁰ represents a single bond or —CH═CH—. From a viewpoint of light resistance, R⁵⁰ is preferably a single bond.

In formula (2-6), R⁵¹ represents —CO₂R⁵¹¹ or —CN, and R⁵¹¹ represents an alkyl group that has 10 or less carbons and may be replaced by a (meth)acryloxy group. For extending the temperature range in which the liquid crystal phase is developed when the compound is processed into the composition and for improving the contrast, R⁵¹ is preferably —CO₂Me or —CN.

In formula (2-7), Ar is an aromatic group having 14 or less carbons or a group in which aromatics are conjugated. From the viewpoint of ease of handling, and for improving the contrast, Ar is preferably phenyl, pyridyl, naphthyl and a thiophene group.

In formula (2-8), R⁵² represents a hydrogen atom and an alkyl group having 10 or less carbons, and one methylene or a methyl group in the alkyl group may be replaced by (meth)acryloxy group. For extending the liquid crystal temperature range when the compound is processed into the composition and for improving the contrast, Ak⁵⁰ is further preferably a hydrogen atom or an alkyl group having 5 or less carbons.

In formula (2-9), R³¹ and R³² represent a hydrogen atom, an alkyl group having 3 or less carbons or an aromatic group having 10 or less carbons. From the viewpoint of ease of handling and for improving the contrast, R⁵³¹ and R⁵³² are independently preferably a hydrogen atom, a methyl group, a phenyl group, a pyridyl group or a thiophene group.

In formula (2-10), R⁵⁴ represents an alkyl group having 3 or less carbons, and two of R⁵⁴ may be bonded into a ring structure, and R⁵⁵ represents a hydrogen atom or an alkyl group having 3 or less carbons. From the viewpoint of ease of handling and for improving the contrast, R⁵⁴ is preferably an alkyl group having 3 or less carbons, and two of R⁵⁴ is also preferably crosslinked into a five-membered ring structure or six-membered ring structure, and R⁵⁵ is further preferably a hydrogen atom or a methyl group.

Further, in formula (2-1) to formula (2-10), A¹ is independently 1,4-phenylene, 1,4-cyclohexylene or naphthalene-2,6-diyl, and in the 1,4-phenylene and the naphthalene-2,6-diyl, at least one hydrogen may be replaced by fluorine, chlorine or an organic group having 1 to 5 carbons. For improving the contrast, A¹ is independently further preferably 1,4-phenylene or 1,4-cyclohexylene.

In formula (2-1) to formula (2-10), Z¹ is independently a single bond, —CH₂CH₂—, —COO—, —OCO—, —CH₂O—, —OCH₂—, —OCH₂CH₂O—, —CH═CHCOO—, —OCOCH═CH—, —CH₂CH₂COO—, —OCOCH₂CH₂—, —CH₂CH₂OCO— or —COOCH₂CH₂—. From the viewpoint of ease of handling, at least one of Z¹ is preferably —CH₂CH₂COO— or —OCOCH₂CH₂—.

In formula (2-1) to formula (2-10), m and n are each an integer from 0 to 7, and an expression: 3≤m+n≤8 holds. For improving the contrast, an expression: m+n≥3 preferably holds in formula (2-1) to formula (2-10). From the viewpoint of ease of handling, an expression: m+n≤8 preferably holds in formula (2-1) to formula (2-10).

In formula (2-1) to formula (2-10), Y is independently a single bond, —O—, —COO—, —OCO— or —OCOO—.

In formula (2-1) to formula (2-10), Q¹ is independently a single bond or alkylene having 1 to 20 carbons, and in the alkylene, at least one piece of —CH₂— may be replaced by —O—, —COO— or —OCO—. From the viewpoint of ease of handling, in formula (2-1) to formula (2-10), Q¹ is further preferably alkylene having 1 to 20 carbons.

In formula (2-1) to formula (2-10), PG represents a polymerizable group. Groups represented by formula (PG-1) to formula (PG-3) and so forth show specific examples of the polymerizable group. From viewpoints of improving a rate of reaction in the polymerization reaction of the compound having the polymerizable group and improving solubility in the solvent, formula (PG-1) and a derivative thereof are preferred.

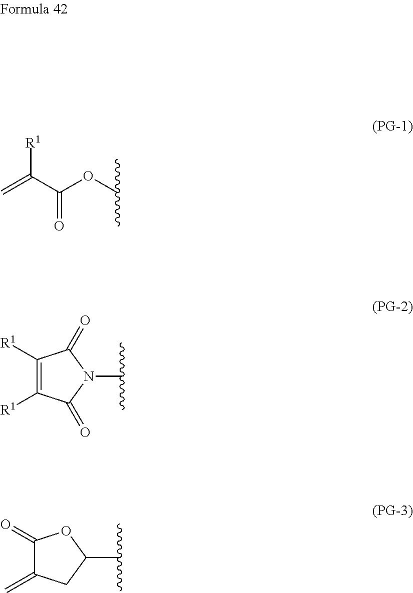

In formula (PG-1) and formula (PG-2), R¹ is independently hydrogen, fluorine, methyl, ethyl or trifluoromethyl.

From viewpoints of inducing the composition to the liquid crystal phase, compatibility with other liquid crystal compounds and solubility in the solvent, among compounds represented by formula (2-1) to formula (2-10) described above, a compound represented by formula (2-1-1) to formula (2-10-6) each is particularly preferred.

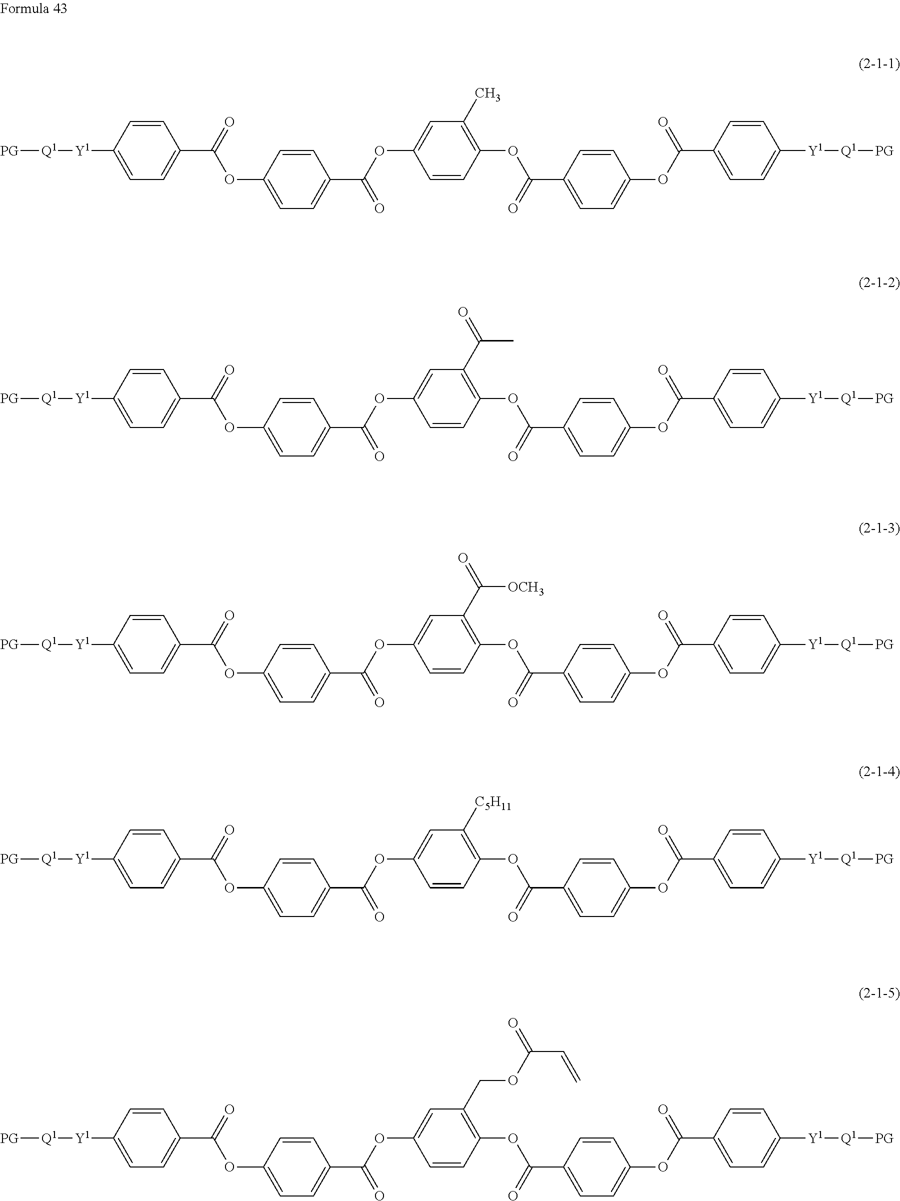

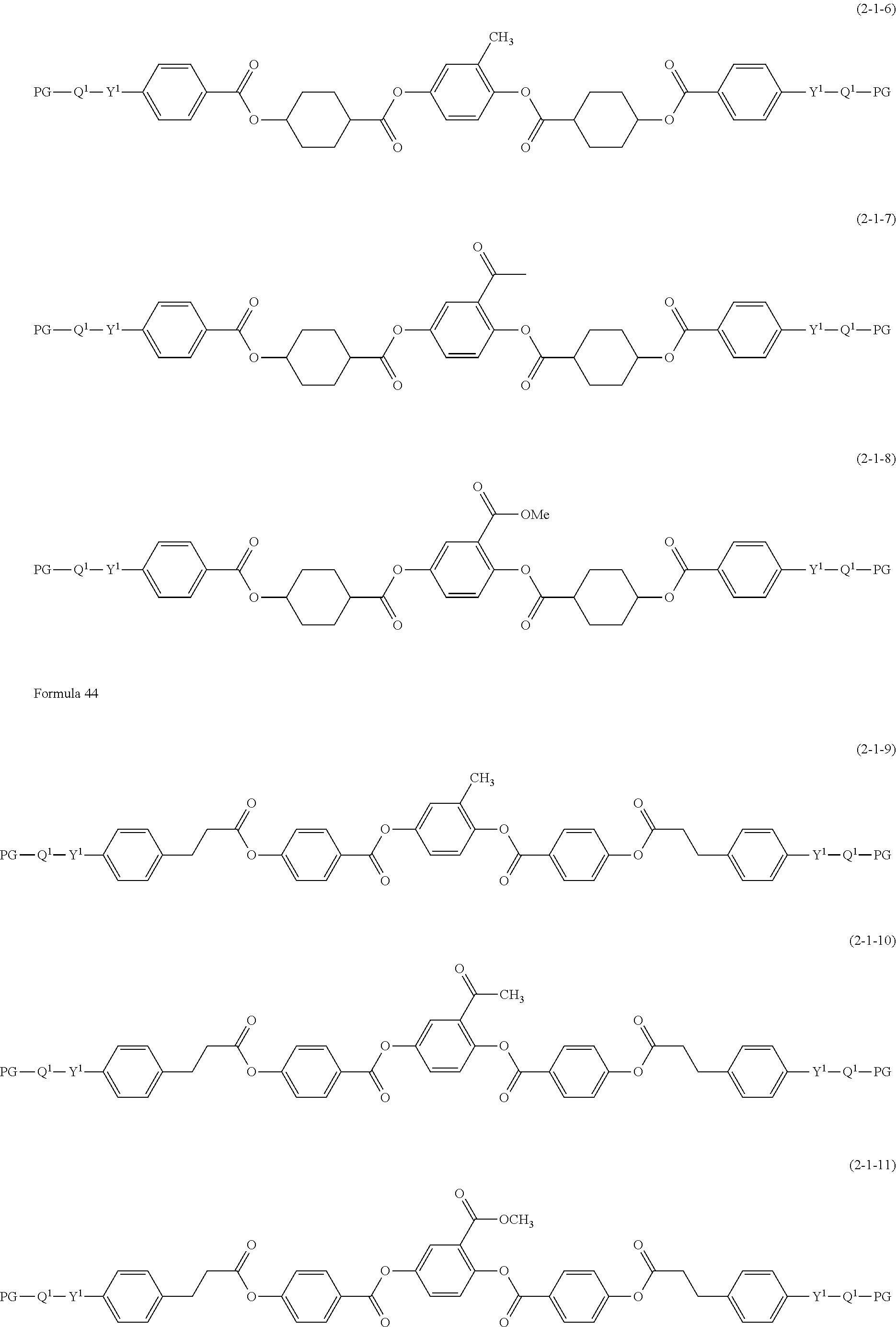

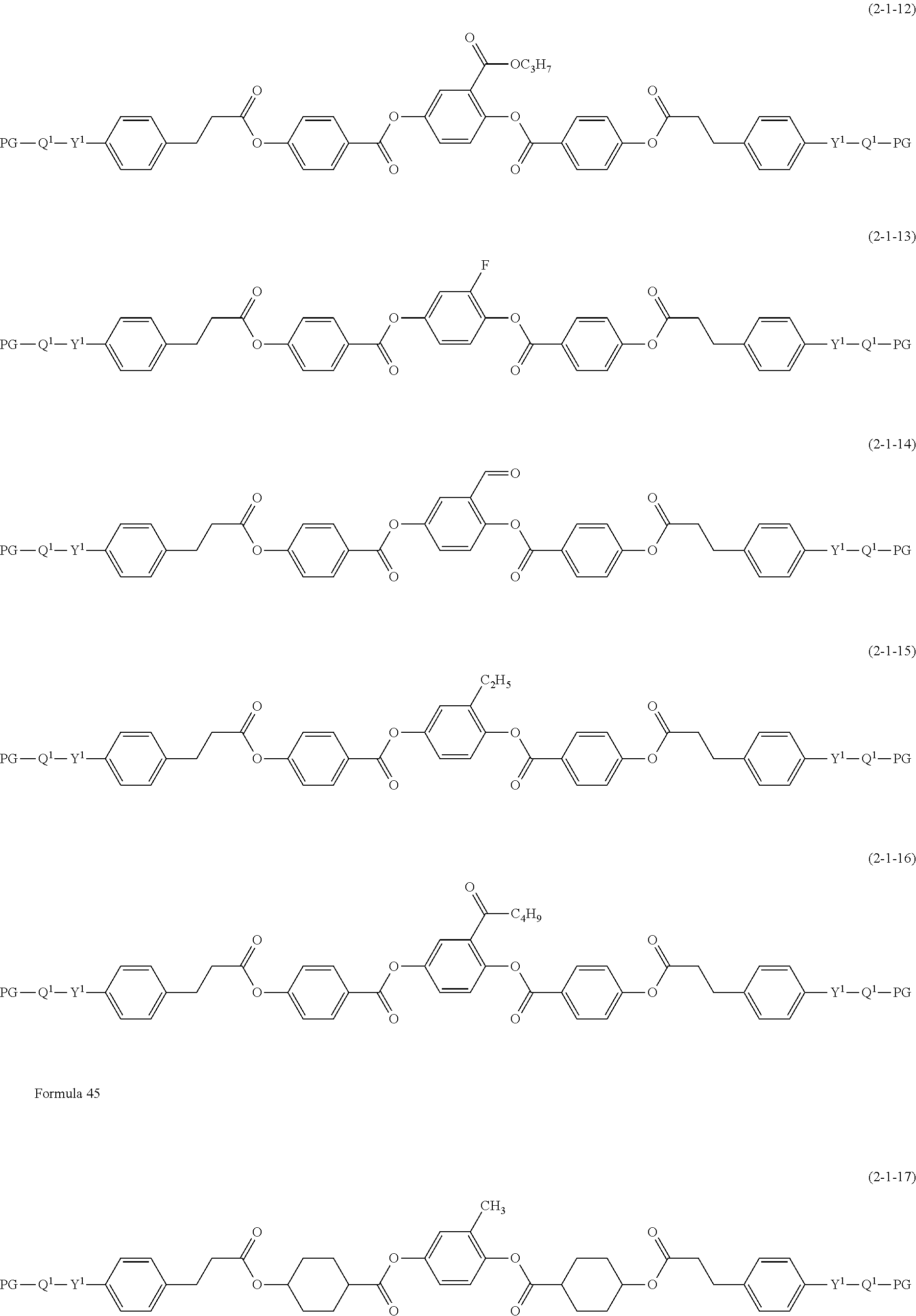

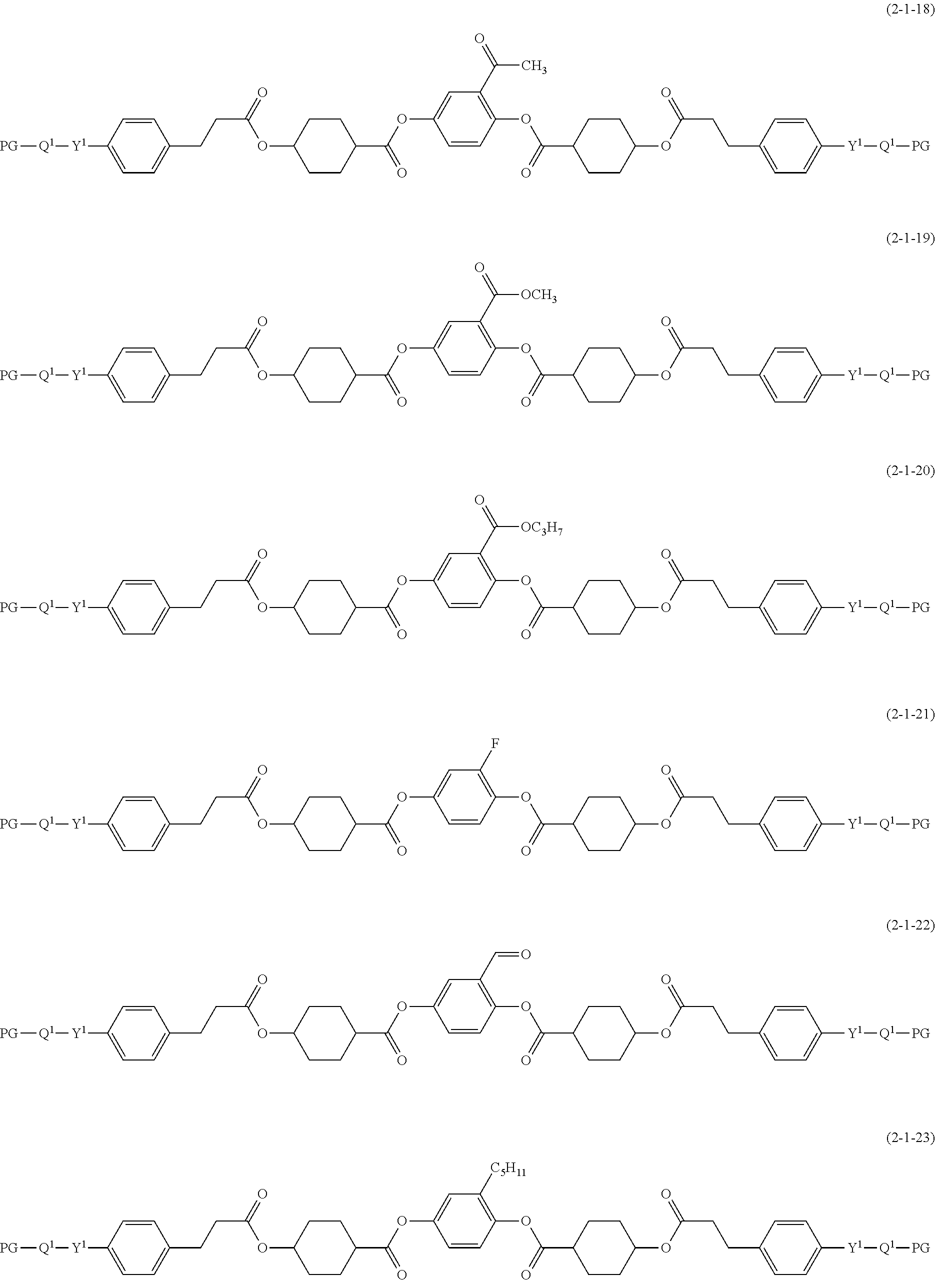

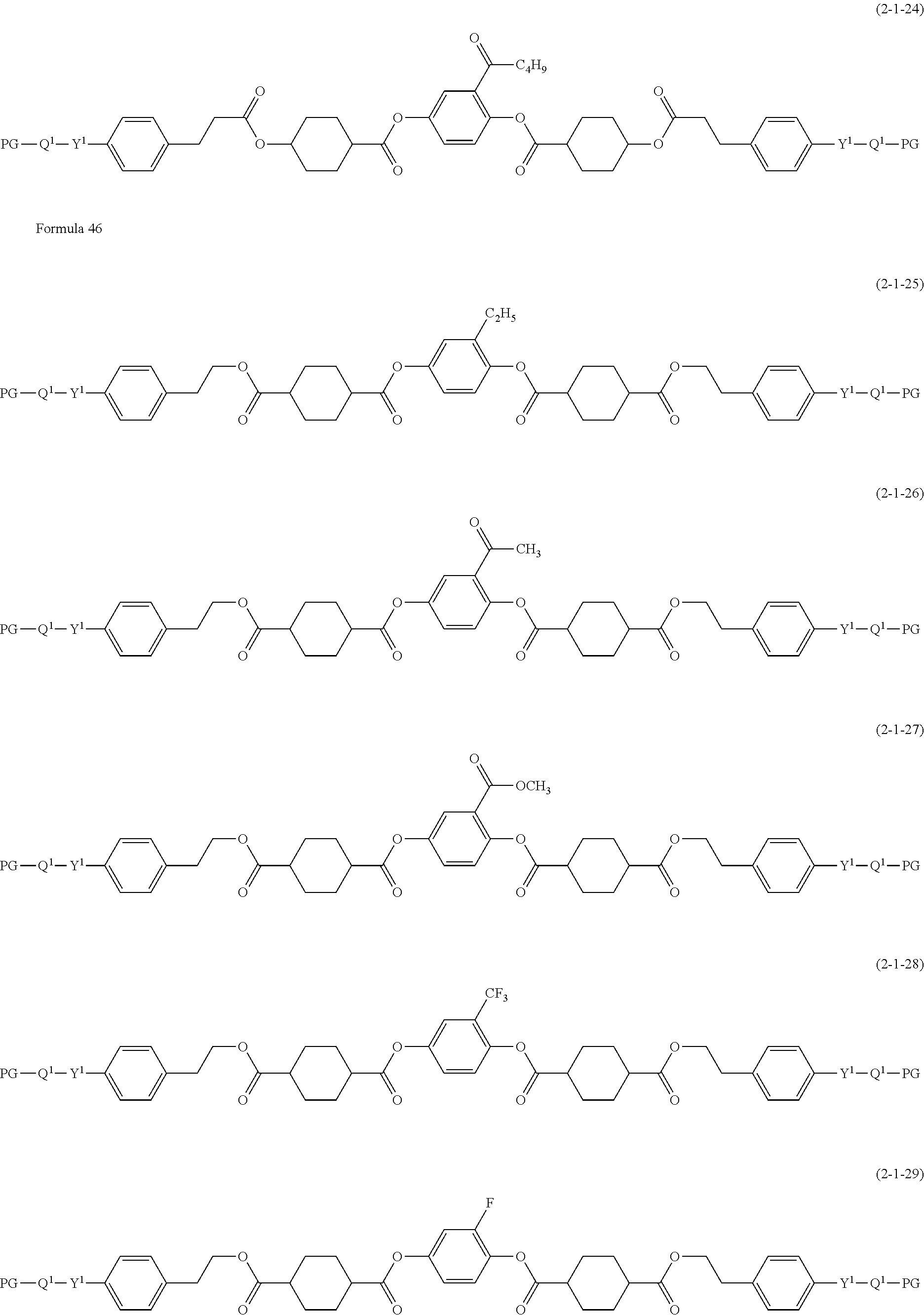

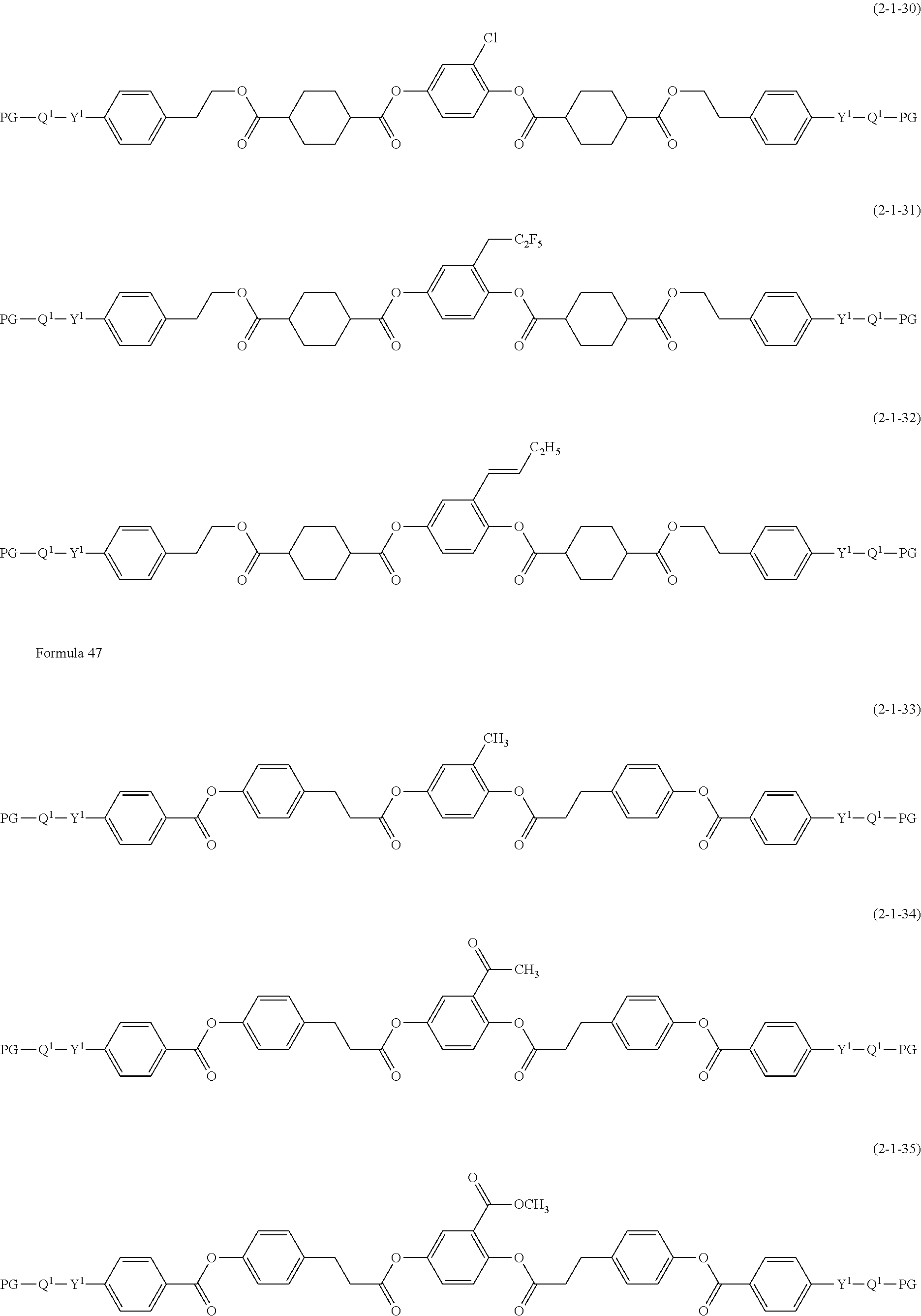

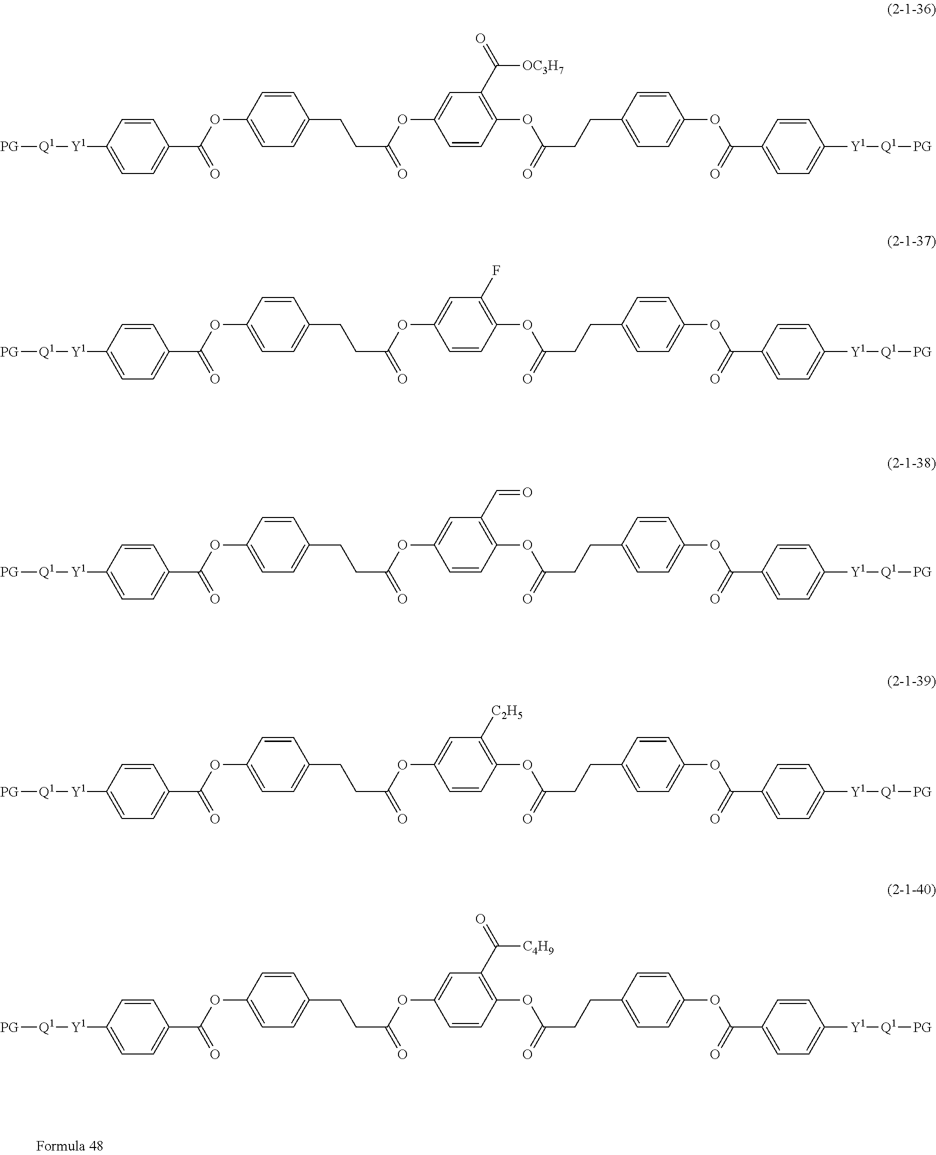

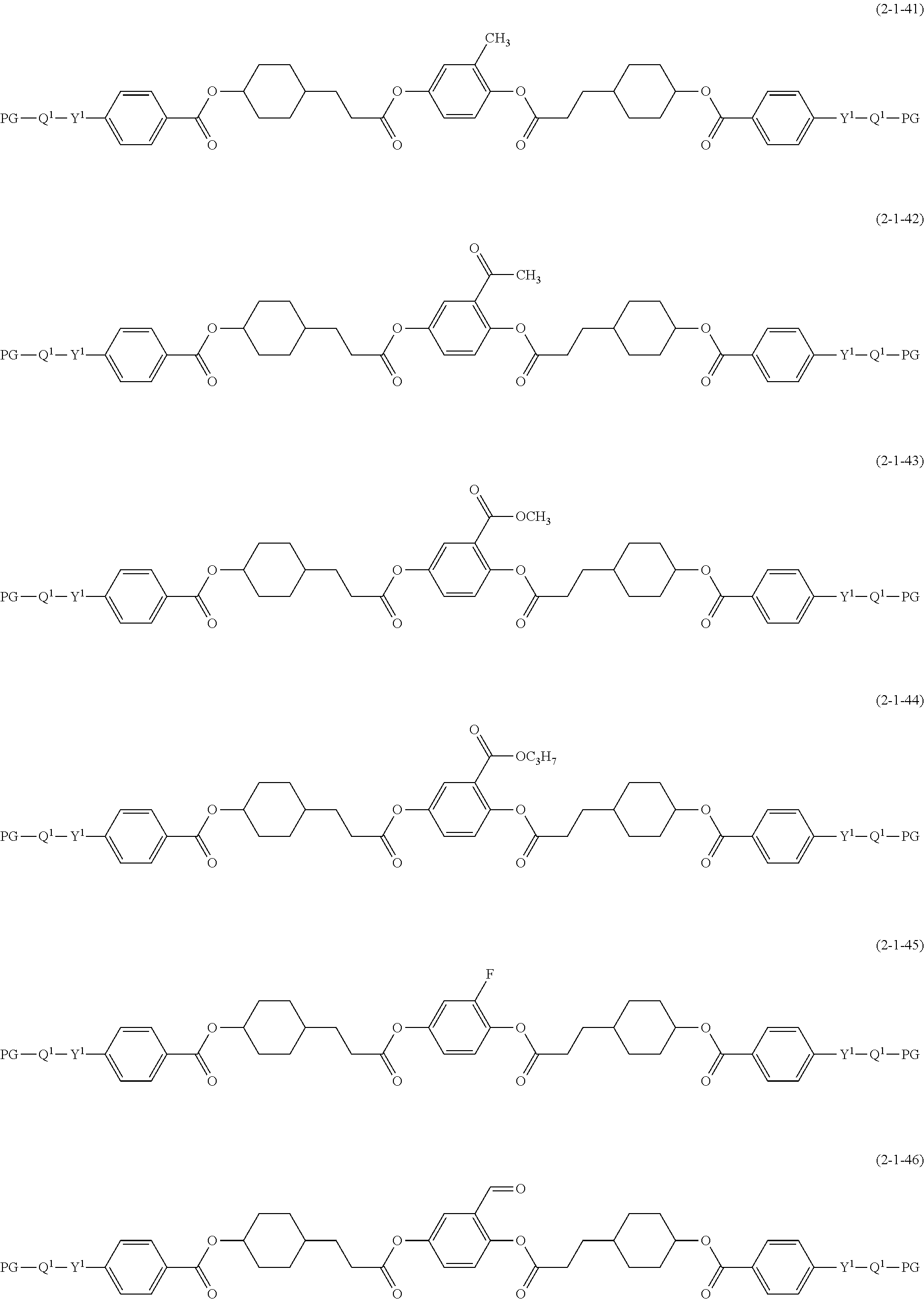

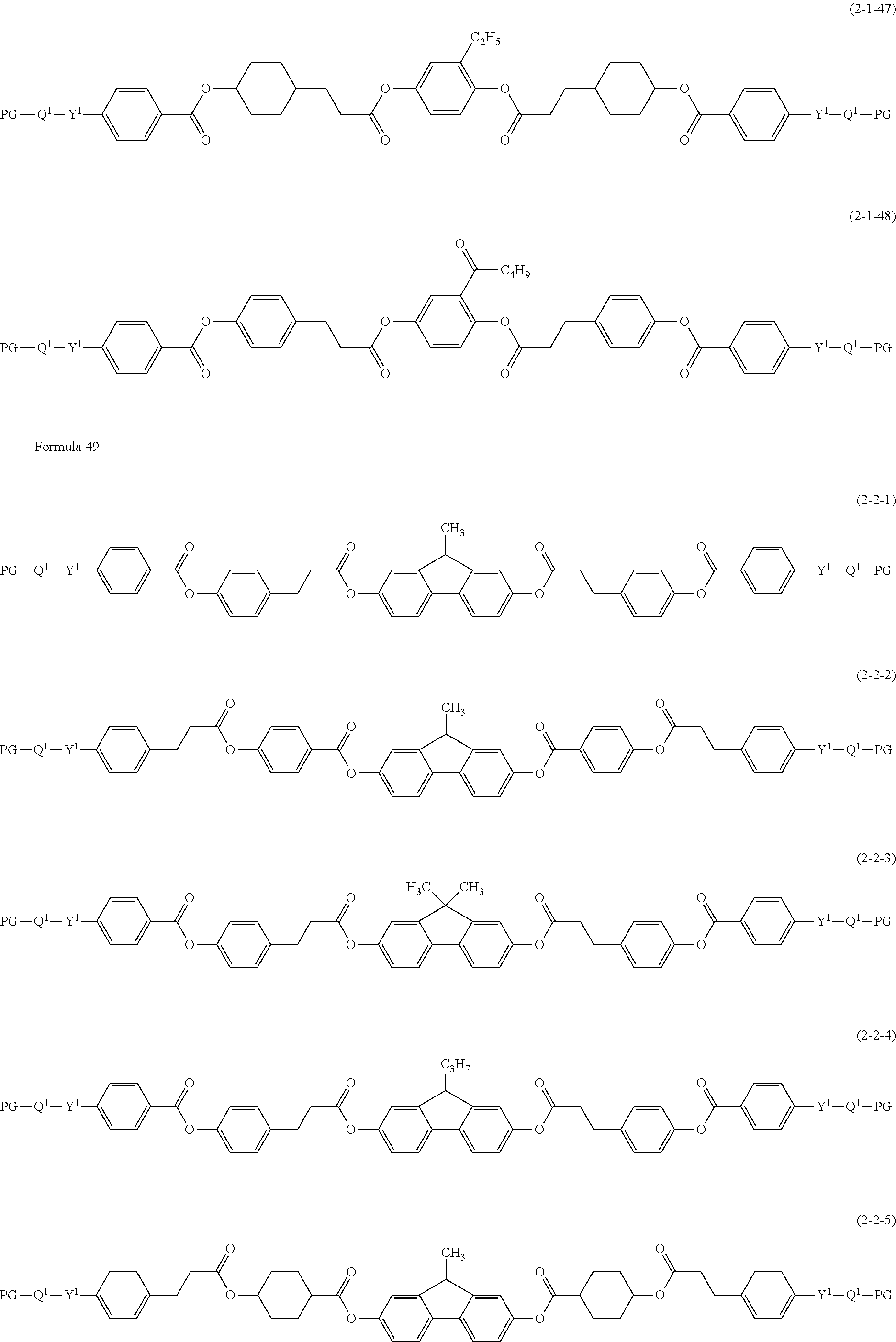

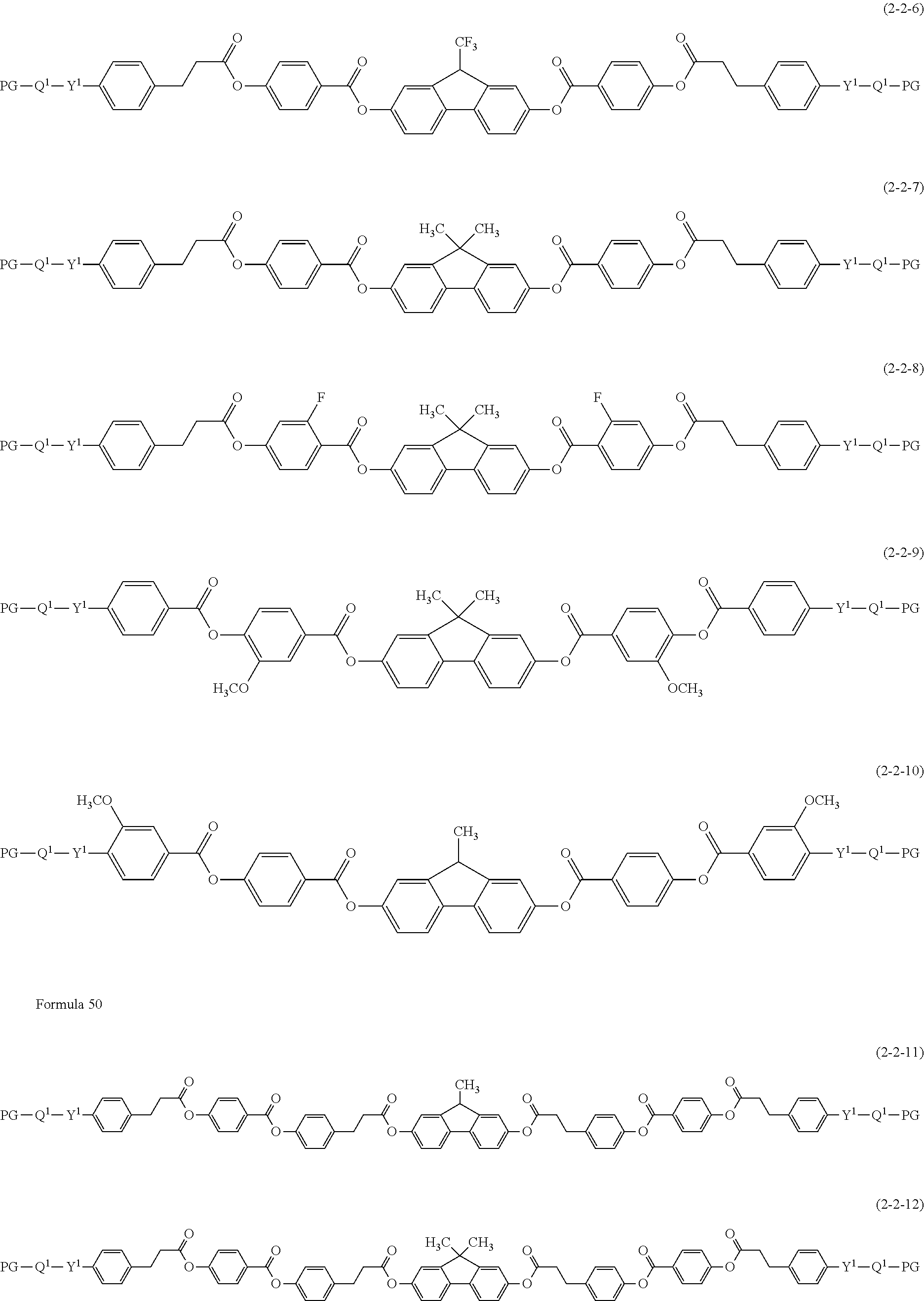

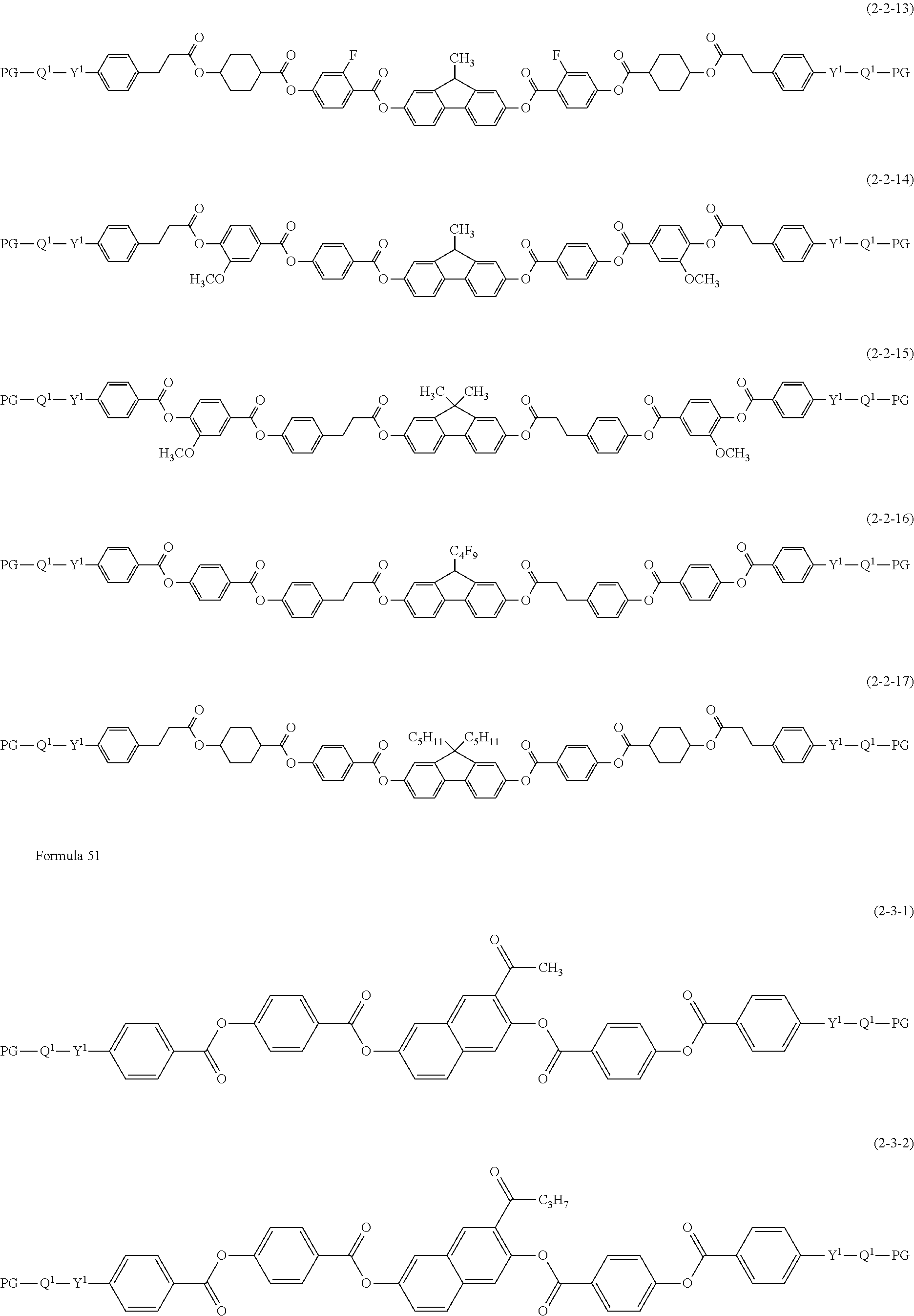

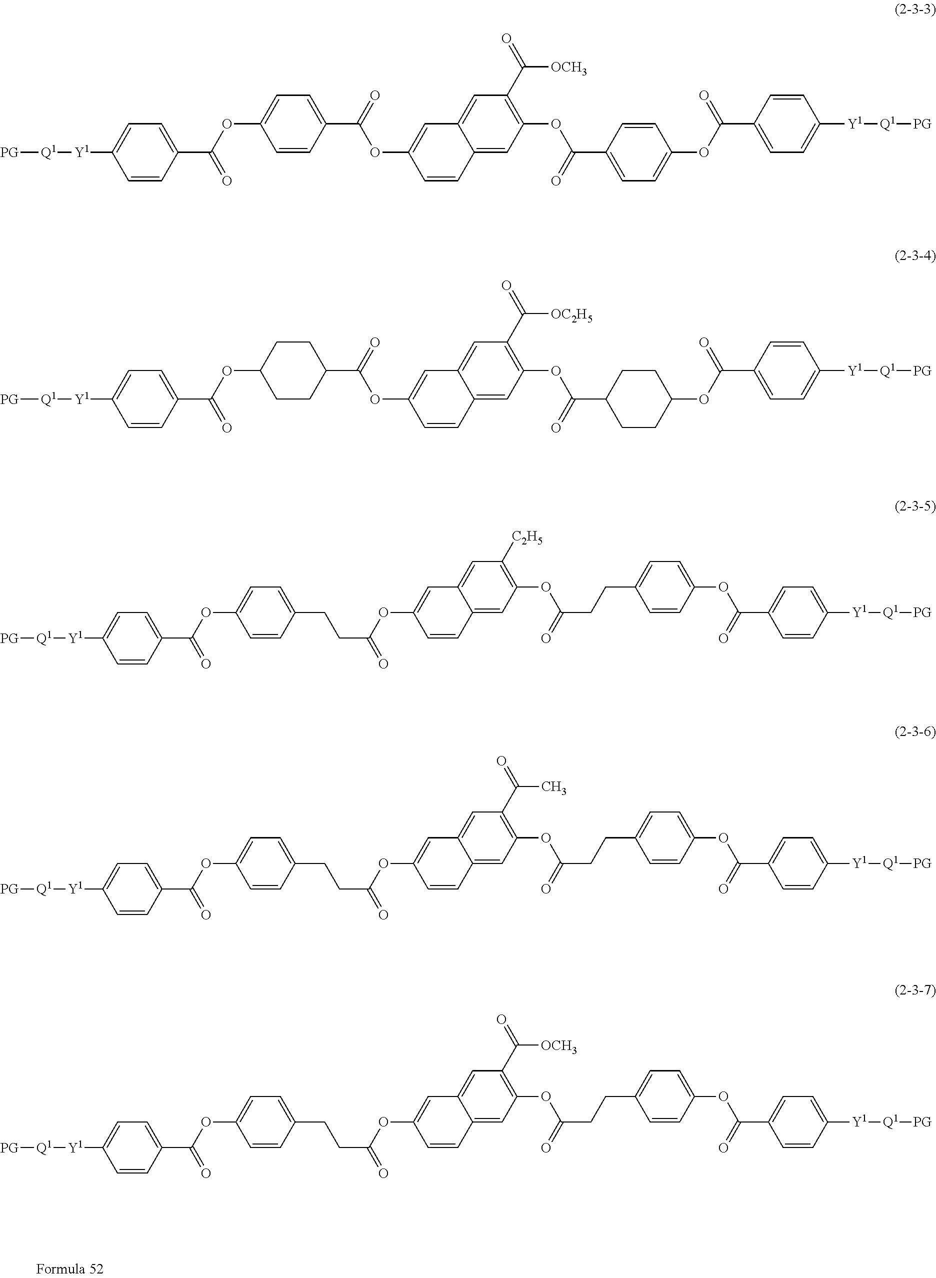

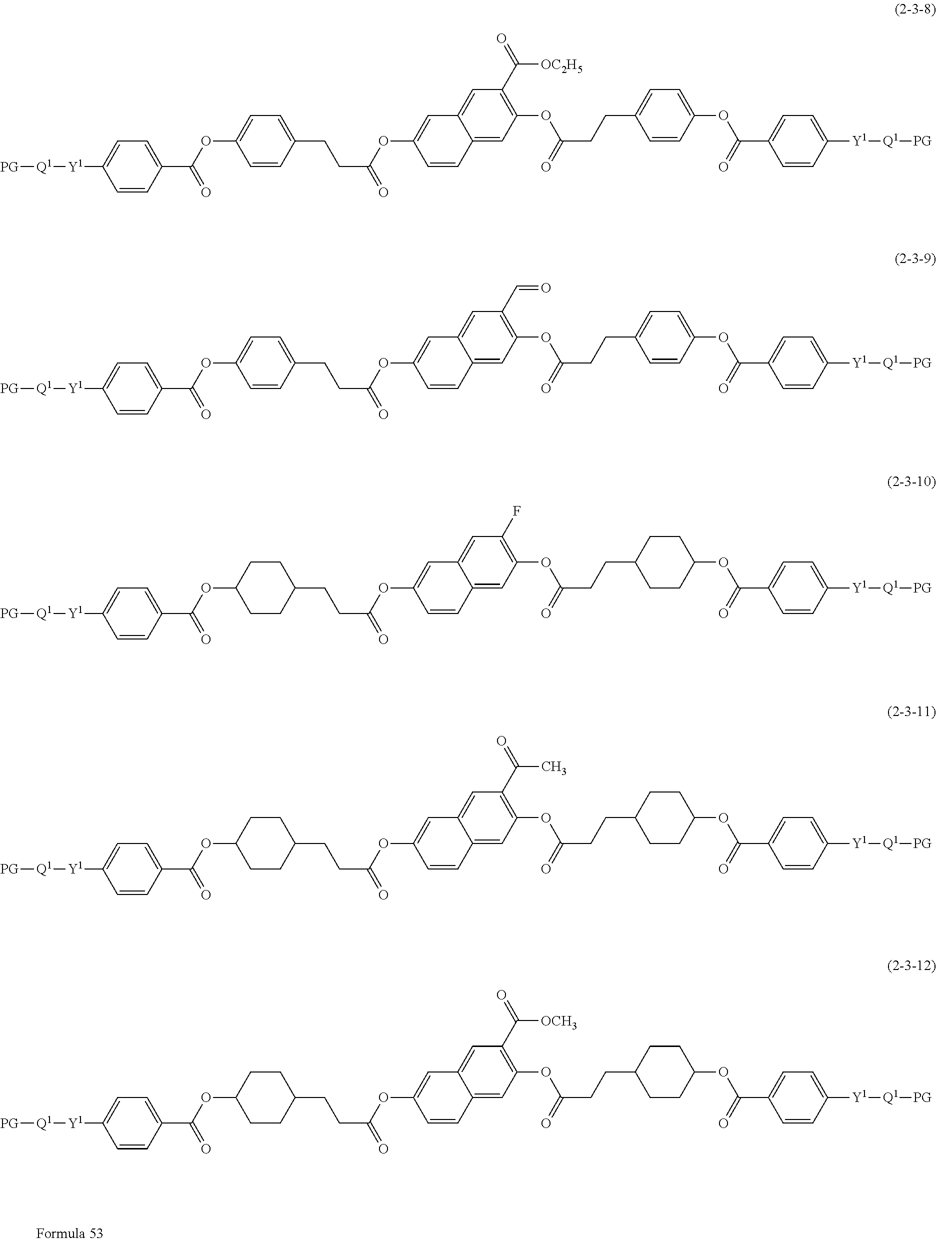

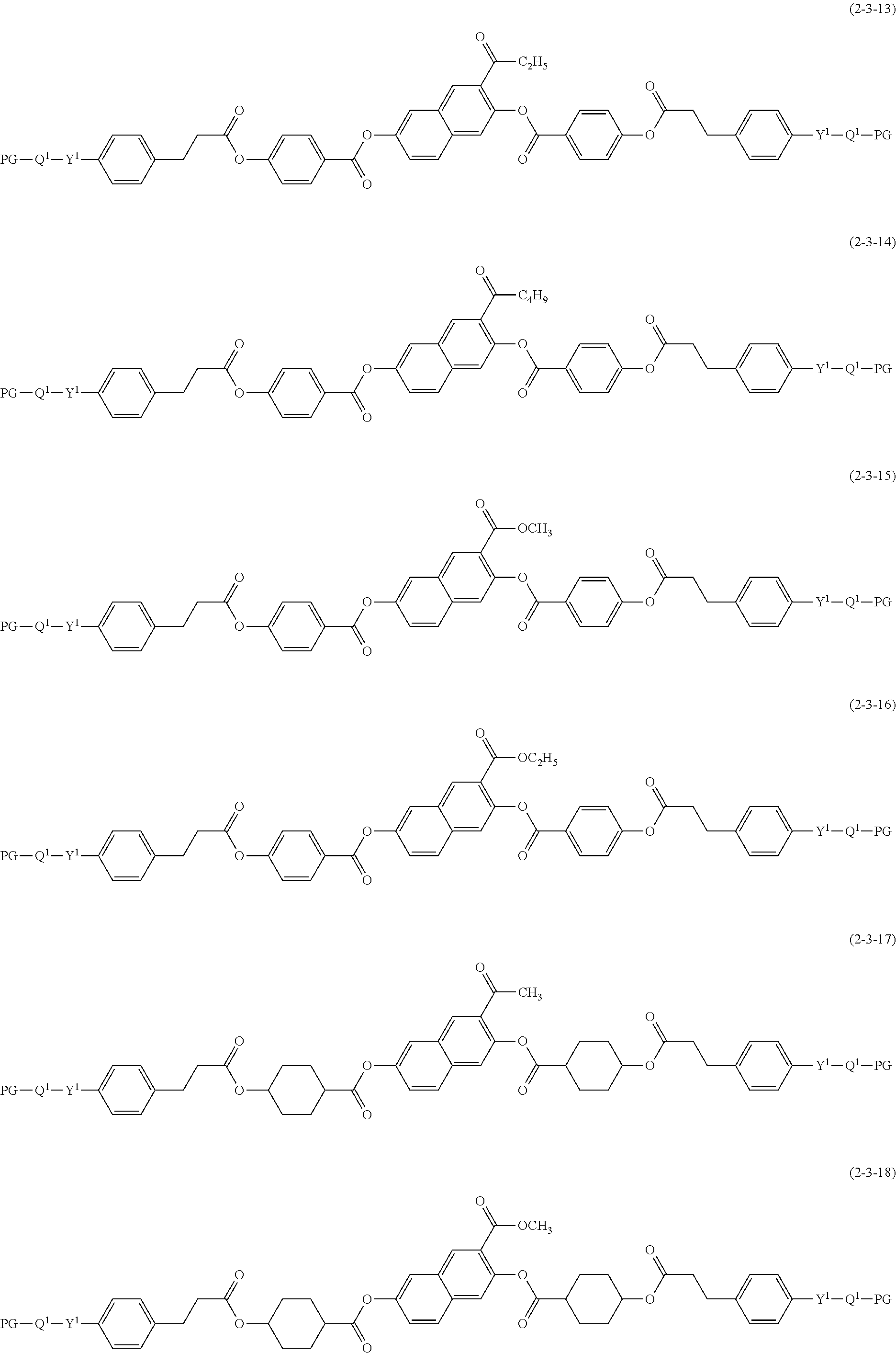

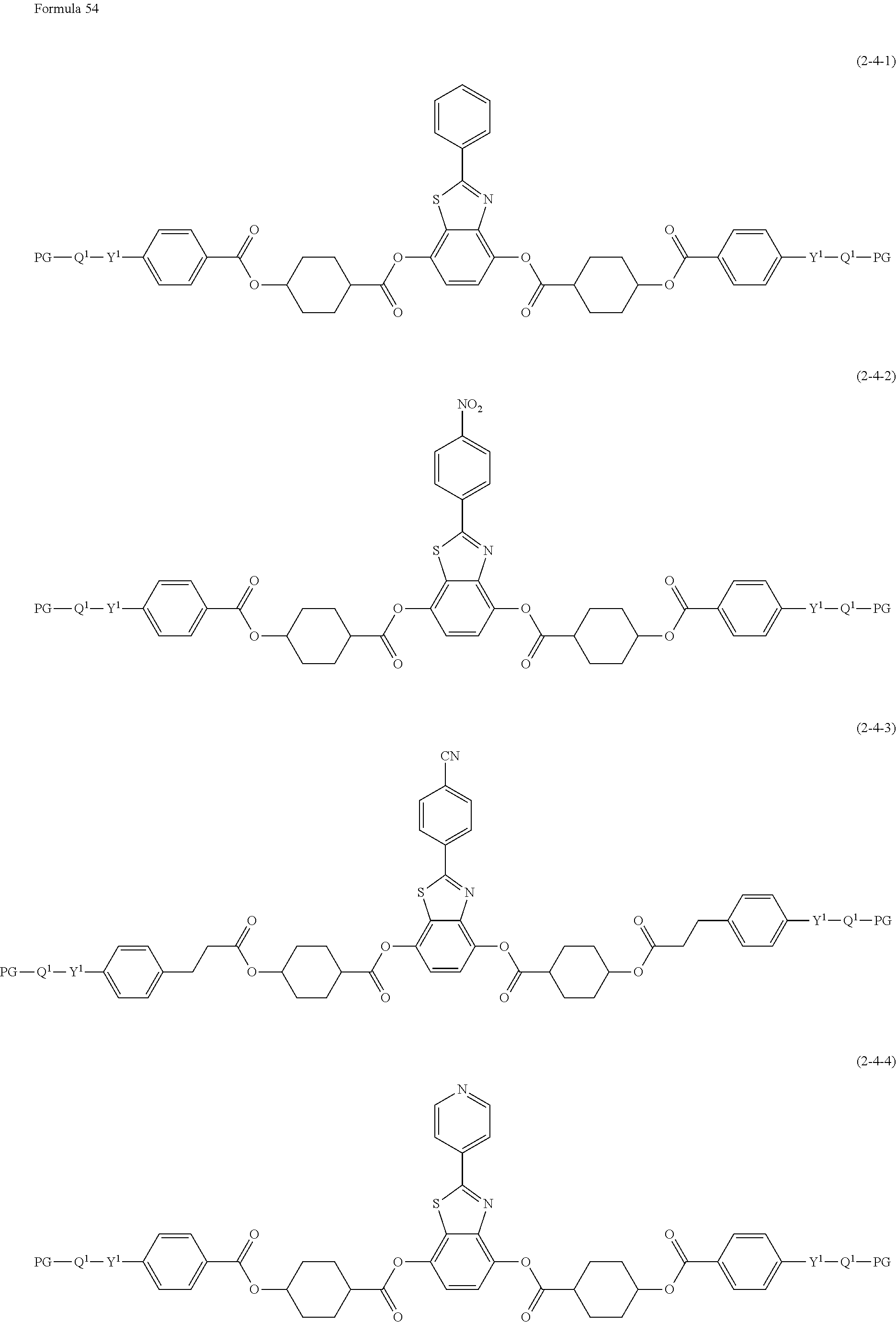

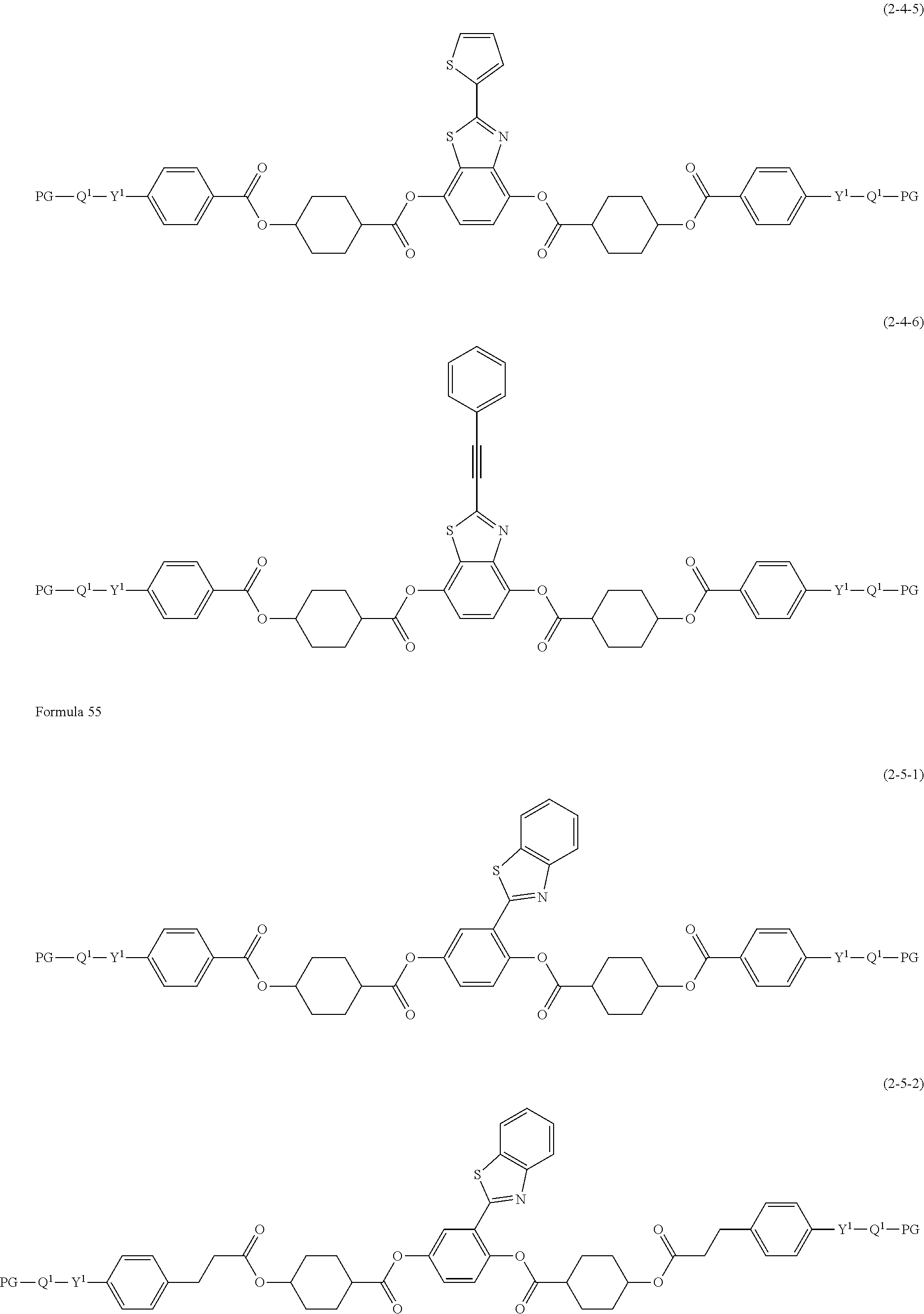

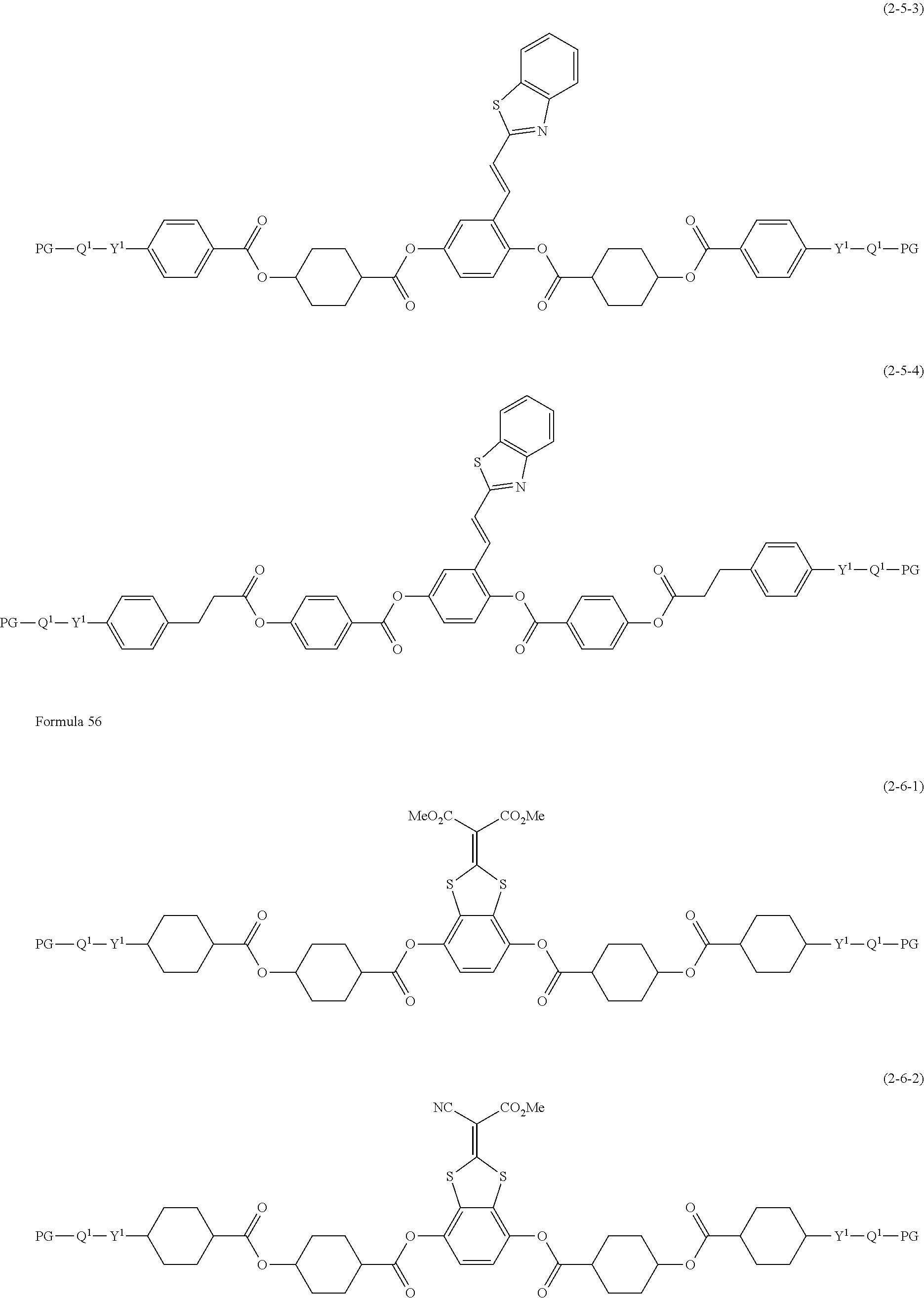

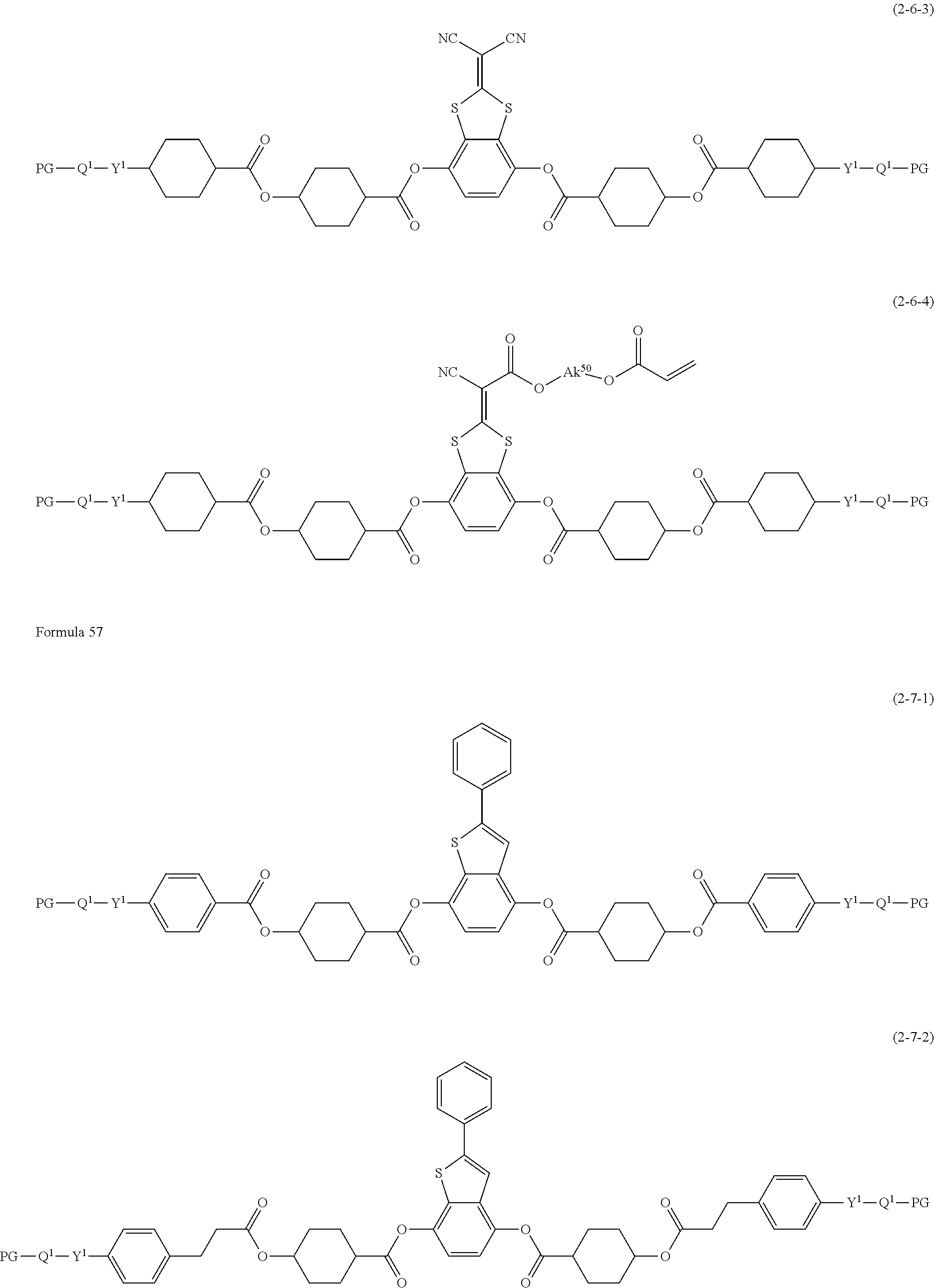

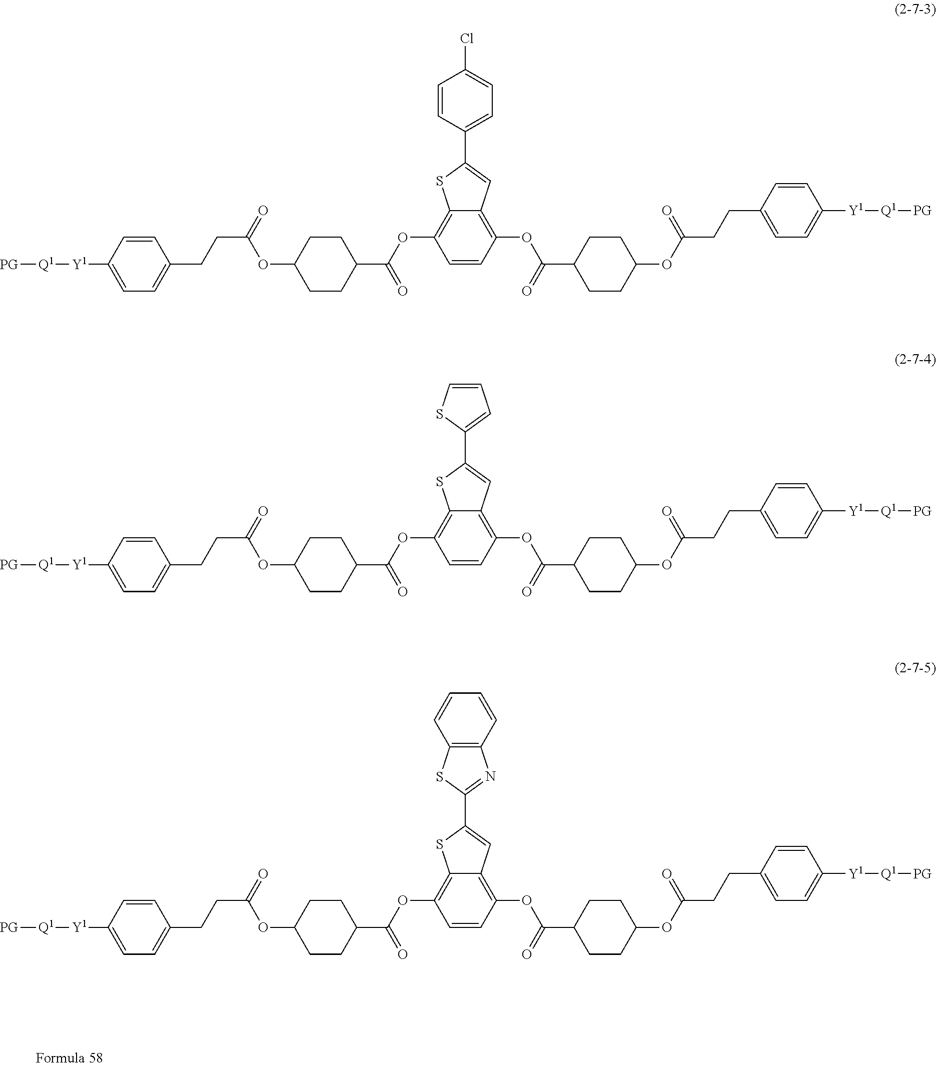

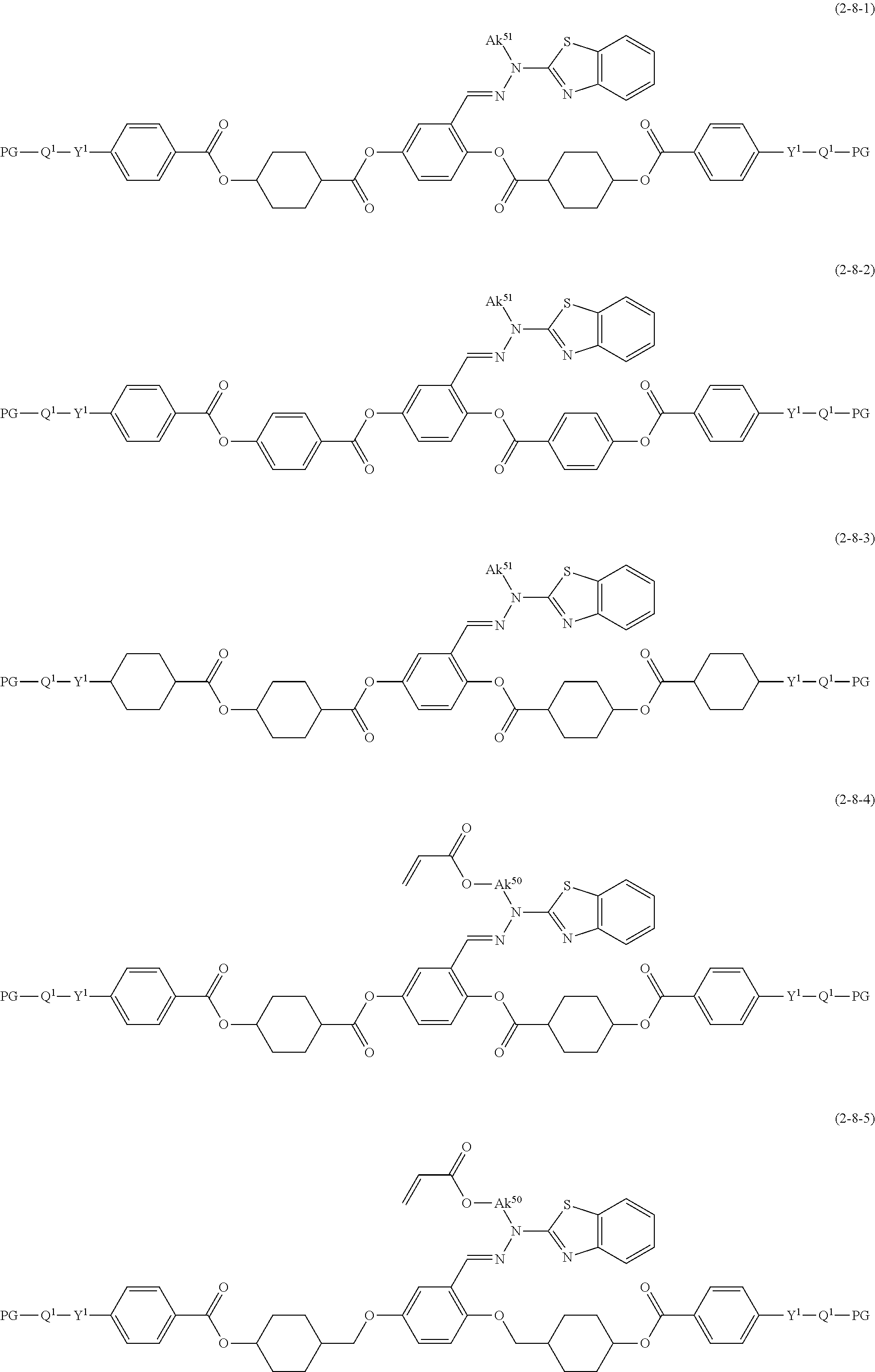

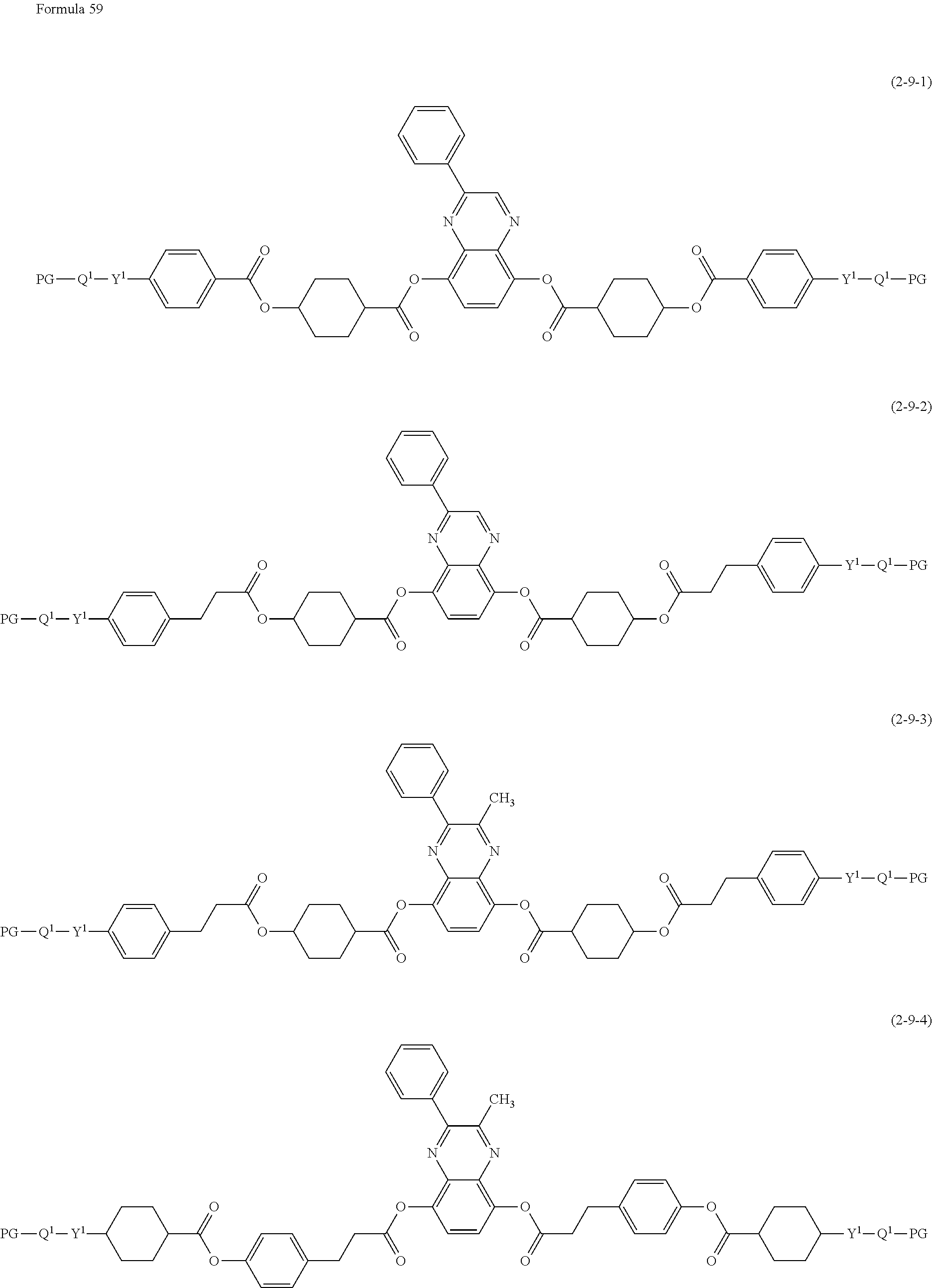

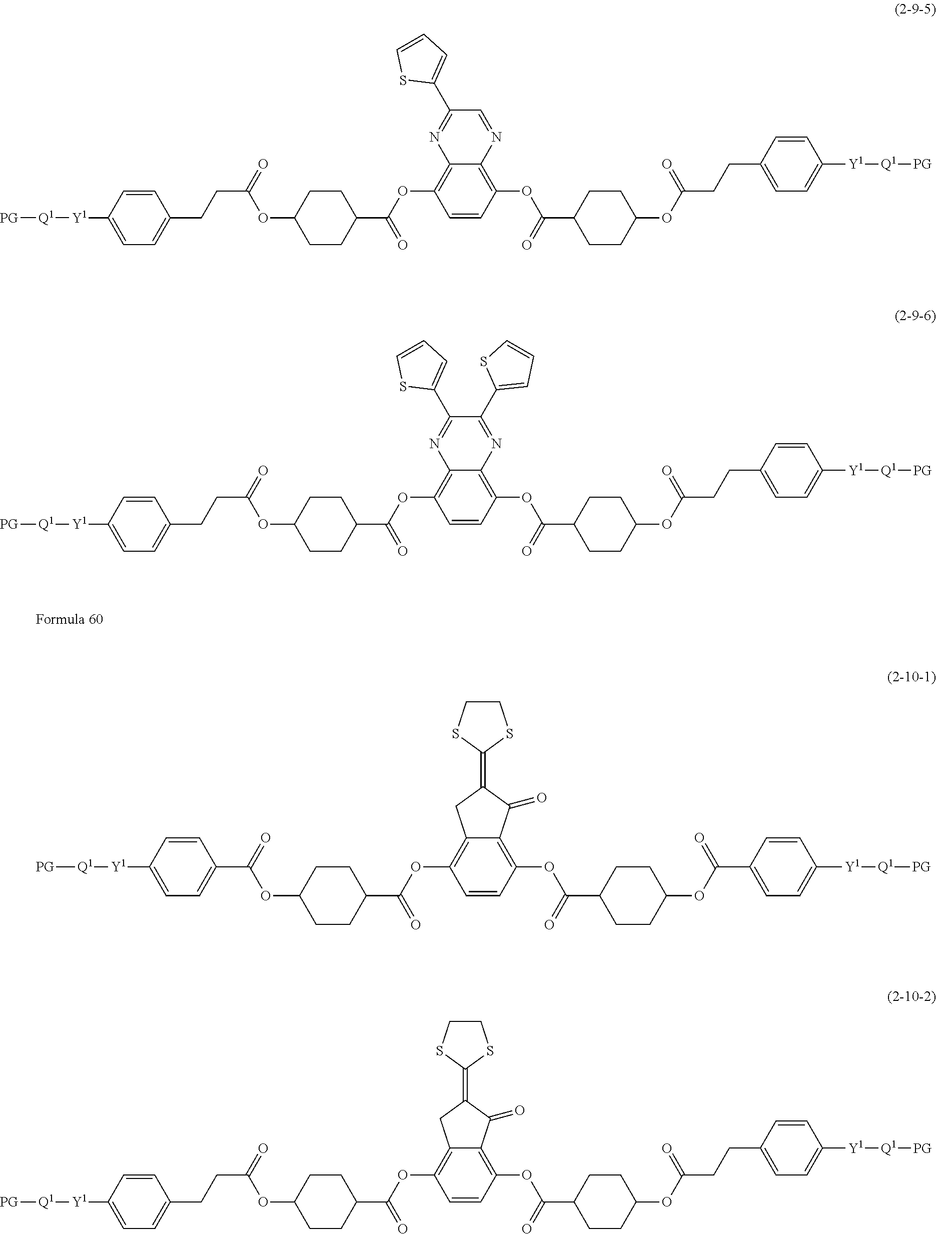

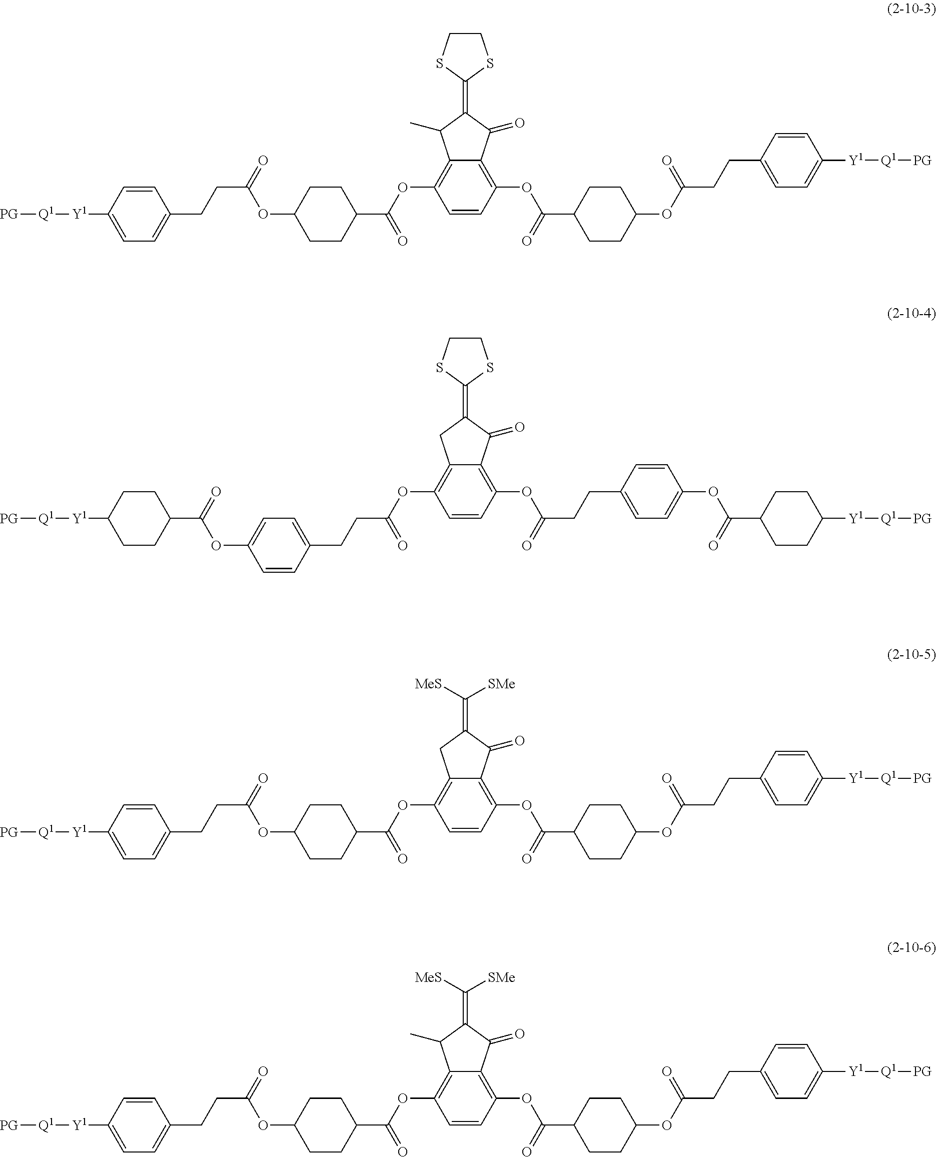

In formula (2-1-1) to formula (2-9-6) described above,

Y¹ is independently a single bond, —O—, —COO—, —OCO— or —OCOO—,

Q¹ is independently a single bond or alkylene having 1 to 20 carbons, and in the alkylene, at least one piece of —CH₂— may be by formula (PG-1) to formula (PG-3) described above,

Ak⁵⁰ represents an alkylene group having 2 to 10 carbons, and

Ak⁵¹ represents a hydrogen atom or an alkyl group having 10 or less carbons.

The polymerizable liquid crystal compound represented by formula (2) can be prepared by combining techniques described in books such as “Organic Syntheses” (John Wiley & Sons, Inc.), “Organic Reactions” (John Wiley & Sons, Inc.), “Comprehensive Organic Synthesis” (Pergamon Press) and “New Experimental Chemistry Course (Shin Jikken Kagaku Koza in Japanese)” (Maruzen Co., Ltd.) and techniques known in the persons skilled in the art.

### Polymerizable Liquid Crystal Composition

From viewpoints of preventing precipitation of a crystal during film formation, inducing the liquid crystal phase and improving solubility in the solvent, the raw material of the liquid crystal polymer is preferably processed into the composition.

In the liquid crystal polymer, the contrast is improved by applying a polymerizable liquid crystal composition containing a compound represented by formula (2) on the alignment film prepared by calcinating a composition containing a polymer represented by a repeating unit of formula (1), and then polymerizing the resulting material. From a viewpoint of the contrast, a content of the compound represented by formula (2) in the polymerizable liquid crystal composition is preferably 50% by weight or more, and further preferably 70% by weight or more.

From viewpoints of preventing precipitation of the crystal during film formation, inducing the liquid crystal phase and improving the solubility in the solvent, other polymerizable compounds may be added in the polymerizable liquid crystal composition. From viewpoints of high liquid crystallinity, heat resistance and ease of manufacturing, such a polymerizable compound is preferably compounds (2M-1-1) to (2M-1-18), compounds (2M-2-1) to (2M-2-30) and compounds (2M-3-1) to (2M-3-8).

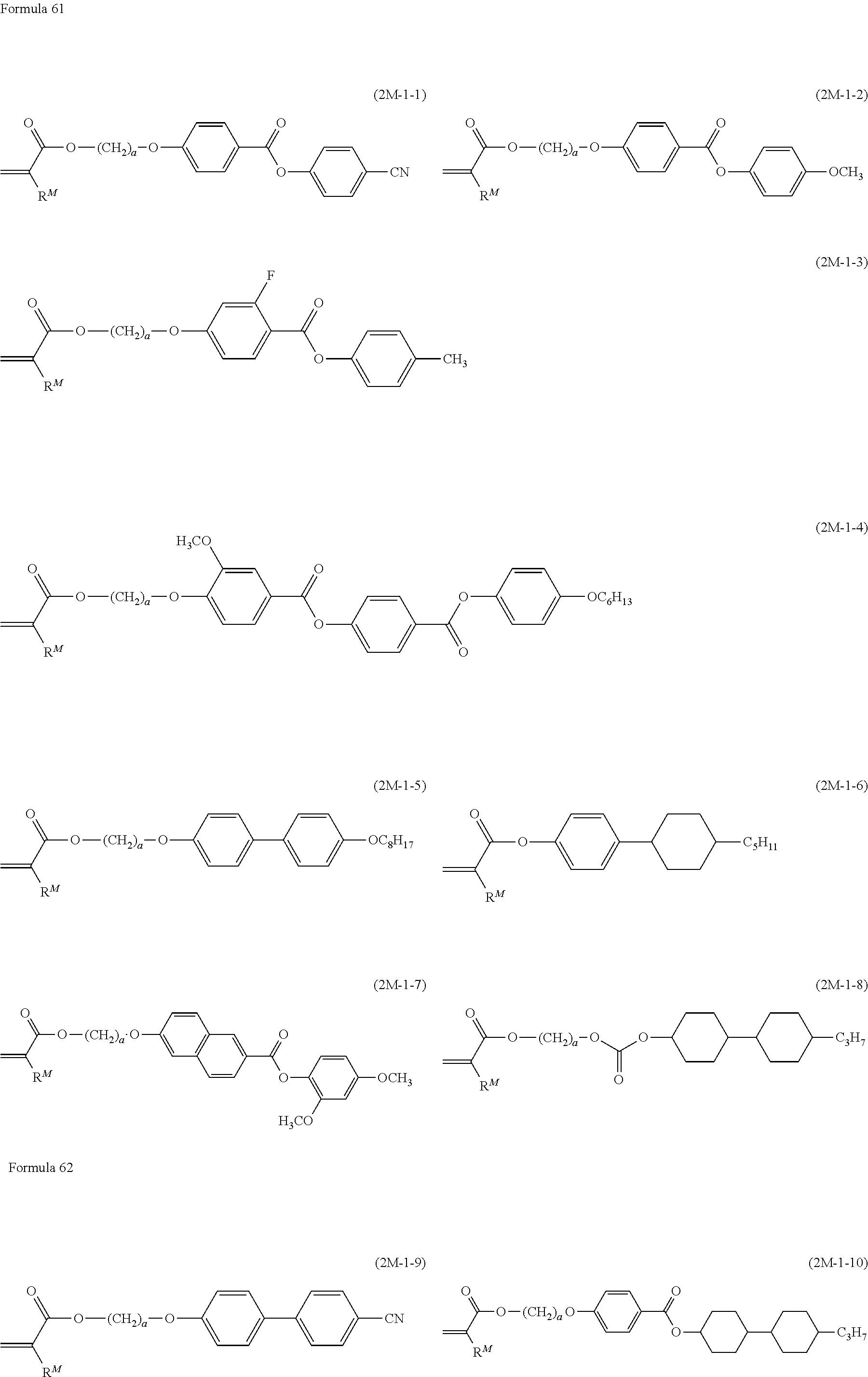

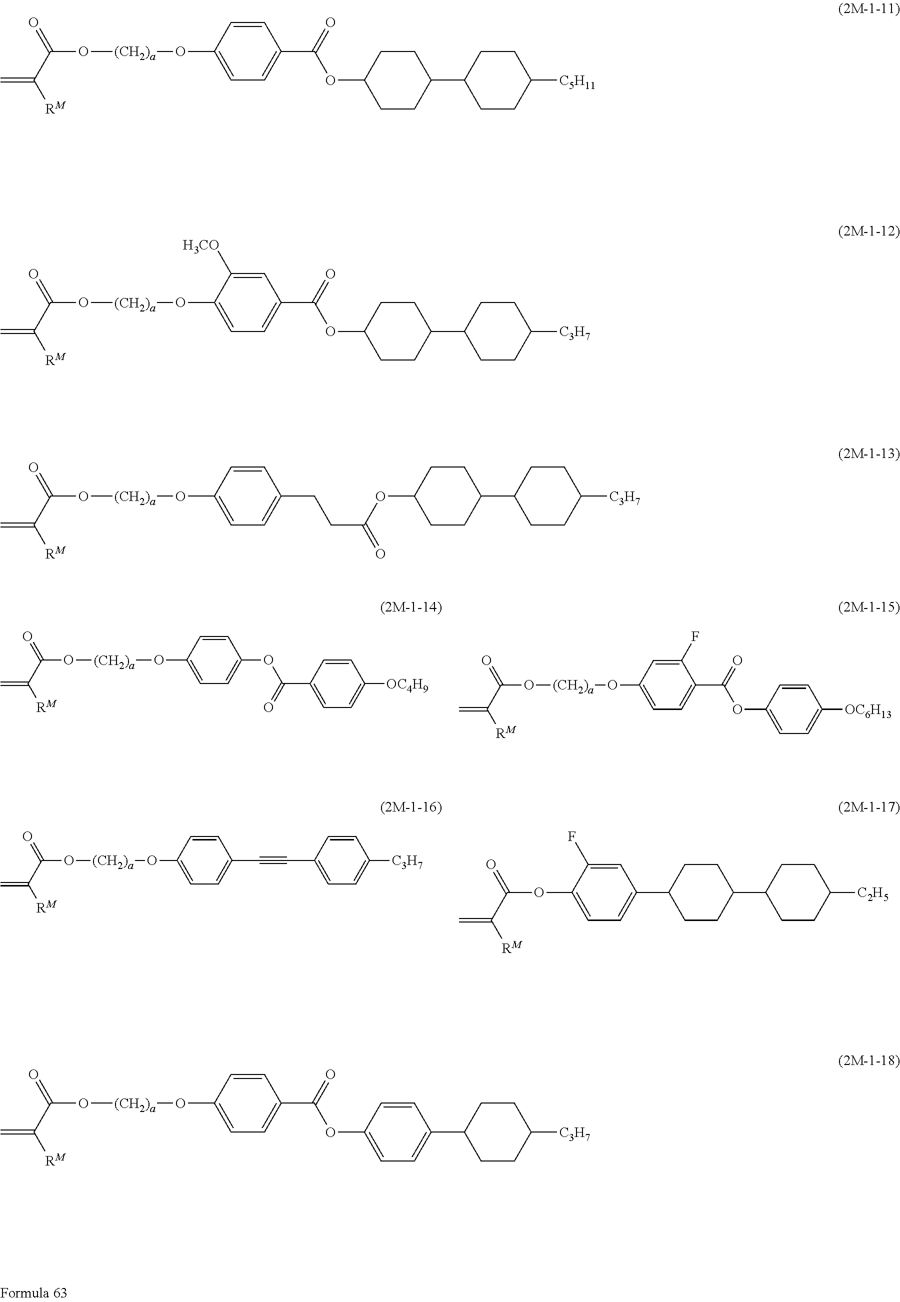

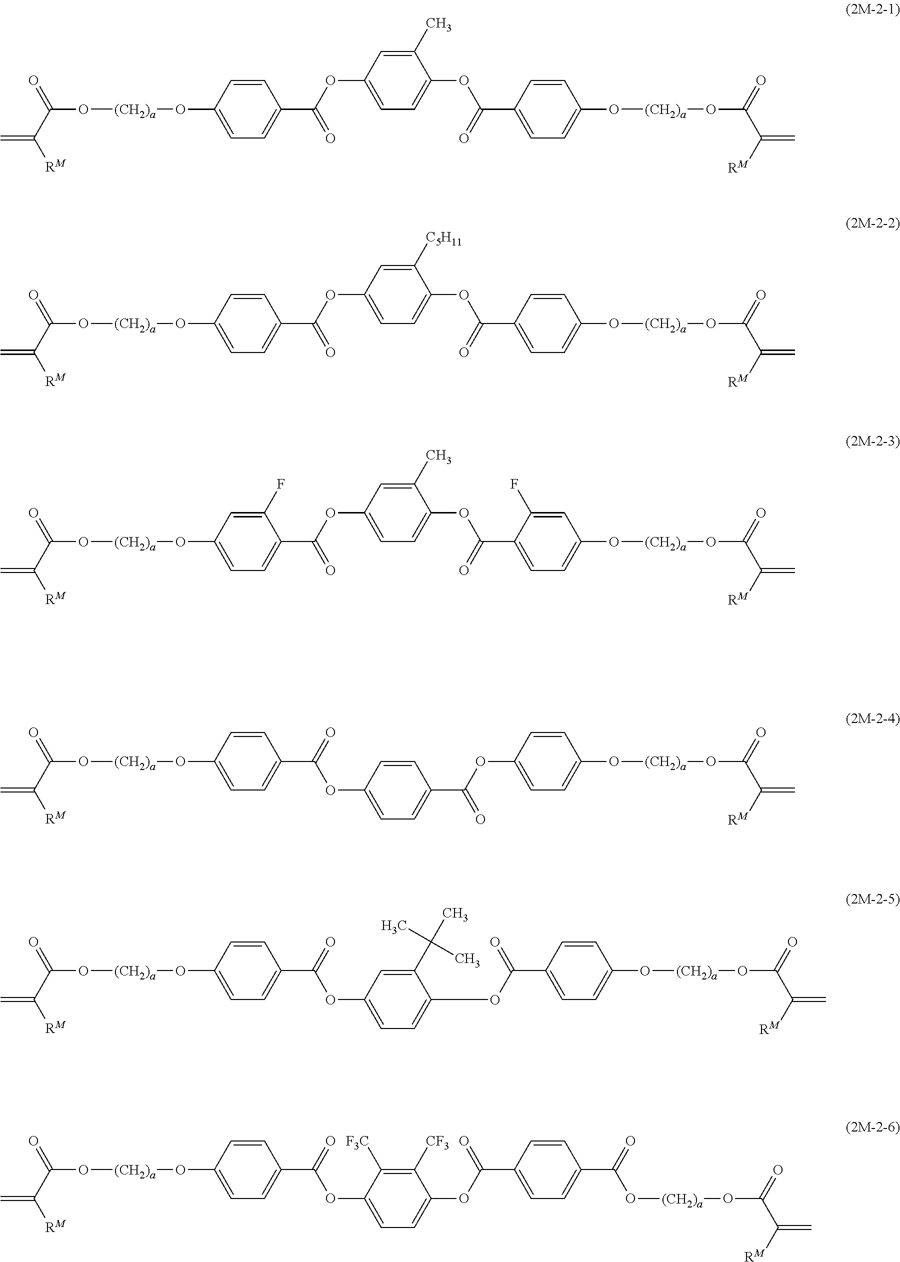

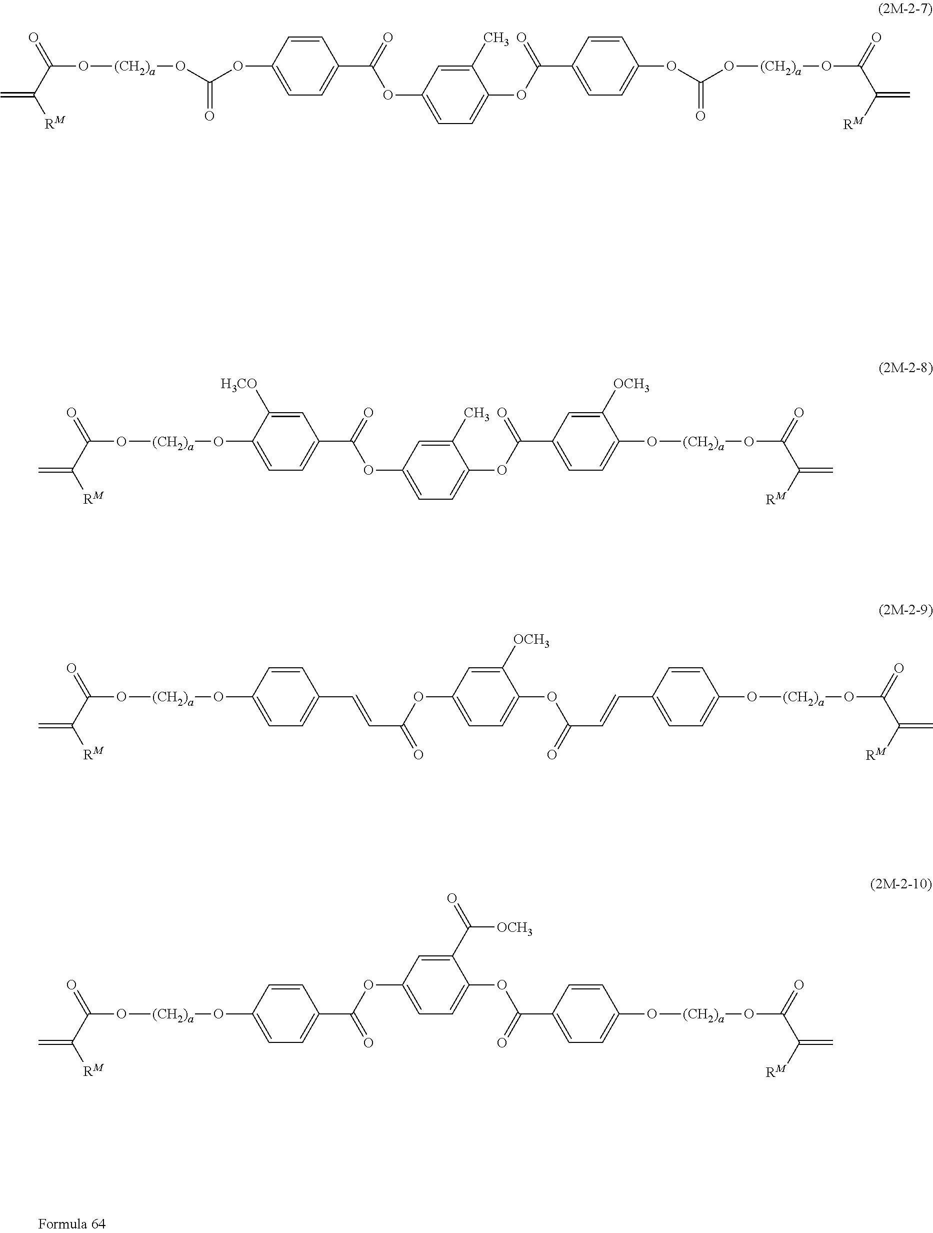

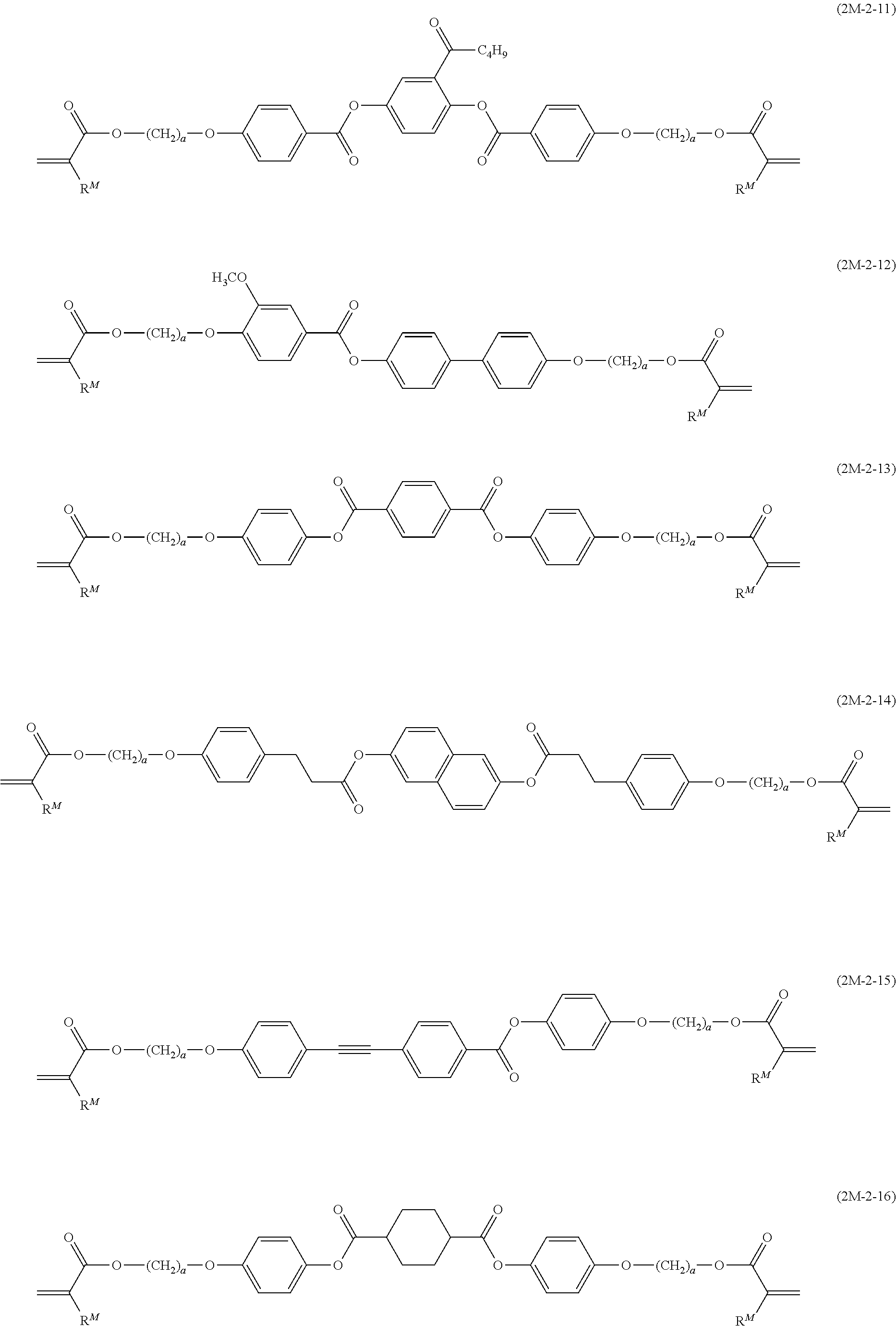

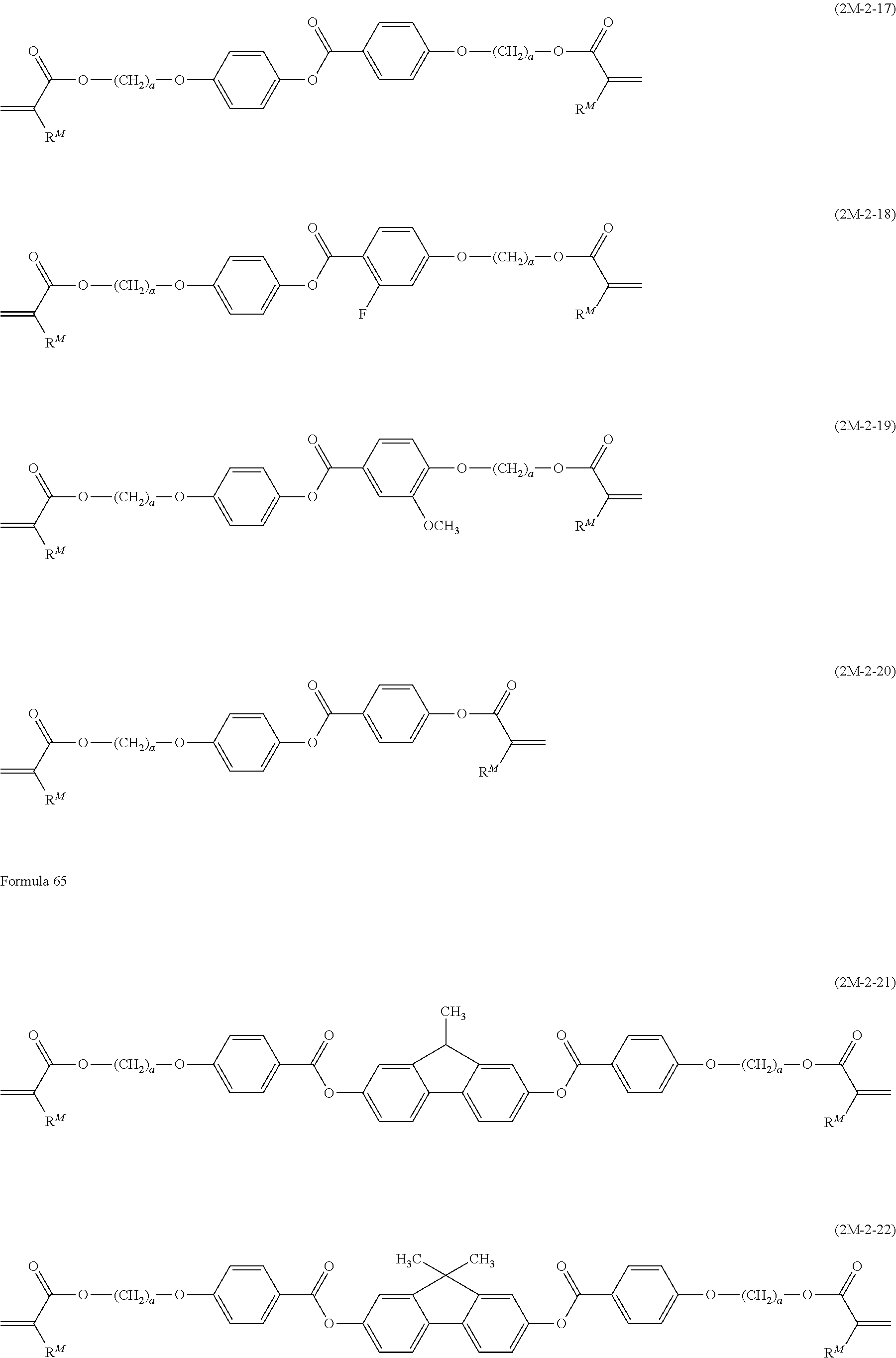

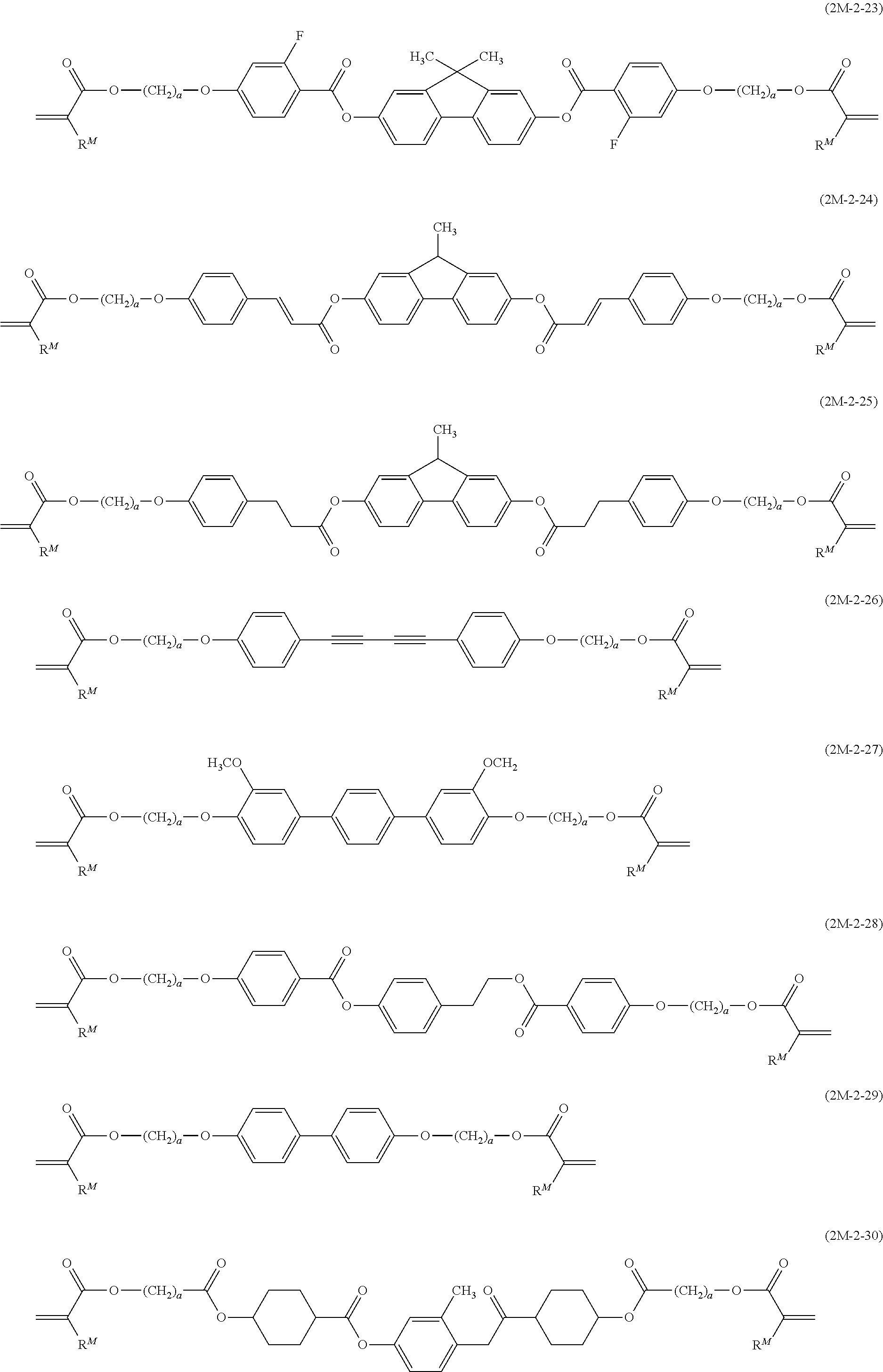

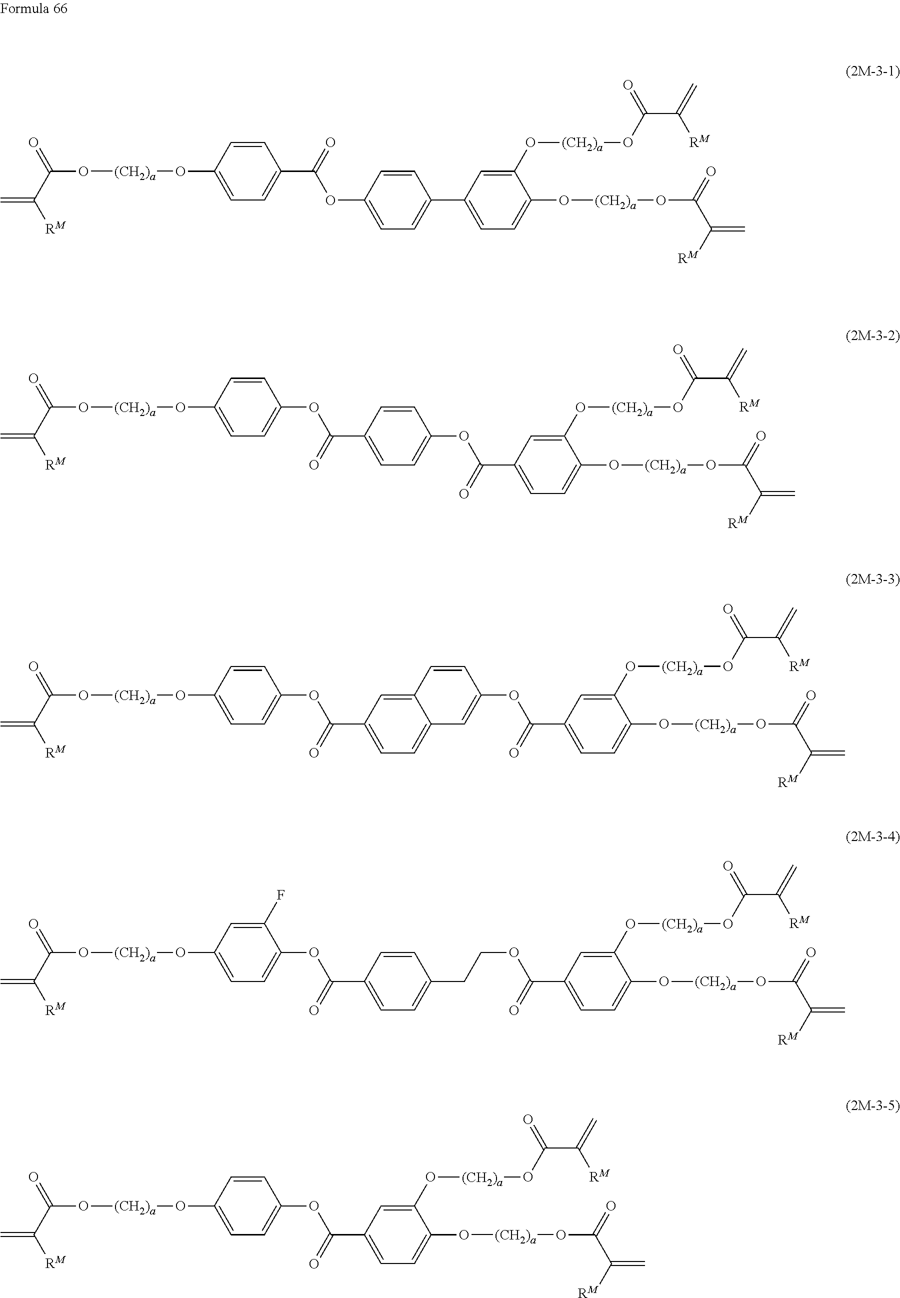

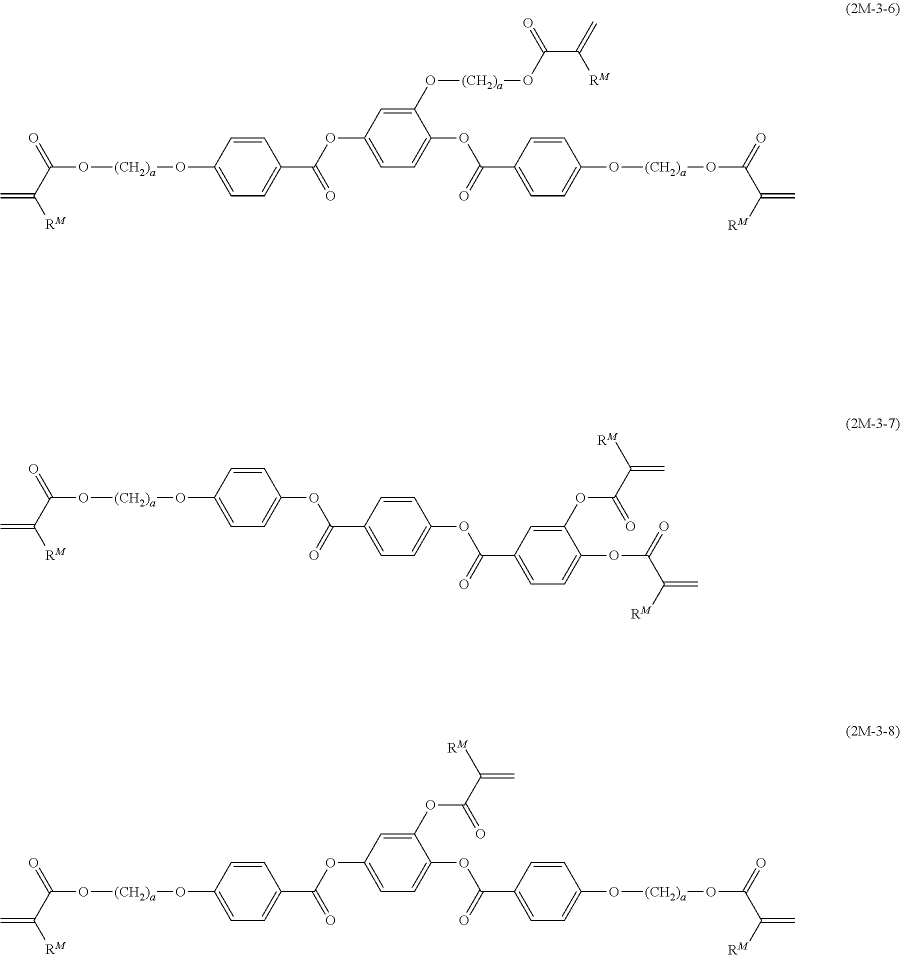

In formulas (2M-1-1) to (2M-1-18), formulas (2M-2-1) to (2M-2-30) and formulas (2M-3-1) to (2M-3-8), R^{M} is independently hydrogen or methyl, and a is independently an integer from 1 to 12.

Compounds (2M-1-1) to (2M-1-18) each are the monofunctional compound, and the polymerizable liquid crystal compound. An increase in an amount of addition of a material being the monofunctional compound and the polymerizable liquid crystal compound in the polymerizable liquid crystal composition results in raising a tilt angle of the polymerizable liquid crystal composition. The increase in the amount of addition of the material being the monofunctional compound and the polymerizable liquid crystal compound in the polymerizable liquid crystal composition results in induction to the homeotropic alignment of the polymerizable liquid crystal compositions.

Compounds (2M-2-1) to (2M-2-30) each are the bifunctional compound, and the polymerizable liquid crystal compound.

The polymerization film prepared by the polymerizable liquid crystal composition is formed into a three-dimensional structure by adding the material being the bifunctional compound and the polymerizable liquid crystal compound in the polymerizable liquid crystal composition. Addition of such a material results in improving mechanical strength or chemical resistance of the liquid crystal polymerization film having the three-dimensional structure, or both thereof.

From viewpoints of improving the contrast in the liquid crystal polymerization film with the base material, compatibility with other liquid crystal compounds in the composition and solubility with the composition, a total of compounds (2M-1-1) to (2M-3-8) in the polymerizable liquid crystal composition is preferably 50% by weight or less, and further preferably 30% by weight or less.

If alignment treatment such as polarization exposure and rubbing is applied to the alignment film prepared by polymerizing the raw material containing polyamic acid including the repeating unit of formula (1), and the polymerizable liquid crystal represented by general formula (2) is directly laminated on the alignment film, the liquid crystal polymerization films are uniformly aligned. The liquid crystal polymerization film having no side chain or a short side chain induces tilt alignment and homogeneous alignment. An alkyl group having a long chain, a connected alicyclic structure or the like is introduced into the side chain of the liquid crystal polymerization film to reduce surface free energy of the alignment film prepared using polyamic acid represented by the repeating unit of formula (1). Thus, the homeotropic alignment of the polymerizable liquid crystals is easy induced.

Addition of the non-liquid crystalline polymerizable compound having a bisphenol structure or a cardo structure to the polymerizable liquid crystal composition results in improving a curing degree of the polymer and inducing homeotropic alignment of the liquid crystal polymers. Compounds (a-1) to (a-3) and so forth show specific examples of the non-liquid crystalline polymerizable compound having the cardo structure.

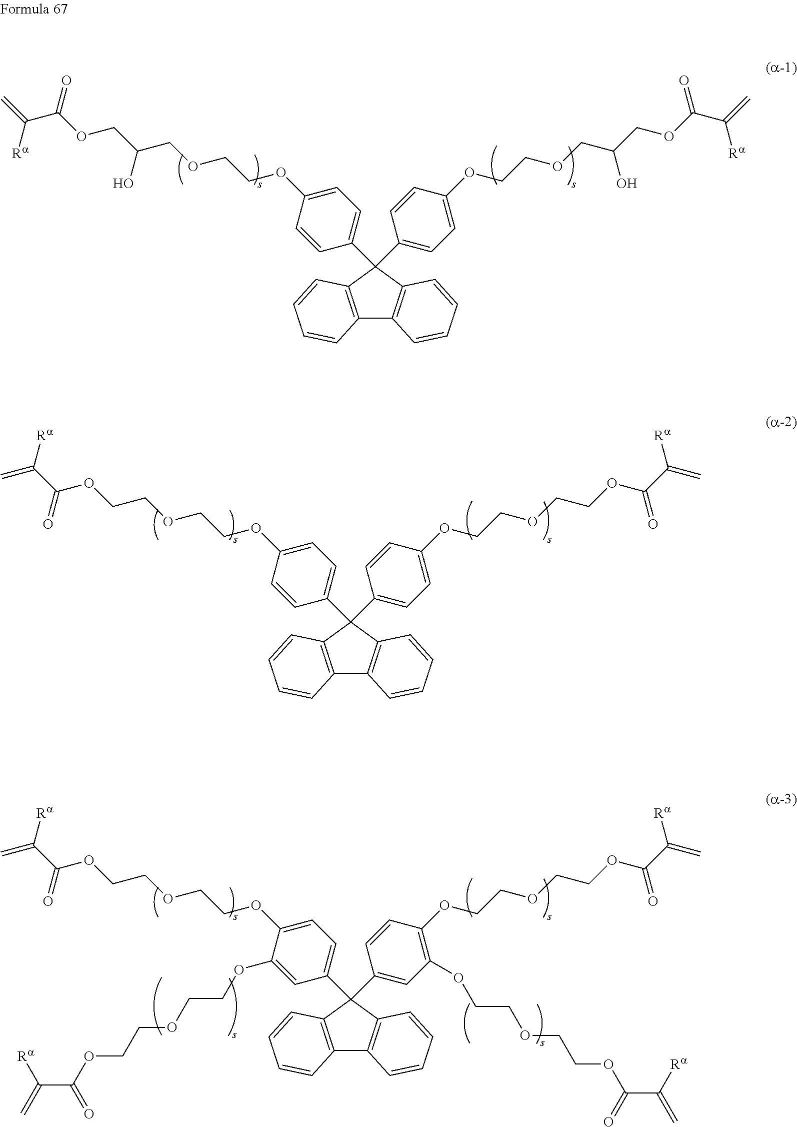

In formulas (a-1) to (a-3), R^{α} is independently hydrogen or methyl, and s is independently an integer from 0 to 4.

In order to induce the homeotropic alignment and suppress reduction of the liquid crystallinity, a content of an additive for inducing the vertical alignment is preferably 0.005 or more and 0.1 or less, in terms of a weight ratio, based on a solid of the composition.

### Additive to the Polymerizable Liquid Crystal Composition

One kind or more kinds of additives may be added to the polymerizable liquid crystal composition of the invention.

Addition of a surfactant to the polymerizable liquid crystal composition results in improving smoothness of the liquid crystal polymerization film. Addition of a nonionic surfactant to the polymerizable liquid crystal composition results in further improving smoothness of the liquid crystal polymerization film. The nonionic surfactant is effective in suppressing the tilt alignment on a side of air interface of the liquid crystal polymerization film. Specific examples of the nonionic surfactant include a silicone type nonionic surfactant, a fluorine type nonionic surfactant, a vinyl type nonionic surfactant and a hydrocarbon type nonionic surfactant.

In order to improve the mechanical strength and the chemical resistance on a surface of the liquid crystal polymerization film, addition of a surfactant being the polymerizable compound to the polymerizable liquid crystal composition is preferred, and a surfactant that starts a polymerization reaction by ultraviolet light is further preferred.

The liquid crystal polymerization films are easily formed into uniform alignment, and applicability of the polymerizable liquid crystal composition is improved, and therefore a proportion of the surfactant in the polymerizable liquid crystal composition is preferably 0.0001 to 0.5% by weight, and further preferably 0.01 to 0.2% by weight, based on the total weight of the polymerizable liquid crystal composition.

The surfactant is classified into the ionic surfactant and the nonionic surfactant.

Specific examples of the nonionic surfactant include a silicone type nonionic surfactant, a fluorine type nonionic surfactant and a vinyl type nonionic surfactant.

Specific examples of the ionic surfactant include a titanate-based compound, imidazoline, a quaternary ammonium salt, alkylamine oxide, a polyamine derivative, a polyoxyethylene-polyoxypropylene condensate, polyethylene glycol and ester thereof, sodium lauryl sulfate, ammonium lauryl sulfate, lauryl sulfate amines, alkyl-substituted aromatic sulfonate, alkyl phosphate, an aliphatic or aromatic sulfonic acid-formalin condensate, lauryl amidopropyl betaine, lauryl aminoacetate betaine, polyethylene glycol fatty acid esters, polyoxyethylene alkylamine, perfluoroalkyl sulfonate and perfluoroalkyl carboxylate.

Specific examples of the silicone type nonionic surfactant include a straight-chain polymer formed of siloxane bond, and a compound in which an organic group such as polyether and long-chain alkyl is introduced into a side chain and/or a terminal.

Specific examples of the fluorine type nonionic surfactant include a compound having a perfluoroalkyl group or a perfluoroalkenyl group each having 2 to 7 carbons.

Specific examples of the vinyl type nonionic surfactant include a (meth)acrylic polymer having a weight average molecular weight of 1,000 to 1,000,000.

Addition of the surfactant having the polymerizable functional group to the polymerizable liquid crystal composition being the raw material of the liquid crystal polymerization film results in improving surface hardness of the liquid crystal polymerization film.

The polymerizable liquid crystal composition of the invention may contain a non-liquid crystalline polymerizable compound. In order to maintain the liquid crystal phase, a total weight of the non-liquid crystalline polymerizable compound in the polymerizable liquid crystal composition is preferably one-fifth or less of the total weight of the polymerizable compound in the polymerizable liquid crystal composition.

Reinforcement of mechanical strength or an improvement in chemical resistance of the liquid crystal polymerization films, or both thereof can be expected by adding the polyfunctional compound to the polymerizable liquid crystal composition.

As the non-liquid crystalline polymerizable compound, a compound having one or two or more vinyl type polymerizable functional groups is typical.

Adhesion between the polymerizable liquid crystal composition and the base material is improved by adding the non-liquid crystalline polymerizable compound having the hydrogen-donating group in the side chain and/or at the terminal to the polymerizable liquid crystal composition.

Specific examples of the non-liquid crystalline polymerizable compound being the monofunctional compound include styrene, nucleus-substituted styrene, acrylonitrile, vinyl chloride, vinylidene chloride, vinylpyridine, N-vinyl pyrrolidone, vinylsulfonic acid, fatty acid vinyl, α,β-ethylenic unsaturated carboxylic acid, alkyl ester of (meth)acrylic acid in which the number of carbon atoms of alkyl is 1 to 18, hydroxyalkyl ester of (meth)acrylic acid in which the number of carbon atoms of hydroxyalkyl is 1 to 18, aminoalkyl ester of (meth)acrylic acid in which the number of carbon atoms of aminoalkyl is 1 to 18, ether oxygen-containing alkyl ester of (meth)acrylic acid in which the number of carbon atoms of ether oxygen-containing alkyl is 3 to 18, N-vinylacetamide, vinyl p-t-butylbenzoate, vinyl N,N-dimethylaminobenzoate, vinyl benzoate, vinyl pivalate, vinyl 2,2-dimethylbutanoate, vinyl 2,2-dimethylpentanoate, vinyl 2-methyl-2-butanoate, vinyl propionate, vinyl stearate, vinyl 2-ethyl-2-methylbutanoate, dicyclopentaniloxylethyl (meth)acrylate, isobornyloxylethyl (meth)acrylate, isobornyl (meth)acrylate, adamantyl (meth)acrylate, dimethyladamantyl (meth)acrylate, dicyclopentanil (meth)acrylate, dicyclopentenyl (meth)acrylate, 2-acryloyloxyethyl succinate, 2-acryloyloxyethy hexahydrophthalate, 2-acryloyloxyethy phthalate, 2-acryloyloxyethyl-2-hydroxyethyl phthalate, 2-acryloyloxyethyl acid phosphate, 2-methacryoyloxyethyl acid phosphate, polyethylene glycol having a polymerization degree of 2 to 100, polypropylene glycol, mono(meth)acrylate of polyalkylene glycol such as a copolymer between ethylene oxide and propylene oxide, or di(meth)acrylate, or polyethylene glycol having a polymerization degree of 2 to 100 and capped with alkyl having 1 to 6 carbons at a terminal, and mono(meth)acrylate of polyalkylene glycol being a copolymer among polyalkylene glycol, ethylene oxide and propylene oxide. Specific examples of “fatty acid vinyl” include vinyl acetate. Specific examples of “α,β-ethylenic unsaturated carboxylic acid” include acrylic acid, methacrylic acid, maleic acid, fumaric acid and itaconic acid. Specific examples of “ether oxygen-containing alkyl ester of (meth)acryl acid in which the number of carbon atoms of ether oxygen-containing alkyl is 3 to 18” include methoxyethyl ester, ethoxyethyl ester, methoxypropyl ester, methylcarbyl ester, ethylcarbyl ester and butylcarbyl ester.

Specific examples of the non-liquid crystalline polymerizable compound being the bifunctional compound include 1,4-butanediol diacrylate, 1,6-hexanediol diacrylate, 1,9-nonanediol diacrylate, neopentyl glycol diacrylate, dimethylol tricyclodecane diacrylate, triethylene glycol diacrylate, dipropylene glycol diacrylate, tripropylene glycol diacrylate, tetraethylene glycol diacrylate, bisphenol A EO-added diacrylate, bisphenol A glycidyl diacrylate, polyethylene glycol diacrylate and a methacrylate compound of the compounds.

Specific examples of the non-liquid crystalline polymerizable compound of the polyfunctional compound being not the bifunctional compound include pentaerythritol triacrylate, trimethylolpropane triacrylate, trimethylol EO-added triacrylate, trisacryloyloxyethyl phosphate, tris(acryloyloxyethyl)isocyanurate, alkyl-modified dipentaerythritol triacrylate, EO-modified trimethylolpropane triacrylate, PO-modified trimethylolpropane triacrylate, pentaerythritol tetraacrylate, alkyl-modified dipentaerythritol tetraacrylate, ditrimethylolpropane tetraacrylate, dipentaerythritol hexaacrylate, dipentaerythritolmonohydroxy pentaacrylate, alkyl-modified dipentaerythritol pentaacrylate, pentaerythritol trimethacrylate, trimethylolpropane trimethacrylate, trimethylol EO-added trimethacrylate, trismethacryloyloxyethyl phosphate, trismethacryloyloxyethyl isocyanurate, alkyl-modified dipentaerythritol trimethacrylate, EO-modified trimethylolpropane trimethacrylate, PO-modified trimethylolpropane trimethacrylate, pentaerythritol tetramethacrylate, alkyl-modified dipentaerythritol tetramethacrylate, ditrimethylolpropane tetramethacrylate, dipentaerythritol hexamethacrylate, dipentaerythritolmonohydroxy pentamethacrylate and alkyl-modified dipentaerythritol pentamethacrylate. Addition of the polymerizable compound having the bisphenol structure or the cardo structure to the polymerizable liquid crystal composition results in improving the curing degree of the polymer and inducing homeotropic alignment of the liquid crystal polymerization film.

Addition of a polymerization initiator results in optimizing a rate of polymerization of the polymerizable liquid crystal composition. Specific examples of the polymerization initiator include a photoradical initiator.

Specific examples of the photoradical initiator include 1-hydroxy-cyclohexyl-phenyl-ketone, 2-hydroxy-2-methyl-1-phenylpropane-1-one, 1-hydroxycyclohexylphenyl ketone, 2,2-dimethoxy-1,2-diphenylethane-1-one, p-methoxyphenyl-2,4-bis(trichloromethyl)triazine, 2-(p-butoxystyryl)-5-trichloromethyl-1,3,4-oxadiazole, 9-phenylacridine, 9,10-benzphenazine, a benzophenone-Michler's ketone mixture, a hexaarylbiimidazole-mercaptobenzimidazole mixture, 1-(4-isopropylphenyl)-2-hydroxy-2-methylpropane-1-one, benzyl dimethyl ketal, 2-methyl-1-[4-(methylthio)phenyl]-2-morpholinopropane-1-one, a 2,4-diethylxanthone-methyl-p-dimethylaminobenzoate mixture and a benzophenone-methyltriethanolamine mixture.

From viewpoints of the contrast, stickiness prevention and prevention of change over time of retardation of the liquid crystal polymerization films, a total weight content of the photoradical polymerization initiator in the polymerizable liquid crystal composition is preferably 0.01 to 10% by weight, further preferably 0.1 to 4% by weight, and still further preferably 0.5 to 4% by weight, based on the total amount of the polymerizable liquid crystal composition.

A sensitizer may be added to the polymerizable liquid crystal composition together with the photoradical polymerization initiator. Specific examples of the sensitizer include isopropylthioxanthone, diethylthioxanthone, ethyl-4-dimethylaminobenzoate and 2-ethylhexyl-4-dimethylaminobenzoate.

A rate of reaction of the polymerizable liquid crystal compound and a length of a chain of the polymer in the liquid crystal polymerization film can be adjusted by addition of a chain transfer agent to the polymerizable liquid crystal composition.

The rate of reaction of the polymerizable liquid crystal compound is reduced by an increase in an amount of the chain transfer agent. The length of the chain of the polymer is decreased by the increase in the amount of the chain transfer agent.

Specific examples of the chain transfer agent include a thiol derivative and a styrene dimer derivative.

Specific examples of the thiol derivative include a thiol derivative being a monofunctional compound and a thiol derivative being a polyfunctional compound.

Specific examples of the thiol derivative being the monofunctional compound include dodecanethiol and 2-ethylhexyl-(3-mercapto)propionate. Specific examples of the thiol derivative being the polyfunctional compound include trimethylolpropane tris(3-mercaptopropionate), pentaerythritol tetrakis(3-mercaptopropionate), 1,4-bis(3-mercaptobutyryloxy)butane, pentaerythritol tetrakis(3-mercaptobutyrate) and 1,3,5-tris(3-mercaptobutyloxyethyl)-1,3,5-triazine-2,4,6(1H,3H,5H)-trione.

Specific examples of the styrene dimer-based chain transfer agent include 2,4-diphenyl-4-methyl-1-pentene and 2,4-diphenyl-1-butene.

Addition of a polymerization preventive to the polymerizable liquid crystal composition results in preventing start of polymerization during storage of the polymerizable liquid crystal composition. Specific examples of the polymerization preventive include a phenol derivative, a phenothiazine derivative, a compound having a nitroso group, and a benzothiazine derivative. Specific examples of the polymerization preventive being the phenol derivative include 2,5-di(t-butyl)hydroxytoluene, hydroquinone, o-hydroxybenzophenone, methylene blue and diphenyl picryl hydrazide. Specific examples of the polymerization preventive being the phenothiazine derivative include phenothiazine and methylene blue. Specific examples of the polymerization preventive being the typical compound having the nitroso group include N,N-dimethyl-4-nitrosoaniline.

Addition of a polymerization inhibitor to the polymerizable liquid crystal composition results in suppressing the polymerization reaction in the polymerizable liquid crystal composition by generation of radicals in the polymerizable liquid crystal composition. Addition of the polymerization inhibitor results in improving storage stability of the polymerizable liquid crystal composition.

Specific examples of the polymerization inhibitor include (a) a phenol type antioxidant, (b) a sulfur type antioxidant, (c) a phosphate type antioxidant and (d) a hindered amine type antioxidant. From a viewpoint of compatibility with the polymerizable liquid crystal composition or transparency of the liquid crystal polymerization films, a phenol type antioxidant is preferred. From a viewpoint of the compatibility, a phenol type antioxidant having a t-butyl group in an ortho-position of a hydroxy group is preferred.

Addition of an ultraviolet light absorber to the polymerizable liquid crystal composition results in improving weather resistance of the polymerizable liquid crystal composition.

Addition of a light stabilizer to the polymerizable liquid crystal composition results in improving the weather resistance of the polymerizable liquid crystal composition.

Addition of an antioxidant to the polymerizable liquid crystal composition results in improving the weather resistance of the polymerizable liquid crystal composition.

Addition of a silane coupling agent to the polymerizable liquid crystal composition results in improving adhesion between the base material and the liquid crystal polymerization film.

In order to facilitate coating, a solvent is preferably added to the polymerizable liquid crystal composition.

Specific examples of a component of the solvent include ester, an amide-based compound, alcohol, ether, glycol monoalkyl ether, aromatic hydrocarbon, halogenated aromatic hydrocarbon, aliphatic hydrocarbon, halogenated aliphatic hydrocarbon, alicyclic hydrocarbon, ketone and an acetate-based solvent.

The amide-based compound means a compound having an amide group, and serving as the component of the solvent. The acetate-based solvent means a compound having an acetate structure, and serving as the component of the solvent.

Specific examples of the ester include alkyl acetate, ethyl trifluoroacetate, alkyl propionate, alkyl butyrate, dialkyl malonate, alkyl glycolate, alkyl lactate, monoacetin, γ-butyrolactone and γ-valerolactone.

Specific examples of “alkyl acetate” include methyl acetate, ethyl acetate, propyl acetate, isopropyl acetate, butyl acetate, 3-methoxybutyl acetate isobutyl acetate, pentyl acetate and isopentyl acetate. Specific examples of “alkyl propionate” include methyl propionate, methyl 3-methoxypropionate, ethyl propionate, propyl propionate and butyl propionate. Specific examples of “alkyl butyrate” include methyl butyrate, ethyl butylate, butyl butyrate, isobutyl butyrate and propyl butyrate. Specific examples of “dialkyl malonate” include diethyl malonate. Specific examples of “alkyl glycolate” include methyl glycolate and ethyl glycolate. Specific examples of “alkyl lactate” include methyl lactate, ethyl lactate, isopropyl lactate, n-propyl lactate, butyl lactate and ethylhexyl lactate.

Specific examples of the amide-based compound include N-methyl-2-pyrrolidone, N,N-dimethylacetamide, N-methylpropionamide, N,N-dimethylformamide, N,N-diethylformamide, N,N-diethylacetamide, N,N-dimethylacetamide dimethyl acetal, N-methylcaprolactam and dimethylimidazolidinone.

Specific examples of the alcohol include methanol, ethanol, 1-propanol, 2-propanol, 1-methoxy-2-propanol, t-butyl alcohol, sec-butyl alcohol, butanol, 2-ethylbutanol, n-hexanol, n-heptanol, n-octanol, 1-dodecanol, ethylhexanol, 3,5,5-trimethylhexanol, n-amyl alcohol, hexafluoro-2-propanol, glycerol, ethylene glycol, diethylene glycol, triethylene glycol, tetraethylene glycol, propylene glycol, dipropylene glycol, tripropylene glycol, hexylene glycol, 1,3-butanediol, 1,4-butanediol, 2,3-butanediol, 1,5-pentanediol, 2,4-pentanediol, 2,5-hexanediol, 3-methyl-3-methoxybutanol, cyclohexanol and methyl cyclohexanol.

Specific examples of the ether include ethylene glycol dimethyl ether, diethylene glycol dimethyl ether, bis(2-propyl)ether, 1,4-dioxane and tetrahydrofuran.

Specific examples of the glycol monoalkyl ether include ethylene glycol monoalkyl ether, diethylene glycol monoalkyl ether, triethylene glycol monoalkyl ether, propylene glycol monoalkyl ether, dipropylene glycol monoalkyl ether, ethylene glycol monoalkyl ether acetate, diethylene glycol monoalkyl ether acetate, triethylene glycol monoalkyl ether acetate, propylene glycol monoalkyl ether acetate, dipropylene glycol monoalkyl ether acetate and diethylene glycol methyl ethyl ether.

Specific examples of the ethylene glycol monoalkyl ether include ethylene glycol monomethyl ether and ethylene glycol monobutyl ether. Specific examples of the diethylene glycol monoalkyl ether include diethylene glycol monoethyl ether. Specific examples of the propylene glycol monoalkyl ether include propylene glycol monobutyl ether. Specific examples of the dipropylene glycol monoalkyl ether include dipropylene glycol monomethyl ether. Specific examples of the ethylene glycol monoalkyl ether acetate include ethylene glycol monobutyl ether acetate. Specific examples of the diethylene glycol monoalkyl ether acetate include diethylene glycol monoethyl ether acetate. Specific examples of the propylene glycol monoalkyl ether acetate include propylene glycol monoethyl ether acetate, propylene glycol monoethyl ether acetate and propylene glycol monobutyl ether acetate. Specific examples of the dipropylene glycol monoalkyl ether acetate include dipropylene glycol monomethyl ether acetate.

Specific examples of the aromatic hydrocarbon include benzene, toluene, xylene, mesitylene, ethylbenzene, diethylbenzene, i-propylbenzene, n-propylbenzene, t-butylbenzene, s-butylbenzene, n-butylbenzene and tetralin.

Specific examples of the halogenated aromatic hydrocarbon include chlorobenzene. Specific examples of the aliphatic hydrocarbon include hexane and heptane. Specific examples of the halogenated aliphatic hydrocarbon include chloroform, dichloromethane, carbon tetrachloride, dichloroethane, trichloroethylene and tetrachloroethylene. Specific examples of the alicyclic hydrocarbon include cyclohexane and decalin.

Specific examples of the ketone include acetone, methyl ethyl ketone, methyl isobutyl ketone, cyclohexanone, cyclopentanone and methyl propyl ketone.

Specific examples of the acetate-based solvent include ethylene glycol monomethyl ether acetate, propylene glycol monoethyl ether acetate, propylene glycol monoethyl ether acetate, methyl acetoacetate and 1-methoxy-2-propyl acetate.

From a viewpoint of the compatibility with the polymerizable liquid crystal compound, the solvent in the polymerizable liquid crystal composition is preferably 30 to 96% by weight, further preferably 50 to 90% by weight, and still further preferably 60 to 80% by weight, based on the total amount of the polymerizable liquid crystal composition.

The polymerizable liquid crystal composition of the invention may contain a compound having optical activity. Addition of the compound having optical activity to the liquid crystal composition results in inducing the liquid crystal polymerization films to twist alignment. The liquid crystal polymerization film can be used as a selective reflection film and a negative C-plate in a wavelength region of 300 to 2,000 nanometers.

Specific examples of the compound having optical activity include a compound having asymmetric carbon, an axial chirality compound having a binaphtyl structure, a helicene structure, and a planar chirality compound having a cyclophane structure. From a viewpoint of immobilizing a helical pitch of twist alignment, the compound having optical activity in the above case is preferably a polymerizable compound.

The liquid crystal polymerization film of the invention may contain a dichroic dye. The liquid crystal polymerization films forming a composite with the dichroic dye can be used in the form of an absorptive polarizing plate.

### Base Material

Specific examples of material of the base material include glass, plastic and metal. The glass or the metal may be subjected to slit-form processing on a surface thereof. The plastic may be subjected to stretching treatment and surface treatment such as hydrophilizing treatment and hydrophobizing treatment.

### Preparation of Liquid Crystal Polymerization Film

### Preparation of Alignment Film

The alignment film can be formed onto a base material by the following procedure (I) or procedure (II):

### Procedure (I):

### Procedure (I-1):

a solution containing polyamic acid represented by the repeating unit of formula (1) is applied onto a base material, and the resulting material is dried to form a coating film thereon;

### Procedure (I-2):

the coating film composed of polyamic acid, which is formed in procedure (I-1), is calcinated at a temperature equal to or higher than a level at which polyamic acid is imidized to form an imidized coating film; and then

### Procedure (I-3):

to the imidized coating film formed in procedure (1-2), alignment treatment is applied to provide the film with anisotropy to form an alignment film on the base material;

### Procedure (II):

### Procedure (II-1):

a solution containing polyamic acid represented by the repeating unit of formula (1) is applied onto a base material, and the resulting material is dried to form a coating film; and procedure (II-2):

to the coating film composed of polyamic acid as formed in procedure (II-1), alignment treatment is applied to provide the film with anisotropy; and then procedure (II-3):

the coating film composed of polyamic acid in procedure (II-2) is calcinated at a temperature equal to or higher than a level at which polyamic acid is imidized to form an alignment film on the base material.

On the above occasion, from viewpoints of film thickness and uniformity, in formation of the liquid crystal polymerization film, an offset printing method and an inkjet printing method are preferred. In order to remove the solvent in the solution on the base material, heat treatment on a hot plate, in a drying oven, by blowing warmed air or others is preferably simultaneously applied thereto in any one of steps in procedures (I-1) to (1-2).

Treatment for alignment is easy, and therefore a photoalignment method and a rubbing method are preferably used in procedure (1-3) or procedure (II-2).

For improving the contrast in the liquid crystal polymerization films, a photoalignment method is further preferably used in procedure (1-3) or procedure (II-2).

A low-pressure mercury lamp, a high pressure discharge lamp, a short arc discharge lamp or the like can be utilized for photoalignment treatment. Specific examples of the low-pressure mercury lamp include a bactericidal lamp, a fluorescent chemical lamp and a black light. Specific examples of the high pressure discharge lamp include a high pressure mercury lamp and a metal halide lamp. Specific examples of the short arc discharge lamp include an ultra high pressure mercury lamp, a Xenon lamp and a Mercury-Xenon lamp. The alignment film can be formed with a small amount of light exposure, and therefore linear polarization is preferably used in procedure (I-3) or procedure (II-3). In order to prevent damage on the alignment film by backlight or visible light of the liquid crystal display apparatus, polyamic acid being the raw material of the coating film is preferably a material having no optical absorption wavelength by 400 nanometers or more.

Preparation of Liquid Crystal Polymerization Film with Base Material

The liquid crystal polymerization film with the base material can be formed by the following procedures:

### Procedure (III-1):

a solution containing a polymerizable liquid crystal compound represented by formula (2) is applied to an alignment film on a base material, and the resulting material is dried to form a coating film;

### Procedure (III-2):

a temperature of the coating film is adjusted to a level at which a liquid crystal phase is exhibited; and

### Procedure (III-3):

light is exposed to the coating film to prepare a liquid crystal polymerization film with a base material.

From a viewpoint of improving adhesion between the liquid crystal polymerization film and the base material, the liquid crystal polymerization film with the base material is preferably heated after procedure (III-3). A temperature of the heat treatment is equal to or lower than a durability temperature to be required for the liquid crystal polymerization film with the base material.

In procedure (III-1), from viewpoints of the film thickness and the uniformity thereof, application by a spin coating method, a microgravure coating method, a gravure coating method, a wire-bar coating method, a dip coating method, a spray coating method, a meniscus coating method and a die coating method is preferred.

In the liquid crystal polymerization film, reduction of phase difference by heat is small and elution of impurities into a nematic liquid crystal is small, and therefore the liquid crystal polymerization film can be used as in-cell use in LCD.

A polarizing plate having a function such as optical compensation can be manufactured by preparing the liquid crystal polymerization film with the base material by using the polarizing plate as the base material. If a liquid crystal polymerization film having ¼ wave length is formed on the polarizing plate, the liquid crystal polymerization film with the base material being a circularly polarizing plate can be manufactured. An absorptive polarizing plate in which iodine or a dichroic dye is doped, and a reflective polarizing plate such as a wire grid polarizing plate or the like can be served as the polarizing plate

### EXAMPLES

The invention is not limited only to Examples presented herein.

In Examples of the invention, room temperature means 25° C.

In Examples of the invention, compound (DA-1) to compound (DA-9) each are a compound represented by the following formula:

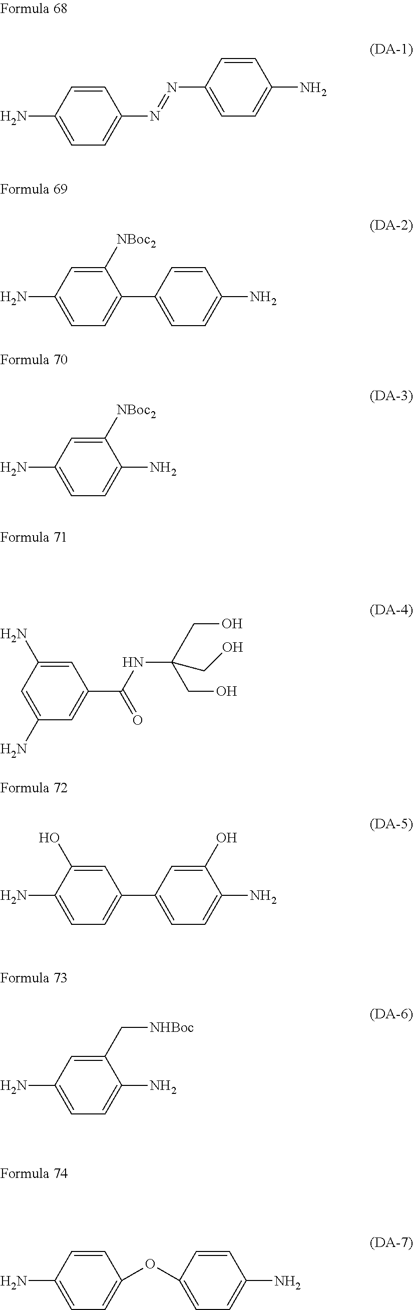

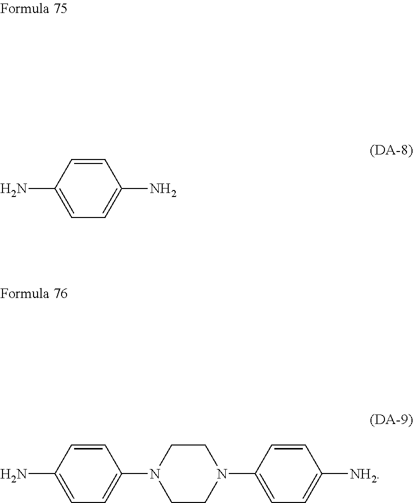 [SMILES: Nc1ccc(N)cc1 ; Nc1ccc(N2CCN(c3ccc(N)cc3)CC2)cc1]

As compound (DA-1), compound (DA-5), compound (DA-7), compound (DA-8) and compound (DA-9), a commercial item was used. Compound (DA-2), compound (DA-3), compound (DA-4) and compound (DA-6) were prepared according to JP 5929298 B, JP 2015-020999 A, JP 5643985 B and WO 2013/039168 A, respectively.

In Examples of the invention, compound (AA-1) to compound (AA-4), and compound (AE-1) each are a compound represented by the following formula:

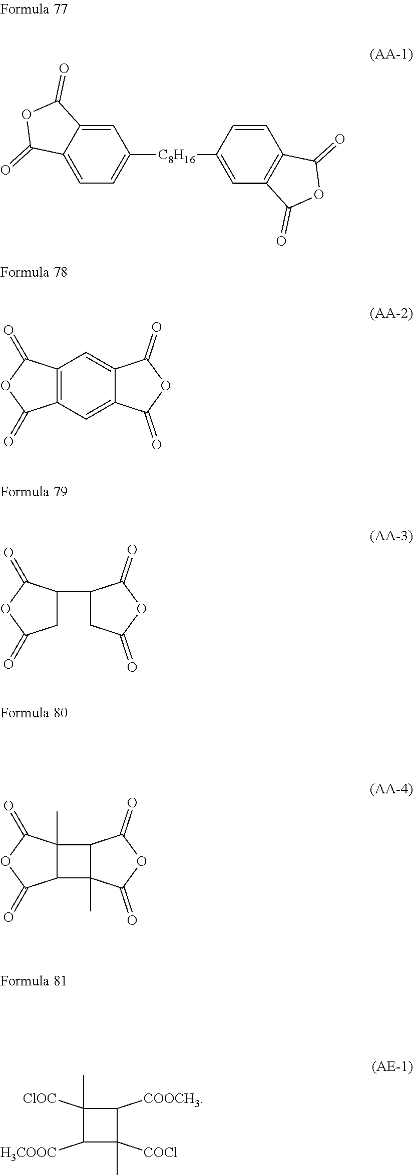

As compound (AA-2) and compound (AA-3), a commercial item was used. Compound (AA-1) and compound (AA-4) were prepared according to JP 5407394 B. Compound (AE-1) was prepared according to WO 2013/039168 A.

Compound (DA-1) to compound (DA-9), compound (AA-1) to compound (AA-4) and compound (AE-1) serve as a raw material of polyamic acid represented by a repeating unit of formula (1).

In Examples of the invention, “Irg-907” represents IRUGACURE (trademark) 907 made by BASF Japan Ltd.

In Examples of the invention, “NCI-930” represents ADEKA CRUISE (trademark) NCI-930 made by ADEKA Corporation.

In Examples of the invention, “FTX-218” represents FUTAGENT (trademark) FTX-218 made by NEOS Company Limited.

In Examples of the invention, “TEGO Flow 370” represents TEGO (trademark) Flow 370 made by Evonik Japan, Inc.

In Examples of the invention, “BOC” means —CO—C(CH₃)₃ being a functional group.

In Examples of the invention, “NMP” represents 1-methyl-2-pyrrolidone.

In Examples of the invention, “BC” represents ethyleneglycol monobutylether.

In Examples of the invention, “GBL” represents γ-butyrolactone.

In Examples of the invention, “IPA” represents 2-propanol.

In Examples of the invention, a glass base material represents EagleXG made by Corning, Inc.

In Examples of the invention, “DMAP” represents N,N-dimethyl-4-aminopyridine.

In Examples of the invention, “DCC” represents N,N′-dicyclohexylcarbodiimide.

In Examples of the invention, “THF” represents tetrahydrofuran.

### Polymerizable Liquid Crystal Composition

In Examples of the invention, a structure of compound each used in the polymerizable liquid crystal composition is shown below. The compounds were prepared according to literature described after the structure of compounds, respectively.

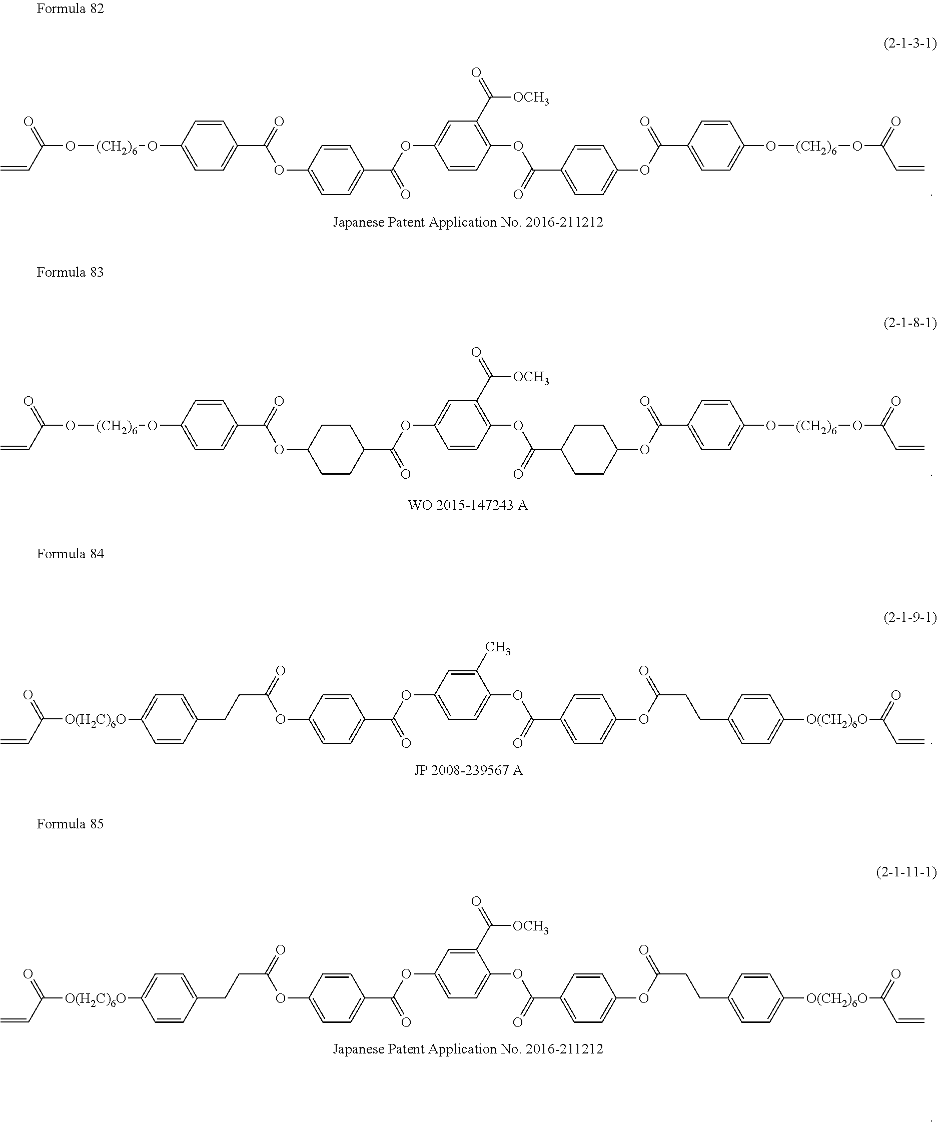

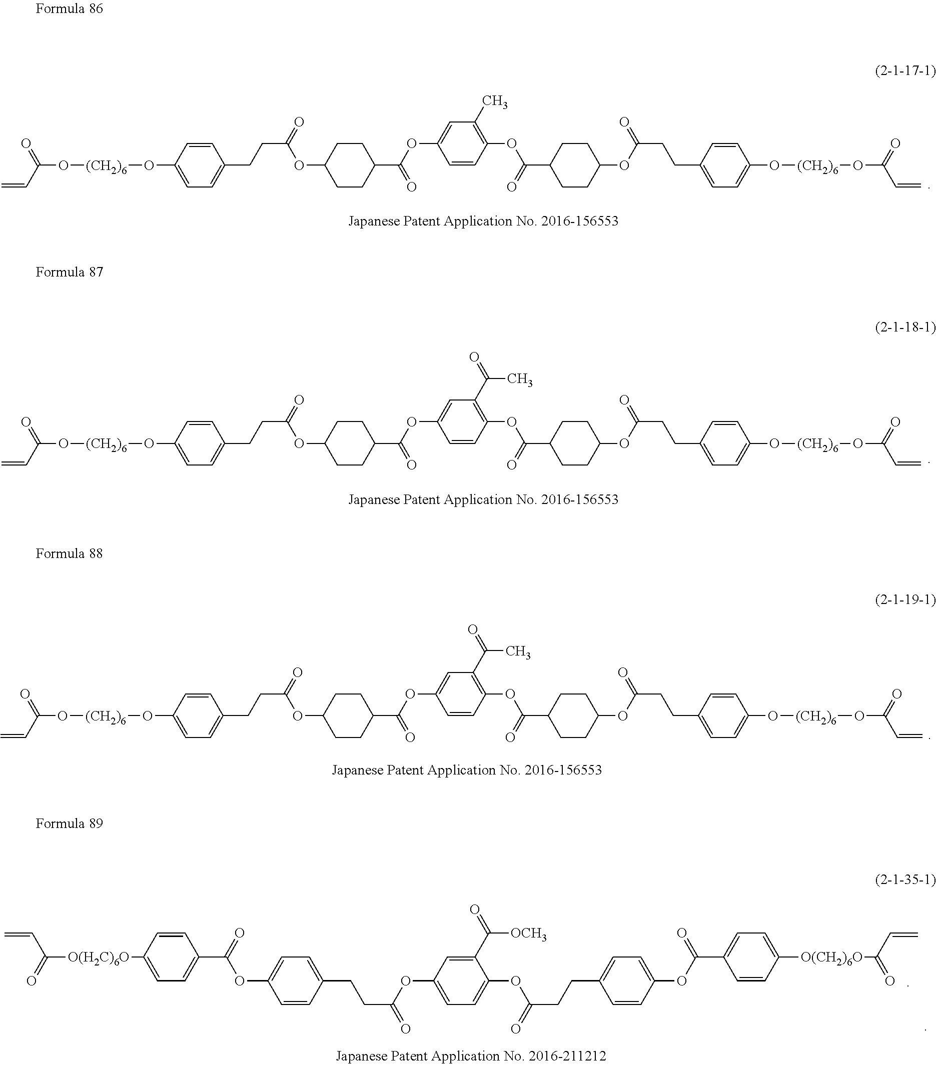

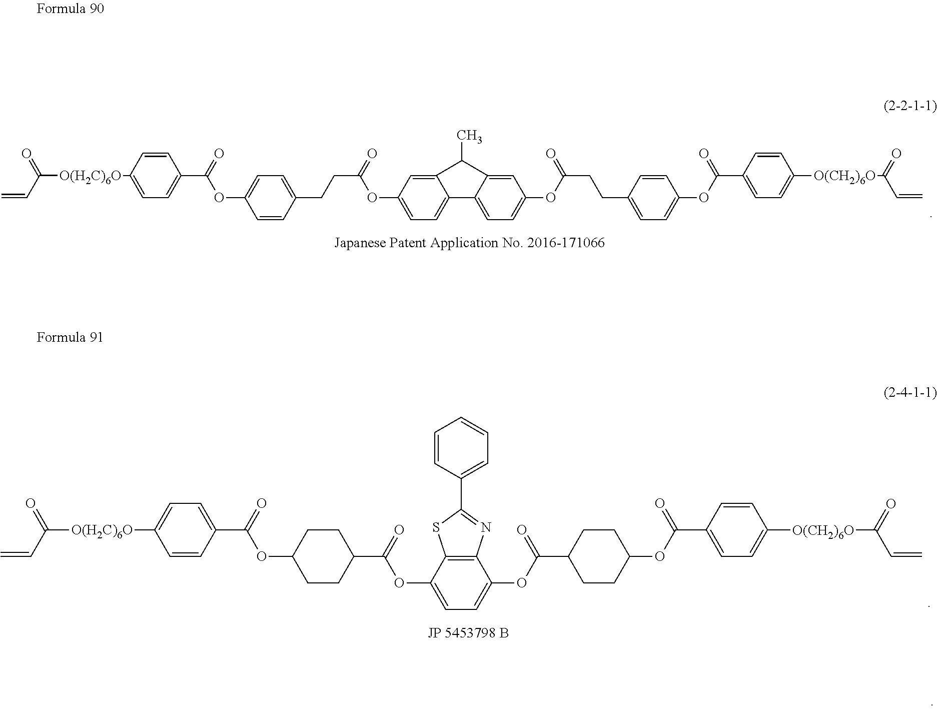

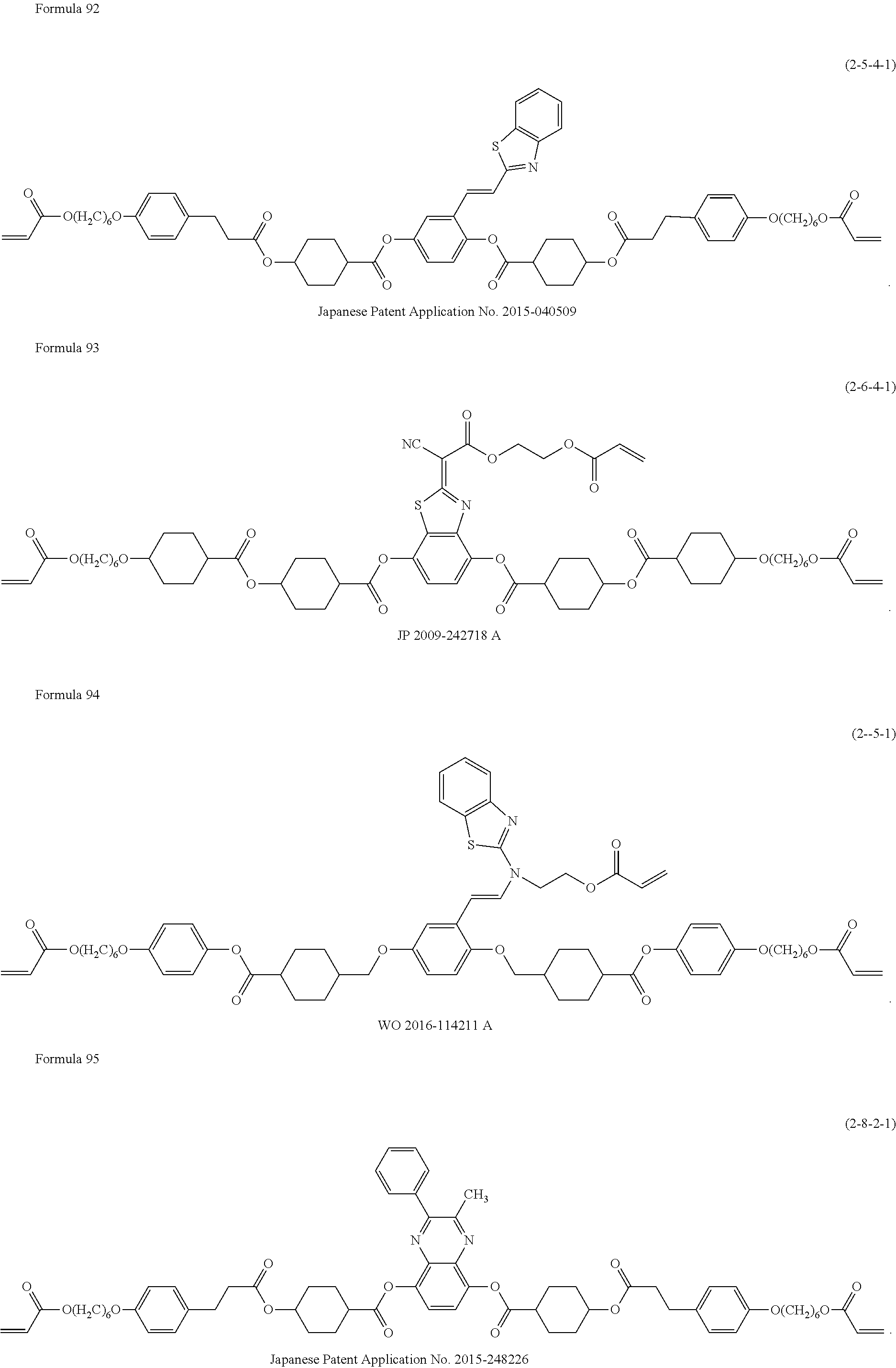

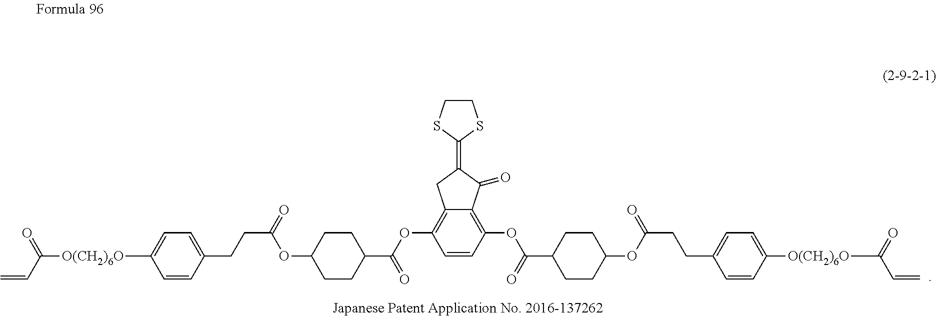

In Examples of the invention, “standard polystyrene” is TSKgel standard polystyrene made by Tosoh Corporation.

In Examples of the invention, “GPC” is a system consisting of 2695 Separation Module made by Waters Corporation, and 2414 Refractive Index Detector made by Waters Corporation.

In Examples of the invention, “viscometer” is TV-22 made by Toki Sangyo Co., Ltd.

In Examples of the invention, “optical film thickness measurement system” is DF-1030R made by Techno-Synergy, Inc.

In Examples of the invention, “Stylus Profilometer” is Alpha-Step IQ made by KLA-Tencor Corporation.

In Examples of the invention, “Fourier transform infrared spectrophotometer” is FT/IR-610 by JASCO Corporation.

In Examples of the invention, “photoalignment lighting system” is model No. APL-L01212S1-ASN01 made by Ushio Inc.

In Examples of the invention, “ultra high pressure mercury lamp” is Multilight-250 that has 250 W output and made by Ushio Inc.

In Examples of the invention, “ellipsometer” is OPIPRO Ellipsometer made by Shintech, Inc.

In Examples of the invention, “luminance meter” is YOKOGAWA 3298F.

### Measurement of Molecular Weight of Polyamic Acid

A weight average molecular weight was measured by GPC in comparison with a standard polystyrene. As a column, HSPgel RT MB-M made by Waters Corporation was used.

A material prepared by dissolving an analysis object in a mixed solution of phosphoric acid and DMF to be 2% by weight was developed in GPC under conditions of a column temperature of 50° C. and a flow rate of 0.40 mL/min. A weight ratio in the mixed solution of phosphoric acid and DMF was 0.6/100. The developer was the mixed solution of phosphoric acid and DMF.

### Measurement of Viscosity of Polyamic Acid

Viscosity was measured using a viscometer in a state of 25° C. for an object according to an instruction manual of an apparatus.

### Measurement of Film Thickness

A film thickness of an alignment film was measured by an optical film thickness measurement system.

A film thickness of a liquid crystal polymerization film having a glass base material was measured according to the following procedures:

(1) a liquid crystal polymerization film was shaved off from a glass base material having the liquid crystal polymerization film;

(2) a level difference between a portion of the liquid crystal polymerization film and a portion from which the liquid crystal polymerization film was removed was measured; and

(3) a measured value thereof was taken as the film thickness.

In Example of the invention, the level difference of a part of the liquid crystal polymerization film was measured by Stylus Profilometer.

### Measurement of Imidization Ratio of Alignment Film

An imidization ratio was determined by the following procedures:

(1-1) a KBr tablet was prepared from an alignment film shaved from a base material, and was named as “sample,”

(1-2) the sample prepared by a method similar to procedure (1-1) was calcinated at 280° C. for 30 minutes, and the resulting material was named as “control,”

(2-1) an area ratio of a absorption peak near 1,780 cm⁻¹ arising from an imide group of the sample to an area of the absorption peak near 1,500 cm⁻¹ of an aromatic ring in a polyimide of the sample was measured by a Fourier transform infrared spectrophotometer, and was named as “area ratio of absorption peak of sample,”

(2-2) an area ratio of a absorption peak of the control was measured in place of the sample in a manner similar to procedure (2-1), and was named as “area ratio of absorption peak of control,” and

(3) a value calculated according to an equation: “area ratio of absorption peak of sample”/“area ratio of absorption peak of control”×100 was taken as an imidization ratio of the alignment film, in which a unit of the imidization ratio was expressed by “%.”

### Exposure Conditions

Exposure for preparing an alignment film was carried out by a photoalignment lighting system.

Exposure for preparing a liquid crystal polymerization film was carried out by an ultra high pressure mercury lamp.

### Confirmation of Existence or Non-Existence of Alignment Defect

Existence or non-existence of alignment defects was judged by interposing, between two polarizing plates arranged in a crossed Nicol state, a liquid crystal polymerization film with a base material. The base material was rotated in a horizontal plane to visually confirm a bright or dark state. A case where no place through which light was observed was observed in a dark state and neither a light state nor a dark state was able to be confirmed was deemed as “no defective alignment.”

### Confirmation of Homogeneous Alignment

Retardation was measured by using an ellipsometer and changing an angle of light incident to a surface of the liquid crystal polymerization film with a base material from −500 to 500 at an increment of 50. Here, an inclination direction of the incident angle of light is identical to a direction of a phase lag axis of the liquid crystal polymerization film. When both conditions described below were satisfied, the liquid crystal polymerization film was deemed to be homogeneously aligned: (a) a case where the retardation to the incident angle of the liquid crystal polymerization film was convex upward, and (b) a case where a difference between respective measured value of Re when an absolute value of each incident angle was identical is within 5%.

### Measurement of Retardation

Retardation of the liquid crystal polymerization film was measured by an ellipsometer by decreasing an incident angle of light to a surface from 900. The retardation in Tables is a value in measured wavelength of 550 nanometers.

### Evaluation of Birefringence an

Birefringence Δn was calculated by an equation: (retardation of liquid crystal polymerization film)/(film thickness of liquid crystal polymerization film).

### Wavelength Dispersion

A ratio of retardation in the measured wavelength of 450 nanometers to the measured wavelength of 550 nanometers was shown.

### Measurement of Luminance in Crossed Nicol State and Luminance in Parallel Nicol State

Luminance in a crossed Nicol state and luminance in a parallel Nicol state were measured by using a luminance meter by interposing, between two polarizing plates of a polarizing microscope, a liquid crystal polymerization film with a base material. Luminance to be a minimum when the base material in the crossed Nicol state was horizontally rotated was regarded as “luminance in the crossed Nicol state.” Luminance to be a maximum when the base material in the parallel Nicol state was rotated in a horizontal plane was regarded as “luminance in the parallel Nicol state.”

### Adhesion Test

An adhesion test of a liquid crystal polymer film with a base material was conducted in accordance with the former JIS K5400 “Testing methods for paints—General rule.” In Examples of the present specification, the number of squares is expressed by the number of squares in which no flaking was caused in 100 squares by performing trials according to the testing methods.

### Preparation of Polyamic Acid Solution

### Example 1

In a 100 mL four-necked flask equipped with a thermometer, a stirrer, a material inlet and a nitrogen gas feeding port, 0.6605 g of compound (DA-1), 0.5328 g of compound (DA-2) and 17.4 mL of NMP were put, and the resulting mixture was stirred and dissolved under a nitrogen flow in a manner similar to the method described in JP 2012-193167 A. Then, 1.8067 g of compound (AA-1) and 10 mL of NMP were put thereto, and the resulting mixture was stirred at room temperature for 24 hours. To the obtained solution, 20.8 mL of BC was added, and the resulting solution was named as a varnish solution. The varnish solution was stirred at 75° C. for 4 hours, and named as polyamic acid solution (PA-1). A concentration of a polymer solid in polyamic acid solution (PA-1) was 6% by weight. Viscosity of polyamic acid solution (PA-1) was 11.3 mPa·s. A weight average molecular weight of polyamic acid solution (PA-1) was 23,000.

### Example 2

Polyamic acid solutions (PA-2) to (PA-8), and polyamic acid solutions (PA-I) to (PA-II) each having a polymer solid concentration of 6% by weight were prepared by using diamine and acid dianhydride described in Table 1 in place of compound (DA-1) and compound (DA-2) and/or acid dianhydride (AA-1) in preparing polyamic acid solution (PA-1). Polyamic acid in polyamic acid solution (PA-1) to polyamic acid solution (PA-8) is polyamic acid represented by formula (1) of the invention.

TABLE 1

| | | | Weight | |
|---|---|---|---|---|
| Name of | | Name of acid | average | |
| polyamic acid | Name of diamine and mole | dianhydride and mole | molecular | Viscosity |
| solution | fraction | fraction | weight | (MPa · s) |
| Polyamic acid | 0.70 mole fraction of compound | 1.00 mole fraction of | 25,000 | 10.0 |
| solution (PA-1) | (DA-1) and 0.30 mole fraction | compound (AA-1) | | |
| | of compound (DA-2) | | | |
| Polyamic acid | 0.80 mole fraction of compound | 1.00 mole fraction of | 25,000 | 10.0 |
| solution (PA-2) | (DA-1) and 0.20 mole fraction | compound (AA-1) | | |
| | of compound (DA-2) | | | |
| Polyamic acid | 0.82 mole fraction of compound | 1.00 mole fraction of | 18,000 | 12.3 |
| solution (PA-3) | (DA-1) and 0.18 mole fraction | compound (AA-1) | | |
| | of compound (DA-3) | | | |
| Polyamic acid | 0.92 mole fraction of compound | 1.00 mole fraction of | 21,000 | 10.3 |
| solution (PA-4) | (DA-1) and 0.08 mole fraction | compound (AA-1) | | |
| | of compound (DA-4) | | | |
| Polyamic acid | 0.90 mole fraction of compound | 1.00 mole fraction of | 25,000 | 11.7 |
| solution (PA-5) | (DA-1) and 0.10 mole fraction | compound (AA-1) | | |
| | of compound (DA-5) | | | |
| Polyamic acid | 0.40 mole fraction of compound | 1.00 mole fraction of | 86,000 | 36.0 |
| solution (PA-6) | (DA-7), 0.30 mole fraction of | compound (AA-4) | | |
| | compound (DA-8) and 0.30 | | | |
| | mole fraction of compound | | | |
| | (DA-9) | | | |
| Polyamic acid | 1.00 mole fraction of compound | 1.00 mole fraction of | 20,000 | 11.4 |
| solution (PA-7) | (DA-1) | compound (AA-1) | | |
| Polyamic acid | 0.95 mole fraction of compound | 0.90 mole fraction of | 18,000 | 9.3 |
| solution (PA-8) | (DA-1) and 0.05 mole fraction | compound (AA-1) | | |
| | of compound (DA-4) | 0.20 mole fraction of | | |
| | | maleic anhydride | | |
| Polyamic acid | 1.00 mole fraction of compound | 0.60 mole fraction of | 84,000 | 37.2 |
| solution (PA-I) | (DA-7) | compound (AA-2) | | |
| | | 0.40 mole fraction of | | |
| | | compound (AA-3) | | |
| Polyamic acid | 0.50 mole fraction of compound | 0.60 mole fraction of | 78,000 | 35.6 |
| solution (PA-II) | (DA-7) and 0.50 mole fraction | compound (AA-2) | | |
| | of compound (DA-8) | 0.40 mole fraction of | | |
| | | compound (AA-3) | | |

### Preparation of Polyamic Acid Ester Solution (PAE-1)

### Example 3

Into a 100 mL four-necked flask, 2.80 g of compound (DA-8), 1.45 g of compound (DA-6), 6.18 g of pyridine and 110 mL of NMP were put in a manner similar to the method of Synthesis Example 7 and Synthesis Example 8 described in WO 2013/039168 A. The four-necked flask was moved onto an ice bath, 9.89 g of compound (AE-1) was slowly added to the four-necked flask, and the resulting mixture was stirred at room temperature overnight. Then, 0.38 g of acryloyl chloride was added thereto, and the resulting mixture was allowed to react at room temperature for 5 hours. Then, the obtained solution was added to 1.2 L of pure water, and a white deposit precipitated was filtered off, and the deposit was washed with 1.2 L of IPA 3 times, and was finally dried in vacuum. Polyamic acid ester obtained was 9.5 g (yield: 77%). A weight average molecular weight of the polymer measured by GPC was 32,000.

Then, 19.0 g of GBL was added to 1.00 g of polyamic acid ester, and the resulting mixture was stirred at room temperature for 30 minutes to dissolve the mixture. To the above solution, 0.35 g of N-α-(9-fluorenylmethoxycarbonyl)-N-τ-t-butoxycarbonyl L-histidine and 5.0 g of BC were added to obtain about 5.6% by weight of a solution, and the solution was named as polyamic acid ester solution (PAE-1).

### Preparation of Polymerizable Liquid Crystal Composition

### Example 4

Polymerizable liquid crystal composition (LC-1) was prepared by the following method.

Then, 0.2040 g of compound (2-1-3-1) and 0.3060 g of compound (2-1-19-1) were dissolved in 2.49 g of cyclohexanone, and 0.0306 g of Irg-907 and 0.0153 g of TEGO Flow370 were further added thereto, and the resulting mixture was dissolved.

Polymerizable liquid crystal composition (LC-2) to polymerizable liquid crystal composition (LC-17) were prepared by changing a compound and an amount thereof in preparing polymerizable liquid crystal composition (LC-1) into compounds as described in Table 2. However, a total amount of the polymerizable liquid crystal compound in the polymerizable liquid crystal composition was adjusted to be 17% by weight by an amount of cyclohexane.

TABLE 2

| Name of | Weight proportion of compound in | Polymerization | |
|---|---|---|---|
| polymerizable liquid | polymerizable liquid crystal | initiator and the | Surfactant and the |
| crystal composition | composition | content | content |
| Polymerizable liquid | 40 parts by weight of compound | 6 parts by weight | 0.3 parts by weight of |
| crystal composition | (2-1-3-1) and 60 parts by weight of | of Irg-907 | TEGO Flow370 |
| (LC-1) | compound (2-1-19-1) | | |
| Polymerizable liquid | 40 parts by weight of compound | 6 parts by weight | 0.3 parts by weight of |
| crystal composition | (2-1-8-1) and 60 parts by weight of | of Irg-907 | TEGO Flow370 |
| (LC-2) | compound (2-1-19-1) | | |
| Polymerizable liquid | 30 parts by weight of compound | 5 parts by weight | 0.3 parts by weight of |
| crystal composition | (2-1-9-1) and 70 parts by weight of | of Irg-907 | TEGO Flow370 |
| (LC-3) | compound (2-1-19-1) | | |
| Polymerizable liquid | 40 parts by weight of compound | 9 parts by weight | 0.1 parts by weight of |
| crystal composition | (2-1-11-1) and 60 parts by weight of | of NCI-930 | FTX-218 |
| (LC-4) | compound (2-1-19-1) | | |
| Polymerizable liquid | 50 parts by weight of compound | 5 parts by weight | 0.1 parts by weight of |
| crystal composition | (2-1-17-1) and 50 parts by weight of | of Irg-907 | FTX-218 |
| (LC-5) | compound (2-1-18-1) | | |
| Polymerizable liquid | 60 parts by weight of compound | 6 parts by weight | 0.3 parts by weight of |
| crystal composition | (2-1-18-1) and 40 parts by weight of | of Irg-907 | TEGO Flow370 |
| (LC-6) | compound (2-1-35-1) | | |
| Polymerizable liquid | 60 parts by weight of compound | 8 parts by weight | 0.3 parts by weight of |
| crystal composition | (2-1-19-1) and 40 parts by weight of | of NCI-930 | TEGO Flow370 |
| (LC-7) | compound (2-2-1-1) | | |
| Polymerizable liquid | 30 parts by weight of compound | 8 parts by weight | 0.3 parts by weight of |
| crystal composition | (2-1-3-1), 50 parts by weight of | of NCI-930 | TEGO Flow370 |
| (LC-8) | compound (2-1-19-1) and 20 parts by | | |
| | weight of compound (2-2-1-1) | | |
| Polymerizable liquid | 40 parts by weight of compound | 9 parts by weight | 0.3 parts by weight of |
| crystal composition | (2-1-11-1), 40 parts by weight of | of NCI-930 | TEGO Flow370 |
| (LC-9) | compound (2-1-19-1) and 20 parts by | | |
| | weight of compound (2-2-1-1) | | |
| Polymerizable liquid | 50 parts by weight of compound | 9 parts by weight | 0.3 parts by weight of |
| crystal composition | (2-1-19-1), 30 parts by weight of | of NCI-930 | TEGO Flow370 |
| (LC-10) | compound (2-1-35-1) and 20 parts by | | |
| | weight of compound (2-2-1-1) | | |
| Polymerizable liquid | 60 parts by weight of compound | 9 parts by weight | 0.3 parts by weight of |
| crystal composition | (2-1-19-1), 20 parts by weight of | of NCI-930 | TEGO Flow370 |
| (LC-11) | compound (2-2-1-1) and 20 parts by | | |
| | weight of compound (2-4-1-1) | | |
| Polymerizable liquid | 60 parts by weight of compound | 9 parts by weight | 0.3 parts by weight of |
| crystal composition | (2-1-19-1), 20 parts by weight of | of NCI-930 | TEGO Flow370 |
| (LC-12) | compound (2-2-1-1) and 20 parts by | | |
| | weight of compound (2-5-4-1) | | |
| Polymerizable liquid | 60 parts by weight of compound | 9 parts by weight | 0.3 parts by weight of |
| crystal composition | (2-1-19-1), 20 parts by weight of | of NCI-930 | TEGO Flow370 |
| (LC-13) | compound (2-2-1-1) and 20 parts by | | |
| | weight of compound (2-6-4-1) | | |
| Polymerizable liquid | 60 parts by weight of compound | 9 parts by weight | 0.3 parts by weight of |
| crystal composition | (2-1-19-1), 20 parts by weight of | of NCI-930 | TEGO Flow370 |
| (LC-14) | compound (2-2-1-1) and 20 parts by | | |
| | weight of compound (2-8-5-1) | | |
| Polymerizable liquid | 60 parts by weight of compound | 9 parts by weight | 0.3 parts by weight of |
| crystal composition | (2-1-19-1), 20 parts by weight of | of NCI-930 | TEGO Flow370 |
| (LC-15) | compound (2-2-1-1) and 20 parts by | | |
| | weight of compound (2-9-2-1) | | |
| Polymerizable liquid | 10 parts by weight of compound | 9 parts by weight | 0.3 parts by weight of |
| crystal composition | (2-1-19-1) and 90 parts by weight of | of NCI-930 | TEGO Flow370 |
| (LC-16) | compound (2-9-2-1) | | |
| Polymerizable liquid | 60 parts by weight of compound | 9 parts by weight | 0.3 parts by weight of |
| crystal composition | (2-1-19-1), 20 parts by weight of | of NCI-930 | TEGO Flow370 |
| (LC-1 7) | compound (2-2-1-1) and 20 parts by | | |
| | weight of compound (2-10-2-1) | | |

### Preparation of Photoalignment Film

### Example 5

A base material with a photoalignment film was prepared by the following procedure:

(1) a solution in Table 3 was prepared;

(2) NMP was added to the mixed solution to obtain a blended solution of polyamic acid where the polymer solid concentration is 4% by weight;

(3) the blended solution was spin-coated at 2,000 rpm on a glass base material;

(4) the glass base material was placed on a hot plate at 80° C., and a solvent of the blended solution was vaporized for 1 minute to prepare a coating film;

(5) the coating film was irradiated with linearly polarized light having a wavelength of 365 nanometers with 2 J/cm² of energy at room temperature from a direction at 900 relative to the application plane; and

(6) then, the resulting material was calcinated in an oven set at 220° C. for 30 minutes to obtain a photoalignment film.

TABLE 3

| Name of base | |
|---|---|
| material | Composition of solution |
| Base material | Mixed solution of polyamic acid solution (PA-1) and |
| (AF-1/I) | polyamic acid solution (PA-I) in weight ratio of 3:7 |
| Base material | Mixed solution of polyamic acid solution (PA-2) and |
| (AF-2/I) | polyamic acid solution (PA-I) in weight ratio of 3:7 |
| Base material | Mixed solution of polyamic acid solution (PA-3) and |
| (AF-3/I) | polyamic acid solution (PA-I) in weight ratio of 3:7 |
| Base material | Mixed solution of polyamic acid solution (PA-4) and |
| (AF-4/II) | polyamic acid solution (PA-II) in weight ratio of 3:7 |
| Base material | Mixed solution of polyamic acid solution (PA-5) and |
| (AF-5/II) | polyamic acid solution (PA-II) in weight ratio of 3:7 |
| Base material | Mixed solution of polyamic acid solution (PA-7) and |
| (AF-8/I) | polyamic acid solution (PA-I) in weight ratio of 3:7 |
| Base material | Mixed solution of polyamic acid solution (PA-8) and |
| (AF-9/I) | polyamic acid solution (PA-I) in weight ratio of 2:8 |

Moreover, base material (AF-6) using polyamic acid solution (PA-6) was prepared by the following procedures. NMP was added to polyamic acid solution (PA-6) to obtain polyamic acid where the polymer solid concentration was 4% by weight. The solution described above was subjected to spin coating on a glass base material at a rotation speed of 2,000 rpm, and a solvent was vaporized for 1 minute on a hot plate at 80° C., and then the resulting material was calcinated in an oven at 220° C. to prepare a coating film. The coating film described above was irradiated with linear polarized light having a wavelength of 254 nanometers from a direction at 90 degrees relative to the application plane. On the above occasion, the irradiation energy was 5.0 J/cm². The resulting material was immersed in an ethyl lactate solution at room temperature for 3 minutes, and then the resulting material was rinsed by IPA for 1 minute, and dried in an oven at 80° C. for 10 minutes to obtain base material (AF-6).

Further, base material (AF-7) using polyamic acid ester solution (PAE-1) was prepared by the following procedures. Polyamic acid ester solution (PAE-1) was subjected to spin coating at a rotation speed of 2,500 rpm on a glass base material, and a solvent was vaporized for 1 minute on a hot plate at 80° C., and then the resulting material was calcinated in an oven at 220° C. to prepare a coating film. The coating film described above was irradiated with linear polarized light having a wavelength of 254 nanometers from a direction at 90 degrees relative to the application plane. On the above occasion, the irradiation energy was 1.0 J/cm². The resulting material was immersed in an ethyl lactate solution at room temperature for 3 minutes, and then the resulting material was rinsed by IPA for 1 minute, and dried in an oven at 80° C. for 10 minutes to obtain base material (AF-7).

Preparation of a Liquid Crystal Polymerization Film with a Base Material

### Example 6

A liquid crystal polymerization film with a base material was prepared by the following procedures:

(1) a polymerizable liquid crystal composition described in Table 5 was applied to a base material described in Table 4 by spin coating to prepare a film;

(2) the film was heated on a hot plate at 80° C. for 3 minutes, and cooled at room temperature for 3 minutes;

(3) the film was irradiated with light at room temperature from a direction at 90 degrees relative to the application plane under a nitrogen atmosphere until an amount of the light exposure to the film becomes to 1.0 J/cm² to obtain a liquid crystal polymer film with a base material in Table 4. Illumination of the ultraviolet light at the above occasion was 30 mW/cm² by measurement using UVD-S365 made by Ushio, Inc.; and

(4) then, the resulting material was calcinated at 220° C. for 30 minutes, and the obtained liquid crystal polymer film with a base material was named as names described in Table 5.

At an end of procedure (3) for preparing liquid crystal polymerization films with base materials (RF-1) to (RF-28), the liquid crystal polymerization films were found to have no alignment defect and uniform homogeneous alignment.

At an end of procedure (4) for preparing liquid crystal polymerization films with a base material (RF-1) to (RF-28), the liquid crystal polymerization films were found to have no alignment defect and uniform homogeneous alignment.

At the end of procedure (3) for preparing liquid crystal polymerization film with a base material (RF-1), the obtained liquid crystal polymerization film with a base material was named as liquid crystal polymerization film with a base material (RF-1b).

TABLE 4

| Name of liquid crystal polymerization film with base material | Name of base material | Name of polymerizable liquid crystal composition |
|---|---|---|
| Liquid crystal polymerization film with base material (RF-1) | Base material (AF-2/I) | Polymerizable liquid crystal composition (LC-7) |
| Liquid crystal polymerization film with base material (RF-2) | Base material (AF-2/I) | Polymerizable liquid crystal composition (LC-7) |
| Liquid crystal polymerization film with base material (RF-3) | Base material (AF-3/II) | Polymerizable liquid crystal composition (LC-7) |
| Liquid crystal polymerization film with base material (RF-4) | Base material (AF-4/II) | Polymerizable liquid crystal composition (LC-7) |
| Liquid crystal polymerization film with base material (RF-5) | Base material (AF-4/II) | Polymerizable liquid crystal composition (LC-7) |
| Liquid crystal polymerization film with base material (RF-6) | Base material (AF-4/II) | Polymerizable liquid crystal composition (LC-7) |
| Liquid crystal polymerization film with base material (RF-7) | Base material (AF-4/II) | Polymerizable liquid crystal composition (LC-7) |
| Liquid crystal polymerization film with base material (RF-8) | Base material (AF-4/II) | Polymerizable liquid crystal composition (LC-7) |
| Liquid crystal polymerization film with base material (RF-9) | Base material (AF-4/II) | Polymerizable liquid crystal composition (LC-7) |
| Liquid crystal polymerization film with base material (RF-10) | Base material (AF-4/II) | Polymerizable liquid crystal composition (LC-7) |
| Liquid crystal polymerization film with base material (RF-11) | Base material (AF-4/II) | Polymerizable liquid crystal composition (LC-7) |
| Liquid crystal polymerization film with base material (RF-12) | Base material (AF-4/II) | Polymerizable liquid crystal composition (LC-7) |
| Liquid crystal polymerization film with base material (RF-13) | Base material (AF-4/II) | Polymerizable liquid crystal composition (LC-7) |
| Liquid crystal polymerization film with base material (RF-14) | Base material (AF-5/I) | Polymerizable liquid crystal composition (LC-7) |
| Liquid crystal polymerization film with base material (RF-15) | Base material (AF-1/I) | Polymerizable liquid crystal composition (LC-7) |
| Liquid crystal polymerization film with base material (RF-16) | Base material (AF-1/I) | Polymerizable liquid crystal composition (LC-7) |
| Liquid crystal polymerization film with base material (RF-17) | Base material (AF-3/II) | Polymerizable liquid crystal composition (LC-7) |
| Liquid crystal polymerization film with base material (RF-18) | Base material (AF-3/II) | Polymerizable liquid crystal composition (LC-7) |
| Liquid crystal polymerization film with base material (RF-19) | Base material (AF-6) | Polymerizable liquid crystal composition (LC-7) |
| Liquid crystal polymerization film with base material (RF-20) | Base material (AF-7) | Polymerizable liquid crystal composition (LC-7) |
| Liquid crystal polymerization film with base material (RF-21) | Base material (AF-8/I) | Polymerizable liquid crystal composition (LC-7) |
| Liquid crystal polymerization film with base material (RF-22) | Base material (AF-4/II) | Polymerizable liquid crystal composition (LC-7) |
| Liquid crystal polymerization film with base material (RF-23) | Base material (AF-4/II) | Polymerizable liquid crystal composition (LC-7) |
| Liquid crystal polymerization film with base material (RF-24) | Base material (AF-4/II) | Polymerizable liquid crystal composition (LC-7) |
| Liquid crystal polymerization film with base material (RF-25) | Base material (AF-4/II) | Polymerizable liquid crystal composition (LC-7) |
| Liquid crystal polymerization film with base material (RF-26) | Base material (AF-4/II) | Polymerizable liquid crystal composition (LC-7) |
| Liquid crystal polymerization film with base material (RF-27) | Base material (AF-4/II) | Polymerizable liquid crystal composition (LC-7) |
| Liquid crystal polymerization film with base material (RF-28) | Base material (AF-4/II) | Polymerizable liquid crystal composition (LC-7) |
| Liquid crystal polymerization film with base material (RF-29) | Base material (AF-9/I) | Polymerizable liquid crystal composition (LC-7) |

Optical Characteristics and Adhesion of Liquid Crystal Polymerization Film with Base Material

### Example 7

Retardation, Δn, contrast, wavelength dispersion and number of squares of the liquid crystal polymer film with the base material were described in Table 5.

TABLE 5

| Name of liquid crystal polymerization film with | | | | Wavelength | Number of |
|---|---|---|---|---|---|
| base material | Retardation/nm | Δn | Contrast | dispersion | squares |
| Liquid crystal polymerization film with base material (RF-1) | 132.2 | — | 9100 | — | 100 |
| Liquid crystal polymerization film with base material (RF-2) | 138.3 | — | 9000 | — | 100 |
| Liquid crystal polymerization film with base material (RF-3) | 135.9 | — | 9300 | — | 100 |
| Liquid crystal polymerization film with base material (RF-4) | 140.1 | — | 9100 | — | 100 |
| Liquid crystal polymerization film with base material (RF-5) | 137.0 | — | 7900 | — | 100 |
| Liquid crystal polymerization film with base material (RF-6) | 135.0 | — | 7600 | — | 100 |
| Liquid crystal polymerization film with base material (RF-7) | 128.7 | — | 8500 | — | 99 |
| Liquid crystal polymerization film with base material (RF-8) | 132.0 | — | 8700 | — | 100 |
| Liquid crystal polymerization film with base material (RF-9) | 138.7 | — | 8200 | — | 100 |
| Liquid crystal polymerization film with base material (RF-10) | 135.5 | 0.14 | 9300 | 1.09 | 100 |
| Liquid crystal polymerization film with base material (RF-7) | 129.8 | 0.13 | 9200 | 1.09 | 100 |
| Liquid crystal polymerization film with base material (RF-8) | 135.4 | — | 8700 | — | 99 |
| Liquid crystal polymerization film with base material (RF-9) | 134.4 | — | 8900 | — | 100 |
| Liquid crystal polymerization film with base material (RF-10) | 140.2 | — | 8500 | — | 100 |
| Liquid crystal polymerization film with base material (RF-11) | 134.3 | — | 8800 | — | 100 |
| Liquid crystal polymerization film with base material (RF-12) | 135.4 | — | 9200 | — | 100 |
| Liquid crystal polymerization film with base material (RF-13) | 138.4 | — | 9300 | — | 100 |
| Liquid crystal polymerization film with base material (RF-14) | 129.9 | — | 8600 | — | 100 |
| Liquid crystal polymerization film with base material (RF-15) | 139.4 | — | 8800 | — | 100 |
| Liquid crystal polymerization film with base material (RF-16) | 126.7 | — | 9000 | — | 100 |
| Liquid crystal polymerization film with base material (RF-17) | 139.4 | — | 8400 | — | 98 |
| Liquid crystal polymerization film with base material (RF-18) | 134.8 | — | 8700 | — | 100 |
| Liquid crystal polymerization film with base material (RF-19) | 125.7 | — | 6500 | — | 100 |
| Liquid crystal polymerization film with base material (RF-20) | 129.3 | — | 7200 | — | 100 |
| Liquid crystal polymerization film with base material (RF-1b) | 146.6 | 0.13 | 8500 | — | — |
| Liquid crystal polymerization film with base material (RF-21) | 133.5 | — | 7200 | — | 0 |
| Liquid crystal polymerization film with base material (RF-22) | 134.4 | — | 8000 | 1.07 | 100 |
| Liquid crystal polymerization film with base material (RF-23) | 140.2 | — | 7000 | 1.06 | 100 |
| Liquid crystal polymerization film with base material (RF-24) | 134.3 | — | 6400 | 1.07 | 98 |
| Liquid crystal polymerization film with base material (RF-25) | 135.4 | — | 5800 | 1.06 | 100 |
| Liquid crystal polymerization film with base material (RF-26) | 138.4 | — | 6200 | 1.06 | 100 |
| Liquid crystal polymerization film with base material (RF-27) | 140.8 | 0.07 | 7600 | 1.02 | 100 |
| Liquid crystal polymerization film with base material (RF-28) | 146.6 | 0.11 | 6700 | 1.06 | 100 |
| Liquid crystal polymerization film with base material (RF-29) | 138.2 | — | 9500 | — | 98 |

In Table 5, a symbol “-” means that no numeric value was obtained because data was insufficient or unmeasured.

As shown in Table 5, the liquid crystal polymerization film with the base material using the polymerizable composition of the invention as a raw material has high contrast.

### Imidization Ratio of Photoalignment Film

### Example 8

In a preparation method for a base material with a photoalignment film, the base material with the photoalignment film was prepared by a solution and conditions of light beam and an amount of light exposure described in Table 6, and the name of the base material was named as described in Table 6. Imidization ratio of the alignment film in each base material was measured, and described in Table 6.

TABLE 6

| | | | Amount of | | |
|---|---|---|---|---|---|
| Name of | Name of | | light | | |
| base | polyamic acid | | exposure/ | | Imidization |
| material | solution | Light beam | (J/cm²) | Post-treatment | ratio (%) |
| Base | Polyamic acid | Linearly polarized light | 2.0 | No-treatment | 100 |
| material | solution (PA-1) | having wavelength of | | | |
| (AF-1) | | 365 nm | | | |
| Base | Polyamic acid | Linearly polarized light | 2.0 | No-treatment | 100 |
| material | solution (PA-2) | having wavelength of | | | |
| (AF-2) | | 365 nm | | | |
| Base | Polyamic acid | Linearly polarized light | 2.0 | No-treatment | 100 |
| material | solution (PA-3) | having wavelength of | | | |
| (AF-3) | | 365 nm | | | |
| Base | Polyamic acid | Linearly polarized light | 2.0 | No-treatment | 98 |
| material | solution (PA-4) | having wavelength of | | | |
| (AF-4) | | 365 nm | | | |
| Base | Polyamic acid | Linearly polarized light | 2.0 | No-treatment | 99 |
| material | solution (PA-5) | having wavelength of | | | |
| (AF-5) | | 365 nm | | | |
| Base | Polyamic acid | Linearly polarized light | 2.0 | No-treatment | 100 |
| material | solution (PA-7) | having wavelength of | | | |
| (AF-8) | | 365 nm | | | |

From the number of squares described in Table 5, adhesion of the alignment film was found to be high when the content of the proton donor group contained in the alignment film is 0.1 or more based on the repeating unit.

The proton donor group in the experimental results described in Table 5 are a hydroxyl group or an amino group.

### Comparative Example 1

Photoalignment film (AF-1/I-2) was prepared according to Example 3 except that polyamic acid solution (PA-1) and polyamic acid solution (PA-I) were used, and a calcination temperature in preparation conditions of the photoalignment film was adjusted at 100° C. A film of polymerizable liquid crystal composition (LC-1) was formed on the photoalignment film according to Example 4 to obtain liquid crystal polymerization film (RF-1-2).

Next, as a result of measuring an imidization ratio of component (AF-1-2) being a component in contact with a liquid crystal polymer (a polymer of LC-1) in the photoalignment film (AF-1/I-2) described above in a manner similar to Example 7, the imidization ratio was 0%.

Characteristics of the liquid crystal polymerization films are shown in Table 7.

TABLE 7

| Name of liquid crystal | | | | |
|---|---|---|---|---|
| polymerization film | Retardation/ | | Con- | Number of |
| with base material | nm | Δn | trast | squares |
| Liquid crystal polymerization | 128.7 | 0.10 | 2000 | — |
| film with base material (RF-1-2) | | | | |

When the content of the carboxyl group contained in the alignment film prepared by using polyamic acid having a low imidization ratio and represented by the repeating unit of formula (1) described above was 2 or more based the repeating unit, contrast is significantly reduced.

### Comparative Example 2

### Synthesis of Comparative Compound (Ref. 1)

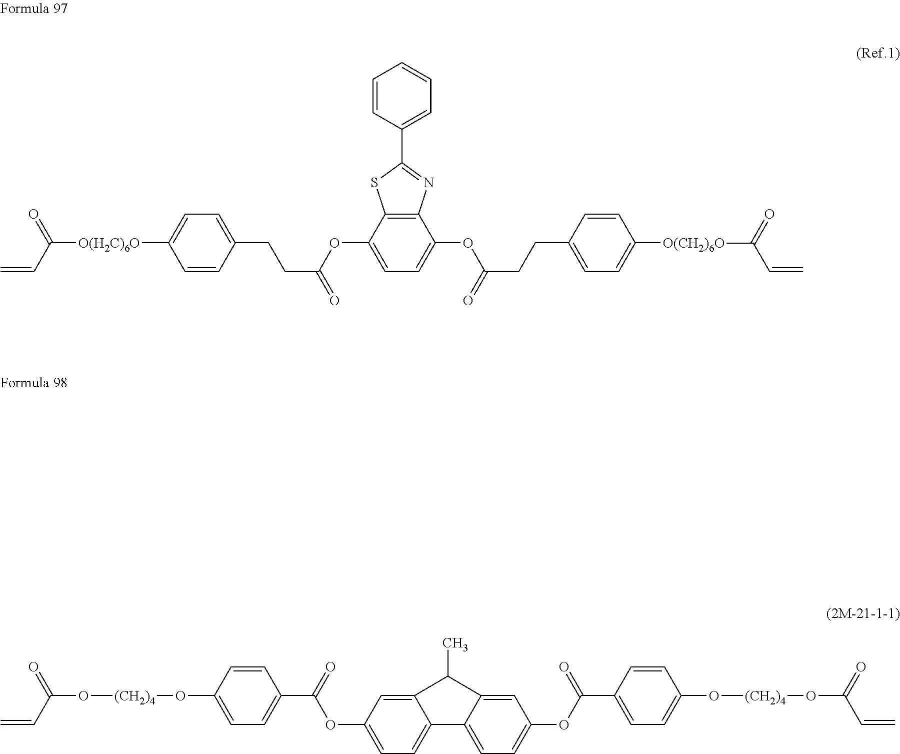

Compound (IM-1) was prepared by the method described in JP 5453798 B. Compound (IM-2) was prepared by the method described in Example 5 in JP 2016-047813 A. To 80 mL of dichloromethane, 5.0 g (21 mmol) of compound (IM-1), 14.5 g of compound (IM-2) and 0.25 g (2.0 mmol) of DMAP were added, and the resulting mixture was stirred under a nitrogen atmosphere while being cooled. Then, 20 mL of dichloromethane solution in which 10.2 g (49.4 mmol) of DCC was dissolved was added dropwise thereto. After dropwise addition, the resulting mixture was stirred at room temperature overnight. A deposit precipitated was filtered off, and an organic layer was washed with water and dried over anhydrous magnesium sulfate. Then, dichloromethane was distilled off under reduced pressure, and the residue was purified by column chromatography, and recrystallized in methanol to obtain 12.5 g of compound (Ref. 1). Here, a packing material in the column chromatography was silica gel. Here, an eluent was a mixture of toluene and ethyl acetate (v/v=10/1). A melting point of compound (Ref. 1) was 81.7° C.

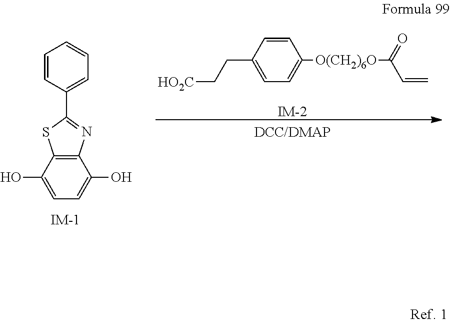

### Preparation of Polymerizable Liquid Crystal Composition

Then, 0.2550 g of compound (Ref.1) and 0.2550 g of compound (2M-21-1-1) were dissolved in 2.49 g of cyclohexanone, and 0.0306 g of Irg-907 and 0.0153 g of TEGO Flow370 were further added thereto, and dissolved thereinto to obtain polymerizable liquid crystal composition (RefLC-1).

Preparation of Liquid Crystal Polymerization Film with Base Material, and Characteristics of the Polymerization Film

A liquid crystal polymerization film with a base material was prepared by using polymerizable liquid crystal composition (RefLC-1) and base material (AF-4/II) in a manner similar to Example 5. Characteristics of the polymerization film are shown in Table 8.

TABLE 8

| Name of liquid crystal polymerization film with | | | | Wavelength | Number of |
|---|---|---|---|---|---|
| base material | Retardation/nm | Δn | Contrast | dispersion | squares |
| Liquid crystal polymerization film with base material (RF-Ref-1) | 141.5 | 0.09 | 2800 | 1.09 | 100 |

1. A liquid crystal polymerization film, prepared by applying a polymerizable liquid crystal composition containing a compound represented by formula (2) on an alignment film prepared by calcinating a composition containing a polymer represented by a repeating unit of formula (1), and subsequently polymerizing the polymerizable liquid crystal composition: 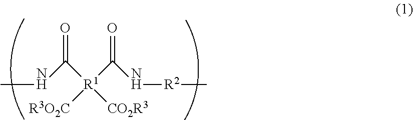
wherein, in formula (1), R¹ is independently a tetravalent group, R² is independently a divalent functional group and R³ is independently a hydrogen atom or a monovalent group:
PG¹-Sp¹-R⁴-Sp²-PG² (2)
wherein, in formula (2), R⁴ represents a divalent group formed by combining five or more and nine or less of alicycles and/or aromatic rings, SP¹ and SP² represent a spacer group, and PG¹ and PG² are an alkyl group, an alkoxyl group, a cyano group, fluorine or a polymerizable functional group, in which either group is the polymerizable functional group.

2. The liquid crystal polymerization film according to claim 1, wherein a content of a hydroxyl group, an amino group or a carboxyl group contained in the alignment film is 0.1 or more, and less than 2 based on the repeating unit of formula (1).

3. The liquid crystal polymerization film according to claim 1, prepared by polymerizing the polymerizable liquid crystal composition, and then calcinating the resulting material at 140° C. or higher.

4. The liquid crystal polymerization film according to claim 3, wherein the alignment film is a photoalignment film.

5. The liquid crystal polymerization film according to claim 4, wherein a photosensitive group in the photoalignment film has an azobenzene structure, a cyclobutane structure, a cinnamic acid structure, a chalcone structure or a coumarin derivative structure.

6. The liquid crystal polymerization film according claim 5, having characteristics of a positive A-plate.

7. The liquid crystal polymerization film according to claim 6, wherein R¹ in formula (1) is represented by any one of formulas (1-A) to (1-D):

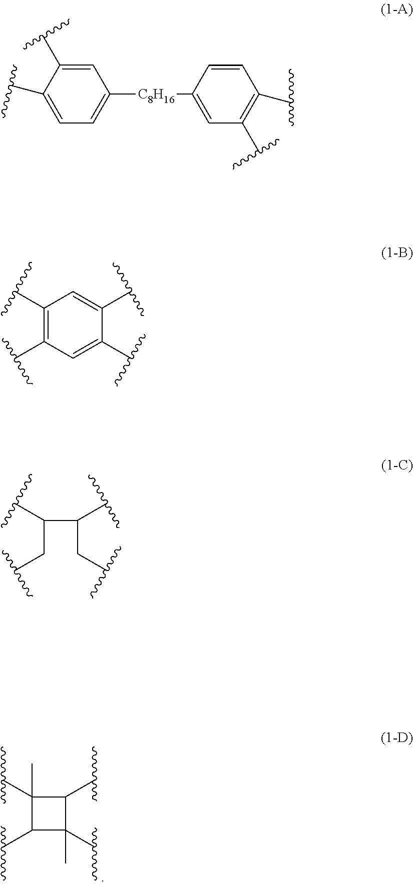

8. The liquid crystal polymerization film according to claim 7, wherein R² in formula (1) is a group represented by any one of formulas (1-F) to (1-N):

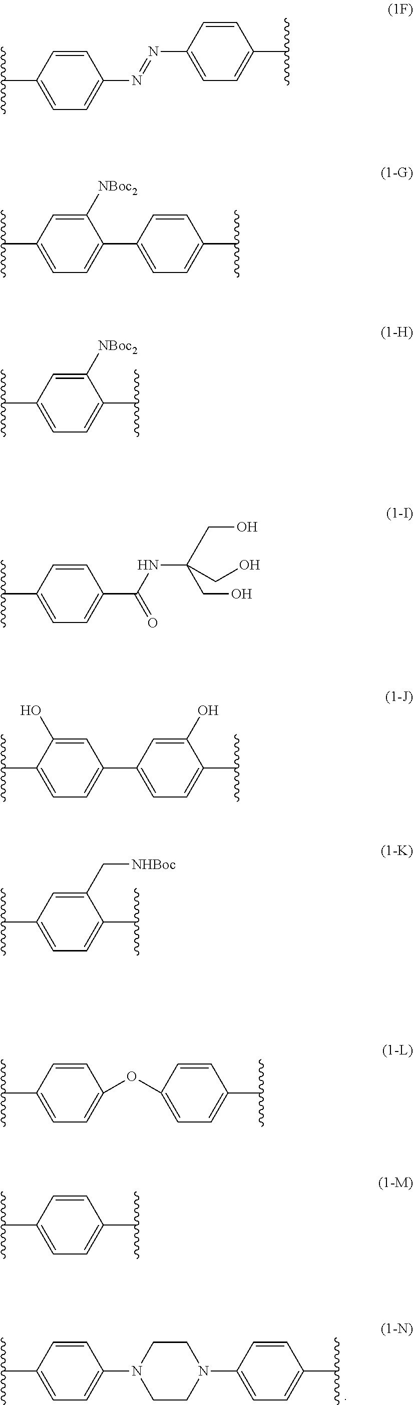

9. The liquid crystal polymerization film according to claim 8, containing a compound represented by formula (2-A): 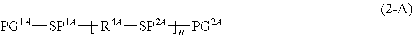
wherein, in formula (2-A), R^{4A} is independently a group represented by formula (2-A-a) to formula (2-A-o): 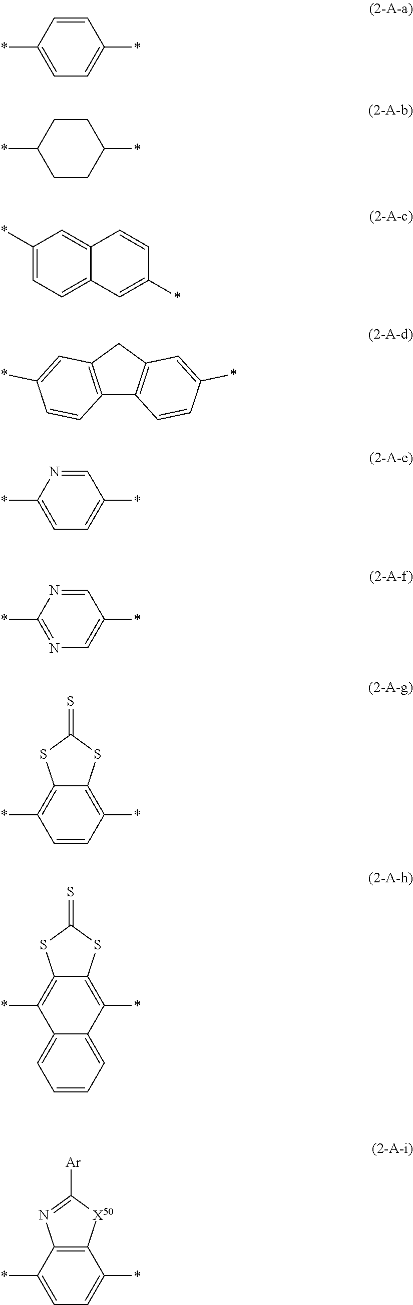 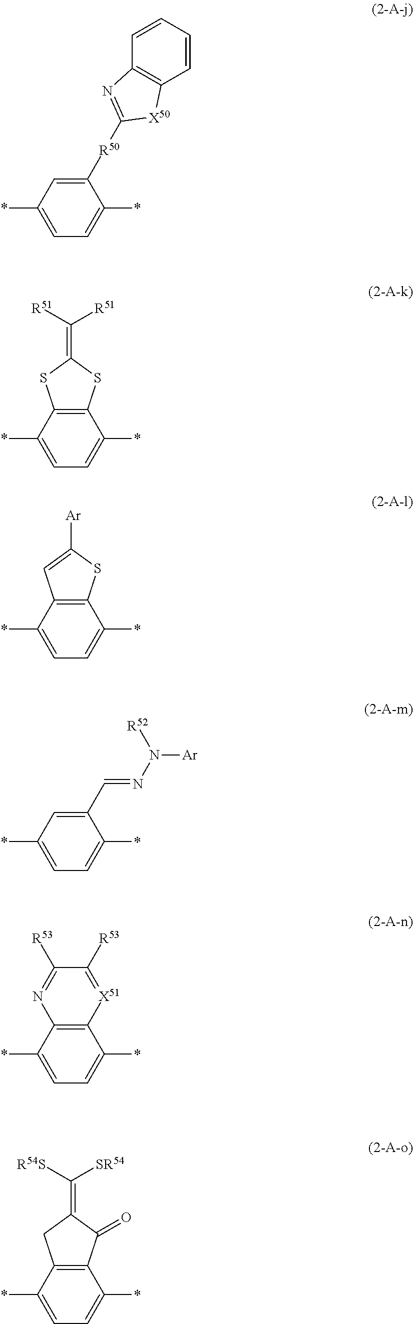
wherein, in formula (2-A-a) to formula (2-A-o),
an asterisk * represents a bonding position to SP^{1A} or SP^{2A};
Ar is an aromatic group having 14 or less carbons or a group in which aromatics are conjugated;
X⁵⁰ is —NH—, —O— or —S—,
X⁵¹ is ═CH— or ═N—;
R⁵⁰ is a single bond or —CH═CH—;
R⁵¹ is —CO₂R⁵¹¹ or —CN;
R⁵¹¹ represents an alkyl group having 10 or less carbons, and one methylene in the alkyl group or one hydrogen in the methyl group may be replaced by a (meta)acryloxy group;
R⁵² represents a hydrogen atom or an alkyl group having 10 or less carbons, and one methylene in the alkyl group or one hydrogen in the methyl group may be replaced by a (meta)acryloxy group;
R⁵³ is independently a hydrogen atom, an alkyl group having 5 or less carbons or an aromatic group having 10 or less carbons;
R⁵⁴ represents an alkyl group having 5 or less carbons, and wherein both R⁵⁴ may be bonded into a ring structure; and
in formula (2-A-a) to formula (2-A-o),
one hydrogen may be substituted for an alkyl group having 1 to 5 carbons (in which arbitrary —CH₂— in the alkyl group may be substituted for —O—, —CO— or —COO— and arbitrary —CH₂—CH₂— may be replaced by —CH═CH—, and hydrogen in the alkyl group may be substituted for a halogen group) or a halogen group;
SP^{1A} and SP^{2A} are independently a single bond or alkylene having 2 to 4 carbons, and —CH₂— in the alkylene may be substituted for —O—, —CO— or —COO—; and
PG^{1A} is a functional group represented by formula (2-B): 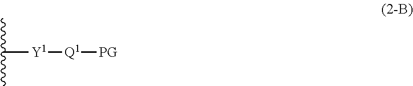
wherein, in formula (2-B),
Y¹ is a single bond, —O—, —COO—, —OCO— or —OCOO—,
Q¹ is a single bond or alkylene having 1 to 20 carbons, and in the alkylene, at least one —CH₂— may be replaced by —O—, —COO— or —OCO—, and PG is a (meta)acrylic group; and PG² is an alkyl group, an alkoxyl group, a cyano group, fluorine or a functional group represented by formula (2-B); and
n is an integer from 5 to 9.

10. The liquid crystal polymerization film according to claim 9, wherein a content of a compound represented by formula (2-A) in the polymerizable liquid crystal composition is 70% by weight or more based on other polymerizable compounds.

11. The liquid crystal polymerization film according to claim 9, wherein the polymerizable liquid crystal composition contains a compound represented by formula (2-A) only.

12. A phase difference film, comprising the liquid crystal polymerization film according to claim 1.
